(19) United States
(12) Patent Application Publication
(10) Pub. No.: US 2014/0074761 A1
(43) Pub. Date: Mar. 13, 2014

(54) DYNAMICAL EVENT NEURON AND SYNAPSE MODELS FOR LEARNING SPIKING NEURAL NETWORKS

(71) Applicant: QUALCOMM Incorporated, San Diego, CA (US)

(72) Inventor: Jason Frank Hunzinger, Escondido, CA (US)

(73) Assignee: QUALCOMM Incorporated, San Diego, CA (US)

(21) Appl. No.: 14/081,777

(22) Filed: Nov. 15, 2013

Related U.S. Application Data
(63) Continuation-in-part of application No. 13/483,811, filed on May 30, 2012.
(60) Provisional application No. 61/728,409, filed on Nov. 20, 2012.
(60) Provisional application No. 61/759,181, filed on Jan. 31, 2013.

(51) Int. Cl. G06N 3/02

(52) U.S. Cl. CPC G06N 3/02
USPC 706/15

(57) ABSTRACT

Certain aspects of the present disclosure support a technique for updating the state of an artificial neuron. A first state of the artificial neuron can be first determined, wherein a neuron model for the artificial neuron has a closed-form solution in continuous time and wherein state dynamics of the neuron model are divided into two or more regimes. An operating regime for the artificial neuron can be determined based, at least in part, on the first state. The state of the artificial neuron can be updated based, at least in part, on the first state of the artificial neuron and the determined operating regime.

### CLAIM OF PRIORITY UNDER 35 U.S.C. §119

The present application for patent claims benefit of Provisional Application Ser. No. 61/728,409 filed Nov. 20, 2012 and Provisional Application Ser. No. 61/759,181 filed Jan. 31, 2013, and assigned to the assignee hereof and hereby expressly incorporated by reference herein.

### CLAIM OF PRIORITY UNDER 35 U.S.C §120

The present application for patent is a continuation-in-part of patent application Ser. No. 13/483,811 filed May 30, 2012, pending, and assigned to the assignee hereof and hereby expressly incorporated by reference herein.

### BACKGROUND

1. Field

Certain aspects of the present disclosure generally relate to neural networks and, more particularly, to a continuous-time, event-based model for neurons and synapses.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

One type of artificial neural network is the spiking neural network, which incorporates the concept of time into its operating model, as well as neuronal and synaptic state, thereby providing a rich set of behaviors from which computational function can emerge in the neural network. Spiking neural networks are based on the concept that neurons fire or “spike” at a particular time or times based on the state of the neuron, and that the time is important to neuron function. When a neuron fires, it generates a spike that travels to other neurons, which, in turn, may adjust their states based on the time this spike is received. In other words, information may be encoded in the relative or absolute timing of spikes in the neural network.

### SUMMARY

Certain aspects of the present disclosure provide a method for updating a state of an artificial neuron. The method generally includes determining a first state of the artificial neuron, wherein a neuron model for the artificial neuron has a closed-form solution in continuous time and wherein state dynamics of the neuron model are divided into two or more regimes, determining an operating regime for the artificial neuron from the two or more regimes based, at least in part, on the first state, and updating the state of the artificial neuron based, at least in part, on the first state of the artificial neuron and the determined operating regime.

Certain aspects of the present disclosure provide an apparatus for updating a state of an artificial neuron. The apparatus generally includes a processing system configured to determine a first state of the artificial neuron, wherein a neuron model for the artificial neuron has a closed-form solution in continuous time and wherein state dynamics of the neuron model are divided into two or more regimes, determine an operating regime for the artificial neuron from the two or more regimes based, at least in part, on the first state, and update the state of the artificial neuron based, at least in part, on the first state of the artificial neuron and the determined operating regime.

Certain aspects of the present disclosure provide an apparatus for updating a state of an artificial neuron. The apparatus generally includes means for determining a first state of the artificial neuron, wherein a neuron model for the artificial neuron has a closed-form solution in continuous time and wherein state dynamics of the neuron model are divided into two or more regimes, means for determining an operating regime for the artificial neuron from the two or more regimes based, at least in part, on the first state, and means for updating the state of the artificial neuron based, at least in part, on the first state of the artificial neuron and the determined operating regime.

Certain aspects of the present disclosure provide a computer-program product for updating a state of an artificial neuron. The computer-program product generally includes a computer-readable medium comprising code for determining a first state of the artificial neuron, wherein a neuron model for the artificial neuron has a closed-form solution in continuous time and wherein state dynamics of the neuron model are divided into two or more regimes, determining an operating regime for the artificial neuron from the two or more regimes based, at least in part, on the first state, and updating the state of the artificial neuron based, at least in part, on the first state of the artificial neuron and the determined operating regime.

Certain aspects of the present disclosure provide a method for producing neural behaviors of an artificial neuron. The method generally includes determining a first state of the artificial neuron, wherein a neuron model for the artificial neuron has a closed-form solution in continuous time and wherein linear dynamics of the neuron model are divided into two or more regimes, determining an operating regime for the artificial neuron from the two or more regimes based, at least in part, on the first state, updating the state of the artificial neuron based, at least in part, on the first state of the artificial neuron and the determined operating regime, and generating a variety of neural behaviors of the artificial neuron by utilizing the linear dynamics of neuron model.

Certain aspects of the present disclosure provide an apparatus for producing neural behaviors of an artificial neuron. The apparatus generally includes a processing system configured to determine a first state of the artificial neuron, wherein a neuron model for the artificial neuron has a closed-form solution in continuous time and wherein linear dynamics of the neuron model are divided into two or more regimes, determine an operating regime for the artificial neuron from the two or more regimes based, at least in part, on the first state, update the state of the artificial neuron based, at least in part, on the first state of the artificial neuron and the determined operating regime, and generate a variety of neural behaviors of the artificial neuron by utilizing the linear dynamics of neuron model

Certain aspects of the present disclosure provide an apparatus for producing neural behaviors of an artificial neuron. The apparatus generally includes means for determining a first state of the artificial neuron, wherein a neuron model for the artificial neuron has a closed-form solution in continuous time and wherein linear dynamics of the neuron model are divided into two or more regimes, means for determining an operating regime for the artificial neuron from the two or more regimes based, at least in part, on the first state, means for updating the state of the artificial neuron based, at least in part, on the first state of the artificial neuron and the determined operating regime, and means for generating a variety of neural behaviors of the artificial neuron by utilizing the linear dynamics of neuron model.

Certain aspects of the present disclosure provide a computer-program product for producing neural behaviors of an artificial neuron. The computer-program product generally includes a computer-readable medium comprising code for determining a first state of the artificial neuron, wherein a neuron model for the artificial neuron has a closed-form solution in continuous time and wherein linear dynamics of the neuron model are divided into two or more regimes, determining an operating regime for the artificial neuron from the two or more regimes based, at least in part, on the first state, updating the state of the artificial neuron based, at least in part, on the first state of the artificial neuron and the determined operating regime, and generating a variety of neural behaviors of the artificial neuron by utilizing the linear dynamics of neuron model.

Certain aspects of the present disclosure provide a method for updating a state of an artificial neuron. The method generally includes updating the state of the artificial neuron based, at least in part, on events, wherein a neuron model for the artificial neuron has a closed-form solution in continuous time and wherein state dynamics of the neuron model are divided into two or more regimes, updating the state of the artificial neuron at time intervals, and updating the state of the artificial neuron if an event occur at or between time instants.

Certain aspects of the present disclosure provide an apparatus for updating a state of an artificial neuron. The apparatus generally includes a processing system configured to update the state of the artificial neuron based, at least in part, on events, wherein a neuron model for the artificial neuron has a closed-form solution in continuous time and wherein state dynamics of the neuron model are divided into two or more regimes, update the state of the artificial neuron at time intervals, and update the state of the artificial neuron if an event occur at or between time instants.

Certain aspects of the present disclosure provide an apparatus for updating a state of an artificial neuron. The apparatus generally includes means for updating the state of the artificial neuron based, at least in part, on events, wherein a neuron model for the artificial neuron has a closed-form solution in continuous time and wherein state dynamics of the neuron model are divided into two or more regimes, means for updating the state of the artificial neuron at time intervals, and means for updating the state of the artificial neuron if an event occur at or between time instants.

Certain aspects of the present disclosure provide a computer-program product for updating a state of an artificial neuron. The computer-program product generally includes a computer-readable medium comprising code for updating the state of the artificial neuron based, at least in part, on events, wherein a neuron model for the artificial neuron has a closed-form solution in continuous time and wherein state dynamics of the neuron model are divided into two or more regimes, updating the state of the artificial neuron at time intervals, and updating the state of the artificial neuron if an event occur at or between time instants.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example network of neurons in accordance with certain aspects of the present disclosure.

FIG. 2 illustrates example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5 illustrates an example abstract event state machine in accordance with certain aspects of the present disclosure.

FIG. 6 illustrates an example of events that invoke changes in neuron model dynamics in accordance with certain aspects of the present disclosure.

FIG. 7 illustrates an example of ability to detect coincidence with Leaky-Integrate-and-Fire (LIF) neuron model in accordance with certain aspects of the present disclosure.

FIG. 8 illustrates an example of inability/difficulty to detect coincidence with other neuron models in accordance with certain aspects of the present disclosure.

FIG. 9 illustrates an example of monotonically decreasing difference in the state of a LIF neuron model in accordance with certain aspects of the present disclosure.

FIG. 10 illustrates an example of non-monotonically decreasing difference in the state of a LIF neuron model in accordance with certain aspects of the present disclosure.

FIG. 11 illustrates an example of inability to distinguish sub-threshold input timing in accordance with certain aspects of the present disclosure.

FIG. 12 illustrates an example of ability to distinguish supra-threshold input timing in accordance with certain aspects of the present disclosure.

FIG. 13 illustrates an example of ability to distinguish sub-threshold input timing in accordance with certain aspects of the present disclosure.

FIG. 14 illustrates an example of momentary coupling at events and decoupling between events in accordance with certain aspects of the present disclosure.

FIG. 15 illustrates an example comparison of dynamics in positive and negative regimes in accordance with certain aspects of the present disclosure.

FIG. 16 illustrates an example of state dynamics between events being independent of inter-event updates in accordance with certain aspects of the present disclosure.

FIG. 17 illustrates an example of artificial events that influence dynamics despite absence of input or output in accordance with certain aspects of the present disclosure.

FIG. 18 illustrates an example comparison of basic dynamics with and without periodic artificial events in accordance with certain aspects of the present disclosure.

FIG. 19 illustrates an example of typical null-clines of Hunzinger Cold neuron model in accordance with certain aspects of the present disclosure.

FIG. 20 illustrates an example spike results of iterative Simple Model and dynamical event Model in accordance with certain aspects of the present disclosure.

FIG. 21 illustrates an example of state trajectories across null-clines in the negative regime in accordance with certain aspects of the present disclosure.

FIG. 22 illustrates an example of state trajectory geometry in accordance with certain aspects of the present disclosure.

FIG. 23 illustrates an example of damped oscillation in accordance with certain aspects of the present disclosure.

FIG. 24 illustrates an example of orbit variations in accordance with certain aspects of the present disclosure.

FIG. 25 illustrates an example of relation between inter-event dynamics and null-clines in accordance with certain aspects of the present disclosure.

FIG. 26 illustrates an example of oscillation due to inter-event intervals in accordance with certain aspects of the present disclosure.

FIG. 27 illustrates an example of orbit due to inter-event intervals in accordance with certain aspects of the present disclosure.

FIG. 28 illustrates an example of voltage derivative acceleration across regime threshold in accordance with certain aspects of the present disclosure.

FIG. 29 illustrates an example of voltage derivative deceleration across regime threshold in accordance with certain aspects of the present disclosure.

FIG. 30 illustrates an example of limit cycle due to positive finite return regime in accordance with certain aspects of the present disclosure.

FIG. 31 illustrates an example of behavior in negative finite return regime in accordance with certain aspects of the present disclosure.

FIG. 32 illustrates an example of vector field state regimes of Hunzinger Cold neuron model in accordance with certain aspects of the present disclosure.

FIG. 33 illustrates an example of spike latency in accordance with certain aspects of the present disclosure.

FIG. 34 illustrates an example of spike latency state trajectory in accordance with certain aspects of the present disclosure.

FIG. 35 illustrates an example of spike latency with and without coupling in accordance with certain aspects of the present disclosure.

FIG. 36 illustrates an example resonator in accordance with certain aspects of the present disclosure.

FIG. 37 illustrates an example of resonator state trajectory in accordance with certain aspects of the present disclosure.

FIG. 38 illustrates an example integrator in accordance with certain aspects of the present disclosure.

FIG. 39 illustrates an example of threshold variability in accordance with certain aspects of the present disclosure.

FIG. 40 illustrates an example rebound spike and rebound burst in accordance with certain aspects of the present disclosure.

FIG. 41 illustrates an example of rebound state trajectory in accordance with certain aspects of the present disclosure.

FIG. 42 illustrates an example of bi-stability in accordance with certain aspects of the present disclosure.

FIG. 43 illustrates an example of bi-stability state trajectory in accordance with certain aspects of the present disclosure.

FIG. 44 illustrates an example of sub-threshold oscillation in accordance with certain aspects of the present disclosure.

FIG. 45 illustrates an example of sub-threshold oscillation post-spike in accordance with certain aspects of the present disclosure.

FIG. 46 illustrates an example of rest orbit paths before and after spike in accordance with certain aspects of the present disclosure.

FIG. 47 illustrates an example of depolarization after-potential in accordance with certain aspects of the present disclosure.

FIG. 48 illustrates an example of accommodation in accordance with certain aspects of the present disclosure.

FIG. 49 illustrates an example of accommodation state trajectory in accordance with certain aspects of the present disclosure.

FIG. 50 illustrates an example of class 1 excitation in accordance with certain aspects of the present disclosure.

FIG. 51 illustrates an example of class 2 excitation in accordance with certain aspects of the present disclosure.

FIG. 52 illustrates an example of tonic spiking in accordance with certain aspects of the present disclosure.

FIG. 53 illustrates an example of phasic-spiking in accordance with certain aspects of the present disclosure.

FIG. 54 illustrates an example of tonic bursting in accordance with certain aspects of the present disclosure.

FIG. 55 illustrates an example of phasic bursting in accordance with certain aspects of the present disclosure.

FIG. 56 illustrates an example of mixed mode behavior in accordance with certain aspects of the present disclosure.

FIG. 57 illustrates an example of spike frequency adaptation in accordance with certain aspects of the present disclosure.

FIG. 58 illustrates an example of inhibition-induced spiking in accordance with certain aspects of the present disclosure.

FIG. 59 illustrates an example of state trajectory for inhibition-induced spiking in accordance with certain aspects of the present disclosure.

FIG. 60 illustrates an example of state trajectory for inhibition-induced bursting in accordance with certain aspects of the present disclosure.

FIG. 61 illustrates summary of nominal example behaviors in accordance with certain aspects of the present disclosure.

FIG. 62 illustrates Hunzinger Cold neuron model behavioral example parameters in accordance with certain aspects of the present disclosure

FIG. 63 illustrates example operations for updating the state of an artificial neuron in accordance with certain aspects of the present disclosure.

FIG. 63A illustrates example components capable of performing the operations illustrated in FIG. 63.

FIG. 64 illustrates example operations for producing various neural behaviors of an artificial neuron in accordance with certain aspects of the present disclosure.

FIG. 64A illustrates example components capable of performing the operations illustrated in FIG. 64.

FIG. 65 illustrates other example operations for updating the state of an artificial neuron in accordance with certain aspects of the present disclosure.

FIG. 65A illustrates example components capable of performing the operations illustrated in FIG. 65.

FIG. 66 illustrates an example block diagram of a method for updating the state of an artificial neuron using a general-purpose processor in accordance with certain aspects of the present disclosure.

FIG. 67 illustrates an example block diagram of a method for updating the state of an artificial neuron where a memory can be interfaced with individual distributed processing units in accordance with certain aspects of the present disclosure.

FIG. 68 illustrates an example block diagram of a method for updating the state of an artificial neuron based on distributed memories and distributed processing units in accordance with certain aspects of the present disclosure.

FIG. 69 illustrates an example implementation of a neural network in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

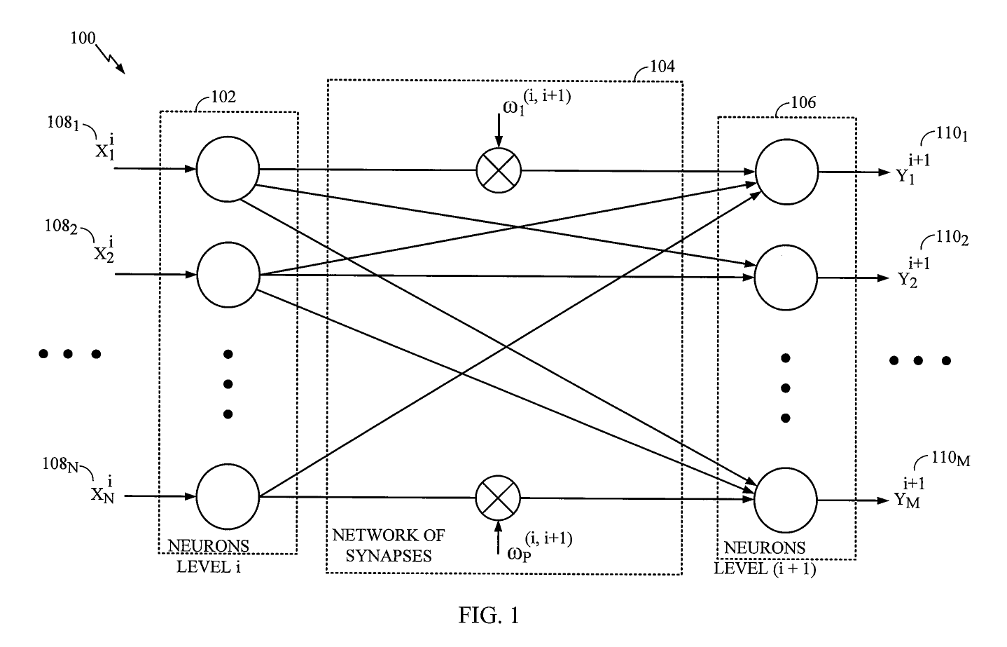

FIG. 1 illustrates an example neural system 100 with multiple levels of neurons in accordance with certain aspects of the present disclosure. The neural system 100 may comprise a level of neurons 102 connected to another level of neurons 106 though a network of synaptic connections 104 (i.e., feed-forward connections). For simplicity, only two levels of neurons are illustrated in FIG. 1, although fewer or more levels of neurons may exist in a typical neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by a plurality of neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). Such behavior can be emulated or simulated in hardware and/or software, including analog and digital implementations.

In biological neurons, the output spike generated when a neuron fires is referred to as an action potential. This electrical signal is a relatively rapid, transient, all- or nothing nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal is represented only by the frequency and number of spikes, or the time of spikes, not by the amplitude. The information carried by an action potential is determined by the spike, the neuron that spiked, and the time of the spike relative to other spike or spikes.

The transfer of spikes from one level of neurons to another may be achieved through the network of synaptic connections (or simply “synapses”) 104, as illustrated in FIG. 1. The synapses 104 may receive output signals (i.e., spikes) from the level 102 neurons (pre-synaptic neurons relative to the synapses 104), and scale those signals according to adjustable synaptic weights w₁^{(i,i+1)}, . . . , w_{P}^{(i,i+1)} (where P is a total number of synaptic connections between the neurons of levels 102 and 106). Further, the scaled signals may be combined as an input signal of each neuron in the level 106 (post-synaptic neurons relative to the synapses 104). Every neuron in the level 106 may generate output spikes 110 based on the corresponding combined input signal. The output spikes 110 may be then transferred to another level of neurons using another network of synaptic connections (not shown in FIG. 1).

Biological synapses may be classified as either electrical or chemical. While electrical synapses are used primarily to send excitatory signals, chemical synapses can mediate either excitatory or inhibitory (hyperpolarizing) actions in postsynaptic neurons and can also serve to amplify neuronal signals. Excitatory signals typically depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, wherein synaptic weight changes may relate to changes of the memristor resistance. With nanometer feature-sized memristors, the area of neuron circuit and synapses may be substantially reduced, which may make implementation of a very large-scale neural system hardware implementation practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, wherein a particular functionality may be based on synaptic weights stored in a memory card currently attached to the neural processor.

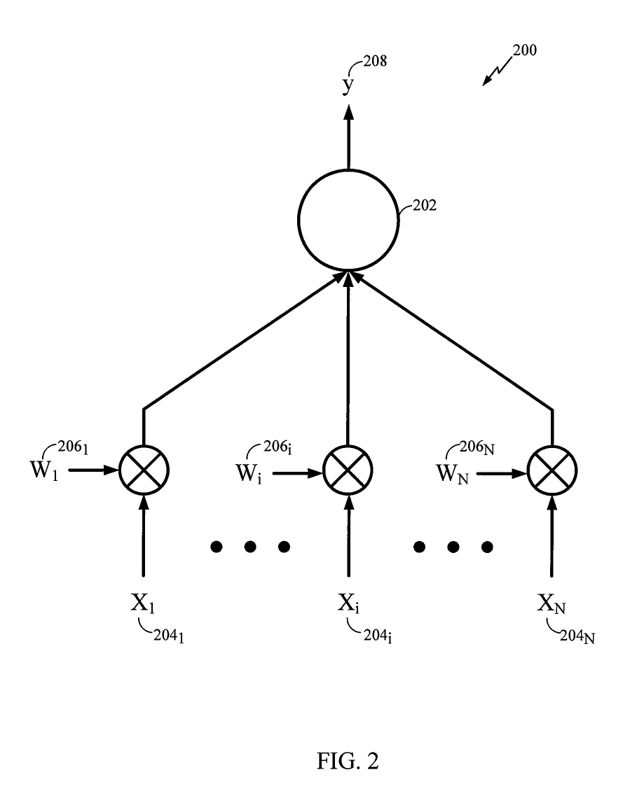

FIG. 2 illustrates an example 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (x₁-x_{N}), which may be signals external to the neural system, or signals generated by other neurons of the same neural system, or both. The input signal may be a current or a voltage, real-valued or complex-valued. The input signal may comprise a numerical value with a fixed-point or a floating-point representation. These input signals may be delivered to the neuron 202 through synaptic connections that scale the signals according to adjustable synaptic weights 206₁-206_{N} (w₁-w_{N}), where N may be a total number of input connections of the neuron 202.

The neuron 202 may combine the scaled input signals and use the combined scaled inputs to generate an output signal 208 (i.e., a signal y). The output signal 208 may be a current, or a voltage, real-valued or complex-valued. The output signal may comprise a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by wires with synaptic circuits. The processing unit 202, its input and output connections may also be emulated by a software code. The processing unit 202 may also be emulated by an electric circuit, whereas its input and output connections may be emulated by a software code. In an aspect, the processing unit 202 in the computational network may comprise an analog electrical circuit. In another aspect, the processing unit 202 may comprise a digital electrical circuit. In yet another aspect, the processing unit 202 may comprise a mixed-signal electrical circuit with both analog and digital components. The computational network may comprise processing units in any of the aforementioned forms. The computational network (neural system or neural network) using such processing units may be utilized in a large range of applications, such as image and pattern recognition, machine learning, motor control, and alike.

During the course of training of neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Some examples of the learning rule are the spike-timing-dependent plasticity (STDP) learning rule, the Hebb rule, the Oja rule, the Bienenstock-Copper-Munro (BCM) rule, etc. Very often, the weights may settle to one of two values (i.e., a bimodal distribution of weights). This effect can be utilized to reduce the number of bits per synaptic weight, increase the speed of reading and writing from/to a memory storing the synaptic weights, and to reduce power consumption of the synaptic memory.

### Synapse Type

In hardware and software models of neural networks, processing of synapse related functions can be based on synaptic type. Synapse types may comprise non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of this is that processing can be subdivided. For example, non-plastic synapses may not require plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) since structural plasticity (i.e., an amount of delay change) may be a direct function of pre-post spike time difference. Alternatively, it may be set as a function of the weight change amount or based on conditions relating to bounds of the weights or weight changes. For example, a synapse delay may change only when a weight change occurs or if weights reach zero but not if they are maxed out. However, it can be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity”. Consequently, inputs that might be the cause of the post-synaptic neuron's excitation are made even more likely to contribute in the future, whereas inputs that are not the cause of the post-synaptic spike are made less likely to contribute in the future. The process continues until a subset of the initial set of connections remains, while the influence of all others is reduced to zero or near zero.

Since a neuron generally produces an output spike when many of its inputs occur within a brief period, i.e., being cumulative sufficient to cause the output, the subset of inputs that typically remains includes those that tended to be correlated in time. In addition, since the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a pre-synaptic neuron to a post-synaptic neuron as a function of time difference between spike time tₚᵣₑ of the pre-synaptic neuron and spike time tₚₒₛₜ of the post-synaptic neuron (i.e., t=tₚₒₛₜ−tₚᵣₑ). A typical formulation of the STDP is to increase the synaptic weight (i.e., potentiate the synapse) if the time difference is positive (the pre-synaptic neuron fires before the post-synaptic neuron), and decrease the synaptic weight (i.e., depress the synapse) if the time difference is negative (the post-synaptic neuron fires before the pre-synaptic neuron).

In the STDP process, a change of the synaptic weight over time may be typically achieved using an exponential decay, as given by,

$$Δ w ( t ) = \{ \begin{matrix}{a}_{+} {e}^{- t / {k}_{+}} + μ , t > 0 \\ {a\_e}^{t / k\_} , t < 0 ,\end{matrix} \qquad ( 1 )$$

where k₊ and k₋ are time constants for positive and negative time difference, respectively, a₊ and a₋ are corresponding scaling magnitudes, and μ is an offset that may be applied to the positive time difference and/or the negative time difference.

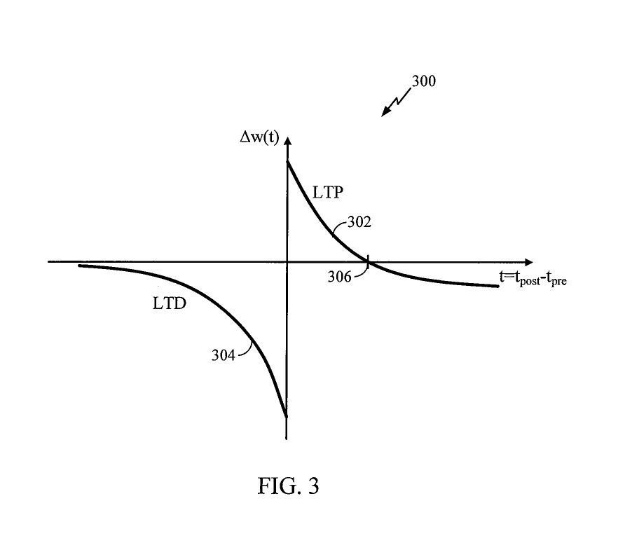

FIG. 3 illustrates an example graph diagram 300 of a synaptic weight change as a function of relative timing of pre-synaptic and post-synaptic spikes in accordance with the STDP. If a pre-synaptic neuron fires before a post-synaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between pre-synaptic and post-synaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input is in the form of a frame of a particular duration comprising spikes or pulses), the offset value μ can be computed to reflect the frame boundary. A first input spike (pulse) in the frame may be considered to decay over time either as modeled by a post-synaptic potential directly or in terms of the effect on neural state. If a second input spike (pulse) in the frame is considered correlated or relevant of a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and have stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any) can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics,

$$\frac{d {v}_{n} ( t )}{d t} = α {v}_{n} ( t ) + β {\sum }_{m}^{ } {w}_{m , n} {y}_{m} ( t - Δ {t}_{m , n} ) , \qquad ( 2 )$$

where α and β are parameters, w_{m,n} is a synaptic weight for the synapse connecting a pre-synaptic neuron m to a post-synaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a post-synaptic neuron is established until the time when the post-synaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.,

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in biologically-consistent linear fashion. The time constant in the supra-threshold regime, positive by convention, reflects anti-leaky channel dynamics generally driving a cell to spike while incurring latency in spike-generation.

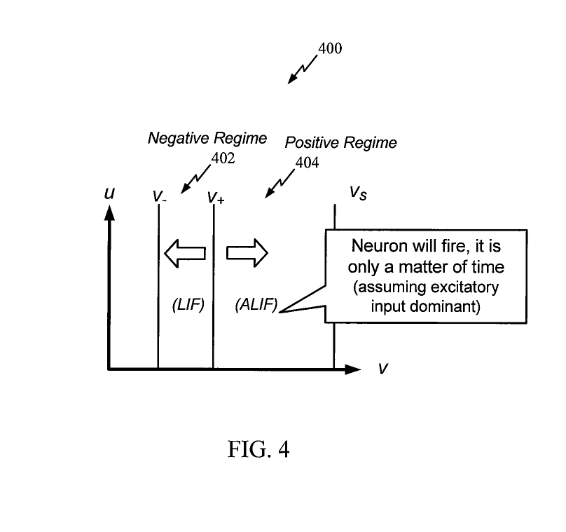

As illustrated in FIG. 4, the dynamics of the model may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as,

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are

q_{ρ}=−τ_{ρ}βu−v_{ρ} (7)

r=δ(v+ε) (8)

where δ is a coupling conductance-time parameter, ε is a coupling offset voltage, and β is a coupling resistance. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model is defined to spike when the voltage v reaches a value v_{S} (spike voltage). Subsequently, the state is typically reset at a reset event (which technically may be one and the same as the spike event):

v=\hat{v}₋ (9)

u=u+Δu (10)

where \hat{v}₋ is a reset voltage and Δu is a recovery current reset offset. The reset voltage \hat{v}₋ is typically set to v₋.

By a principle of momentary coupling, a closed form solution is possible not only for state (and with a single exponential term), but also for the time required to reach a particular state. The close form state solutions are

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{ρ}}} - r & ( 12 )\end{matrix}$$

Therefore, the model state may be updated only upon events such as upon an input (pre-synaptic spike) or output (post-synaptic spike). Operations may also be performed at any particular time (whether or not there is input or output).

Moreover, by the momentary coupling principle, the time of a post-synaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches v_{S}, then the closed-form solution for the amount of time, or relative delay, until a spike occurs as measured from the time that the voltage is at a given state v is

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \qquad ( 14 )$$

where \hat{v}₊ is a regime threshold and is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

More details about the Hunzinger Cold model and possible implementations will follow in the present disclosure.

### Neural Coding

A useful neural network model, such as one comprised of the artificial neurons 102, 106 of FIG. 1, may encode information via any of various suitable neural coding schemes, such as coincidence coding, temporal coding or rate coding. In coincidence coding, information is encoded in the coincidence (or temporal proximity) of action potentials (spiking activity) of a neuron population. In temporal coding, a neuron encodes information through the precise timing of action potentials (i.e., spikes) whether in absolute time or relative time. Information may thus be encoded in the relative timing of spikes among a population of neurons. In contrast, rate coding involves coding the neural information in the firing rate or population firing rate.

If a neuron model can perform temporal coding, then it can also perform rate coding (since rate is just a function of timing or inter-spike intervals). To provide for temporal coding, a good neuron model should have two elements: (1) arrival time of inputs affects output time; and (2) coincidence detection can have a narrow time window. Connection delays provide one means to expand coincidence detection to temporal pattern decoding because by appropriately delaying elements of a temporal pattern, the elements may be brought into timing coincidence.

### Arrival Time

In a good neuron model, the time of arrival of an input should have an effect on the time of output. A synaptic input—whether a Dirac delta function or a shaped post-synaptic potential (PSP), whether excitatory (EPSP) or inhibitory (IPSP)—has a time of arrival (e.g., the time of the delta function or the start or peak of a step or other input function), which may be referred to as the input time. A neuron output (i.e., a spike) has a time of occurrence (wherever it is measured, e.g., at the soma, at a point along the axon, or at an end of the axon), which may be referred to as the output time. That output time may be the time of the peak of the spike, the start of the spike, or any other time in relation to the output waveform. The overarching principle is that the output time depends on the input time.

One might at first glance think that all neuron models conform to this principle, but this is generally not true. For example, rate-based models do not have this feature. Many spiking models also do not generally conform. A leaky-integrate-and-fire (LIF) model does not fire any faster if there are extra inputs (beyond threshold). Moreover, models that might conform if modeled at very high timing resolution often will not conform when timing resolution is limited, such as to 1 ms steps.

### Inputs

An input to a neuron model may include Dirac delta functions, such as inputs as currents, or conductance-based inputs. In the latter case, the contribution to a neuron state may be continuous or state-dependent.

### General Principles for Neuron Model

Certain aspects of the present disclosure provide general principles for designing a useful spiking neuron model. A useful neuron model is one that is practical and that can be used to model rich, realistic and biologically consistent behaviors. Further, a useful neuron model can be used to both engineer and reverse-engineer (interpret) neural circuits in terms of well-defined stable computational relations.

Behavior from Events

Natural cells appear to exhibit various behaviors including tonic and phasic spiking and bursting, integrating inputs, adapting to inputs, oscillating sub-threshold, resonating, rebounding, accommodating input features, and more. Often, different behaviors may be induced in the same cell by inputs with different characteristics. In the present disclosure, these behaviors may be considered from the point of view of the events that cause the behaviors.

Accordingly, cells may be viewed as abstract event state machines in which cell dynamics between events are determined by machine state, and transitions between machine states are determined by events. In this context, the machine state is a meta-state that governs characteristics of the dynamics rather than the model state variables themselves. The model state variables evolve according to the dynamics in the meta-state.

In this view, events set cell dynamics in motion until the next event. Dynamics between a prior event and a next event are defined depending on machine state, which is determined based on the prior event. However, it is important to distinguish that this does not prevent state from being determined at any time between events, but it only prevents the dynamics definition from changing. This abstract event state machine concept allows the definition of dynamics to differ across machine states. One may thus define or parameterize dynamics in one way for one subset of machine states or regimes, and in another way, independently, for another subset of machine states. This means that dynamics in different machine states or regimes can be defined independently. In an aspect, behavior does not need to differ for all machine states, nor is it necessary for every event to cause a significant change, or even any change, in dynamics.

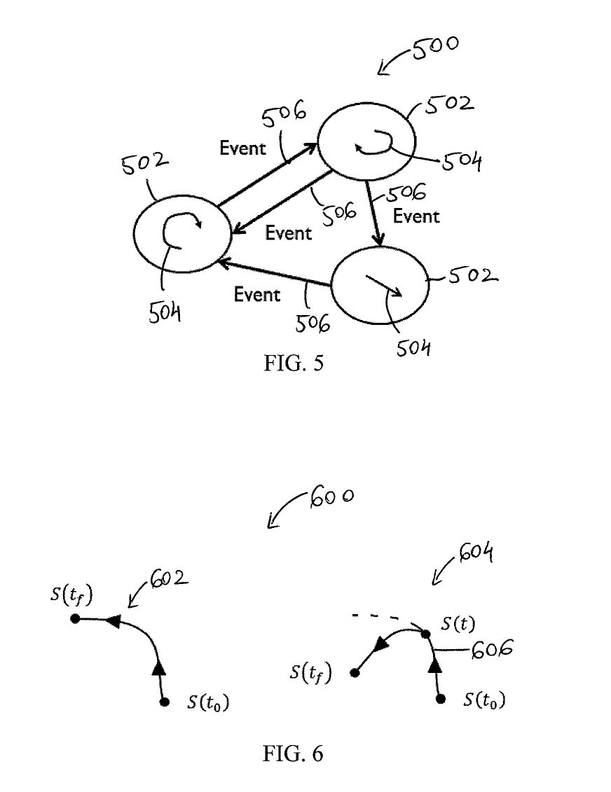

FIG. 5 illustrates an example 500 of the abstract event state machine concept in accordance with certain aspects of the present disclosure. Machine states are depicted as circles 502, while the dynamics of model state variables within a machine state are represented by arrows 504 within the circle 502. Transition between machine states occurs at events as indicated by arrows 506 between the circles 502.

In an aspect, three consecutive events can be considered, where the first and last events comprise instantaneous inputs that significantly alter a cell's state at their time of occurrence. For simplicity, these events can be Dirac delta functions added to a voltage state representative of some equivalent integrated current or conductance-based input affecting a cell's membrane potential. However, the interim event between the first and last input events can be considered as having no associated input or output. According to certain aspects of the present disclosure, a hypothetical neuron model can be considered in which the behavior of the model is defined to change depending on whether the interim event is included or omitted, even though the event has no associated input or output.

In order to achieve a rich behavioral repertoire representative of a biological cell, one would need an event state machine that can exhibit complex behaviors. Yet, a computationally well-defined well-behaved low-complexity model is also a desirable objective. If the occurrence of an event itself, separate from any contribution to state variables (such as input, if any), can influence the state machine and change constraints on dynamics subsequent to the event, then the future state of the system is not only a function of a prior state, time and input but rather a function of a state, time, input and the event. Given more dependencies, there is more freedom to design individual model dependency relations and dynamics in different meta-states or regimes. Hence, the model elements can potentially be of lower complexity and yet yield an overall model that may achieve a richer behavioral repertoire.

Moreover, the model can be defined theoretically in formal terms of events. Since machines are amenable to event-based processing as opposed to continuous-time processing, the model may then be implemented as theoretically defined rather than implementation approximating theory. The present disclosure provides a new harmonious approach, embracing events as a foundation of a model as opposed to dealing with events as inconvenient practical constraints.

The above abstract principles can be expressed mathematically by defining a univariate or multivariate state S that evolves absent of any events between time t₀ and t_{f} according to some function of the prior state and elapsed time. The state at any time t between an event at time t₀ and an event at time t_{f}>t may be expressed as,

S(t)=f(t−t₀,S(t₀)). (15)

By definition, there is a closed-form expression for the state as it evolves between events. However, if there is an event at time t between the two events, then the state at time t_{f}>t may be,

S(t_{f})=f(t_{f}−t,f(t−t₀,S(t₀)))≠f(t_{f}−t₀,S(t₀)). (16)

The significance of this is that the dynamics of the model may follow a different path regardless of input or even whether there is an input only because of the existence of an event. FIG. 6 illustrates an example 600 of this particular situation, i.e., examples 602, 604 of events that invoke changes in dynamics. In the example 602, there is no interim event between times t₀ and t_{f}. In the example 604, there is an interim event with no input or output. However, the trajectory of a state 606 may change at the interim event at time t.

A neuron model with a multi-variate state is not fundamentally incompatible with such a notion. Counter-intuitively, dynamics may be defined independently for the state variables. If dynamics are decoupled, the question is what the advantage of a multi-variate state is. In an aspect, a multi-variate state may provide the opportunity to transition to a new meta-state upon an event where the dynamics in the new meta-state are determined based on the state at the time of the event. In other words, a multi-variate state may provide another dimension for determining behavioral changes at the time of events.

This event-based view may provide a framework for designing a neuron model with rich behavioral capabilities with smaller computational complexity. This framework can be the basis for further principles that may shape design of a spiking neuron model.

### Coincidence Detection and Plasticity

The ability of a spiking neuron model to detect fine timing coincidences may depend on memory characteristics. Leaky-integrate-and-fire neuron models with exponential decay are able to detect temporal coincidences to a certain degree depending on the rate of leak (or decay), which determines how fast the neuron forgets about the prior input. Such models may be limited in terms of other computational properties or biological behaviors that may be reproduced. However, while considering alternate or more sophisticated models, it may be beneficial to retain advantages of this leaky-integrate-and-fire behavior, including desirable memory characteristics.

A basic exponential leaky-integrate-and-fire model may be defined as having a state which decays over time Δt toward rest (which can be defined without loss of generality as 0), absent any input, according to,

v(t+Δt)=v(t)e^{-Δt/τ}, (17)

where v is the state (e.g., voltage) and τ is a time constant. The rate of decay is decelerating so the difference in the decay curves for two different starting states is greatest at the starting point and converges thereafter. Therefore, any change in input magnitude at a particular time, which would alter state at that time, has a monotonically decreasing effect in the cell's memory.

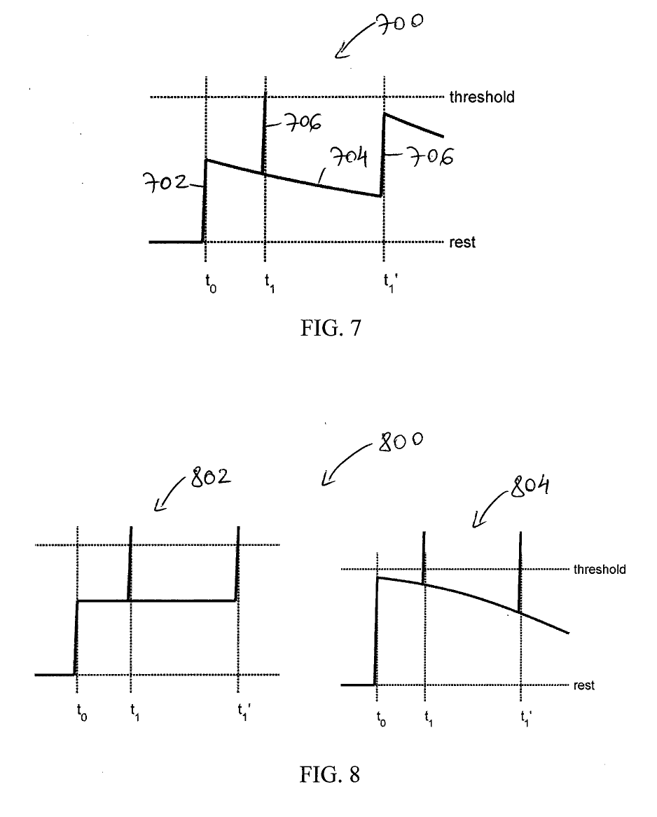

FIG. 7 illustrates an example behavior 700 of a leaky-integrate-and-fire model with exponential decay in two overlaid scenarios. For example, there are two input events in which the input contributions are modeled as Dirac delta functions added to the state variable at the time of the respective event. The first input event 702 may occur at time t₀, increasing the state trace 704 by a step amount. The second input 706 may occur at a later time with a sufficient input magnitude such that the two input quantities, if added together, would bring the state above a threshold 708 for the model to spike. However, whether the second input occurs at a time t₁ or t₁′ affects whether the state rises above the threshold. If the second input event 706 occurs sufficiently soon after the first input event 702, then the threshold 708 may be exceeded. Otherwise, the memory of the first input 702 has decayed and the second input 706 may be insufficient to trigger a spike. Thus, there is a means to detect whether the first event 702 and the second event 706 were close, or coincided, in time.

FIG. 8 illustrates behaviors 800 of two alternative models that demonstrate counter examples: either the inability or the difficulty of detecting coincidences. An integrate-and-fire model, depicted on the graph 802, is unable to detect timing coincidences because the model does not forget. A relatively more sophisticated model, such as a model with a quadratic expression for the state derivative, depicted on the graph 804, may not fundamentally have as fine timing coincidence detection capability. The quadratic expression for the state derivative is of the form dv/dt=v(v−v_{threshold})/τ, similar to the Simple Model of Izhievich. Although the parameters of a more sophisticated model may be varied, to decrease the effective time constant, the same applies to a leaky-integrate-and-fire model. The underlying dynamic (shape) remains as a fundamental property regardless of time scale.

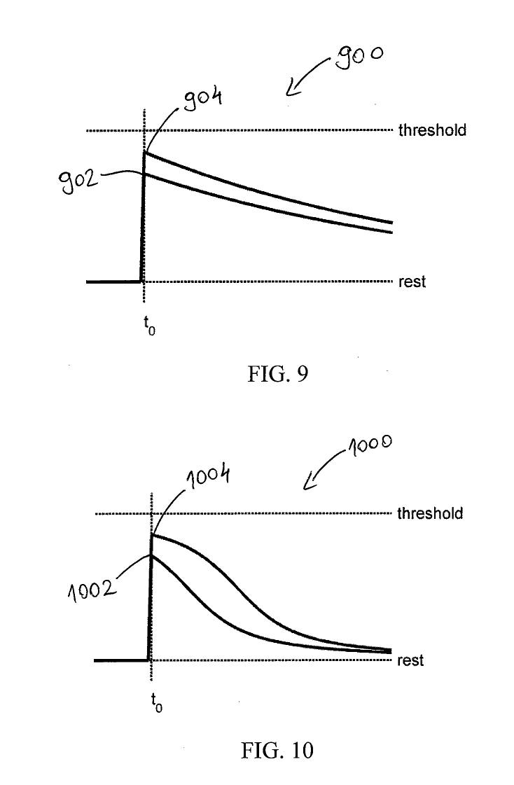

FIG. 9 illustrates an example 900 of the monotonically decreasing difference in the state of a leaky-integrate-and-fire model if an input magnitude is changed from a value 902 to a value 904. As illustrated in FIG. 9, the model forgets the difference between inputs over time.

FIG. 10 illustrates a counter-example 1000 based on a quadratic model when an input magnitude is changed from a value 1002 to a value 1004. The difference in state decay is non-monotonic for the input magnitude that is changed. As illustrated in FIG. 10, the states in the two cases first diverge, increasing the difference before decreasing. Hence, the model remembers differences larger than actuality (at the time t₀ of input) before forgetting the difference between the inputs.

These memory behaviors are relevant in learning because input magnitudes are typically variable during learning due to adaptation of the weight (strength) applied to an input. Spike-timing-dependent plasticity typically involves adjusting a synaptic (connection) weight (strength) by an amount depending on the time difference between input event and spike output event. With a monotonically decreasing memory behavior, a weight adjustment has a stable impact in the sense of a decreasing impact over time. However, with a non-monotonic memory behavior, a weight adjustment would have an unstable effect in the sense that it may have either a larger or smaller impact on a future event depending on the latency between the input event and the future event.

Nevertheless, one might consider a broad coincidence detection capability desirable in a particular circumstance. Rather than modifying neuron model dynamics to suit such an objective, input or input filtering may be defined to suit the circumstance. There are many ways to shape input into broader forms. However, it would be difficult to get a cell to detect a narrower coincidence than permitted by dampened dynamics. Dulling a neuron model's temporal coincidence detection capability would limit resolution for all inputs.

An excitatory or inhibitory post-synaptic potential (input effect) may be modeled as a linear combination of exponentials,

i(t)=Σⱼaⱼe^{-(t-t}^{ⱼ}^{)/τ}^{ⱼ}. (18)

Typically, the difference between two exponentials may provide a sufficiently realistic waveform. In an aspect, there may be one or more events associated with the input. For example, the input event may be considered as coinciding with the peak or start of the waveform (or any other arbitrary reference point or point(s)). Since the input itself can be spread over time, the time window over which coincidence detection can be performed can be controlled by input definition or filtering.

An important distinction is that the abstract event state machine concept does not prevent a model from receiving input broader than Dirac delta functions. Whether input is defined in discrete or continuous form, equivalent input can be applied to a model at the time of an input event or events.

Retaining fine timing coincidence detection capability in a neuron model, such as afforded by leaky-integrative behavior, may allow both narrow and broad coincidence detection. However, temporal coincidence detection capability gives a framework for decoding information coded in time and outputting information coded in rate (spike or no spike). A basic leaky-integrate-and-fire model fires when the final element of input arrives (or some fixed latency thereafter). Thus, the output time may be constrained by the final contributing input. This is the reason for the distinction that the output information is coded in rate, and not in time. All else being equal, more information can be coded in a spike timing pattern than in a spiking rate. Information coded in time is more general. While spiking rate is a characteristic of a spike time pattern, there is no unique spike time pattern for any given spiking rate. Thus, a spike timing pattern yields a rate, but the reverse does not hold.

### Temporal Computation

Spiking neuron models are often defined in terms of a threshold. Typically, when the threshold is exceeded, the model spikes, possibly with some latency. The question that arises is whether the concept of latency-to-fire is computationally useful.

If a cell would fire immediately or even with a particular latency once reaching a particular condition, the usefulness might be limited since a fixed delay can be achieved by other means such as by axonal, synaptic, or dendritic processes. Nevertheless, there might be an advantage if the relative delay between an invoking event (a sufficient input to transition machine state) and the spike event (output) was variable. In particular, there may be a significant advantage if that relative delay depends on inputs or events subsequent to (or at or before) the invoking event. Such a general computational ability would indeed be useful, particularly if the output timing was a well-defined function, because it would not only provide a framework for engineering a system with spiking neurons but also a framework for understanding what a network of spiking neurons is computing.

In particular, if the delay of an output spike is a well-defined function of relative delays from a reference event and any interim events (including inputs), a function would be defined that gives a relative output time Δt_{k,r} as a function of relative input times Δt_{i,r},

Δt_{k,r}=f({Δt_{i,r}|iεIₖ}), (19)

where Iₖ is the set of inputs to cell k. Essentially, post-synaptic spikes can be viewed as coding information in the form of the relative time Δt of the spike as compared to a reference time tᵣ. The reference time may be arbitrary or some prior spike time such as the time of a first pre-synaptic spike or last post-synaptic spike.

Coding information in time presents certain challenges. Cells may have limited memory of inputs and timing may be consistent only to a particular finite resolution. This means that coding more information requires more time. However, the more important the information, the sooner that information should be conveyed. Accordingly, certain aspects of the present disclosure support viewing the information in relative time as x having a normalized range [0, 1], without loss of generality, where the time delay to convey the information may be expressed as,

Δt=−α log x, (20)

such that the larger the value x is (more significant information), the shorter the time delay (response) is. A value of one corresponds to instantaneous response (no delay) and a value of zero (no significance) corresponds to infinite delay (no input or never outputting a spike). Viewing both input and output timing in this context can motivate a dynamic in which the sooner an input occurs or the more significant an input, the sooner an output occurs.

A variable output latency relative to a last contributing input or invoking event may be achieved with an anti-leaky dynamic, i.e., a dynamic in which state moves toward a spiking condition or has positive feedback. According to the aforementioned information time coding principle, dynamics may be desirable where inputs occurring earlier have a larger impact on output time. This differs from a dynamics in which feedback is negative as in leaky-integrative behavior. However, rather than attempting to combine leaky-integrative behavior with anti-leaky-integrative behavior, the abstract event state machine concept presents a framework for defining multiple separate behavioral regimes or sets of meta-states so that dynamics in different machine states may be defined or parameterized independently.

In a simple example, leaky-integrative behavior may be defined in one machine state regime and anti-leaky-integrative behavior may be defined in another machine state regime. These can be referred to as sub-threshold and super-threshold behaviors. However, the term threshold may be misleading in the context of an abstract event state machine because the transition between machine states occurs on events, not on a state condition per se. A state condition may not be related with a machine state transition, as discussed above, unless there is an event.

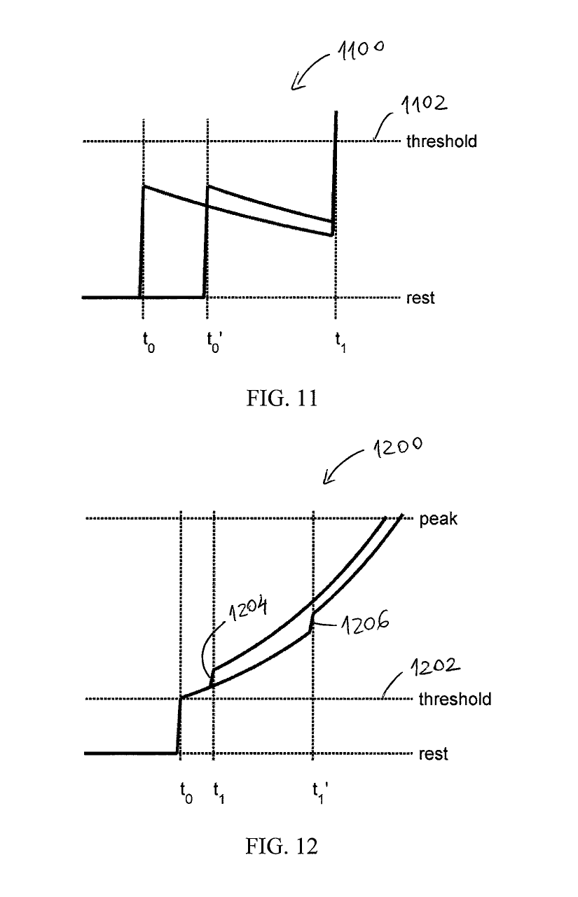

It can be observed that a leaky-integrate-and-fire model is insufficient. For example, the leaky-integrate-and-fire model is not sufficiently flexible. In an aspect, inputs may be expressed as linear combinations of quanta of discrete input, such as Dirac delta functions. Two input events can be considered occurring at times t₀ and t₁, neither of which is sufficient to bring a leaky-integrate-and-fire model above a threshold alone. However, together, if the input magnitudes were summed, the voltage change would bring the model above the leaky-integrate-and-fire model's threshold. FIG. 11 illustrates an example 1100 of the voltage state dynamics over time for two cases in which the only difference is the time of the first input event, i.e., time t₀ vs. time t₀′. However, it should be noted that regardless of whether the first input occurs at t₀ or at t₀′ the cell exceeds a threshold 1102 at the same time t₁, and thus there is no means to distinguish the two input cases from the output of this cell.

In another aspect, inputs are not discrete Dirac delta functions. In an abstract event state machine, inputs may contribute to machine state transition only on events. Accumulated or equivalent integrated input may be applied to transition machine state only at events. Therefore, the same principles apply to input magnitude as well as input timing.

A basic exponential anti-leaky-integrate-and-fire model may be defined in a conventional modeling sense as having a state which increases if it is above a threshold (which can be defined without loss of generality as 0) over time Δt toward a peak, absent any input, according to,

v(t+Δt)=v(t)e^{Δt/τ}. (21)

The term conventional refers to the formulation not strictly according to the proposed abstract event state machine framework in order to demonstrate a basic principle. This model can be viewed as demonstrative to make a point regarding timing behavior in reference to a threshold. With such an anti-leaky-integrate-and-fire model, timing differences can be distinguished because the time to reach the peak may depend on the input timing.

FIG. 12 illustrates an example comparison 1200 of two situations demonstrating this point in accordance with certain aspects of the present disclosure. In both cases, the state is above a threshold 1202 at time t₀ and thus begins rising. However, in the first case, a first input event 1204 occurs at time t₁ and the rise toward the peak is accelerated. In the second case, the same input event 1206 occurs at later time t₁′ with the same input contribution (magnitude). Nevertheless, the output time changes as a result because earlier input accelerates the anti-leaky dynamic. The same output time could be achieved if the input was substantially changed (increased) at time t₁′. However, that is not what is desired. In this case, the input magnitude would be different, not the same. If the magnitude of the input at time t₁ was changed, the trend from time t₁ would also change. The objective here is a mechanism to distinguish timing.

On a related note, the range of magnitude of synaptic weights (connection strengths) is typically constrained. Therefore, without loss of generality, a weight may be defined to have a sign (excitatory or inhibitory) and normalized range (e.g., range [0,1]). Moreover, plasticity rules for learning may tend to result in clustering of weights bi-modally (i.e., near 0 and near 1).

Certain aspects of the present disclosure support a conceptual model in the spirit of an abstract event state machine based on combining leaky-integrate-and-fire behavior with anti-leaky-integrate-and-fire behavior by defining behavior in two regimes separately. The term threshold can be used loosely to reflect a condition applying at an event that transitions from one regime to the other, i.e., the transition event linking a state before and after the event.

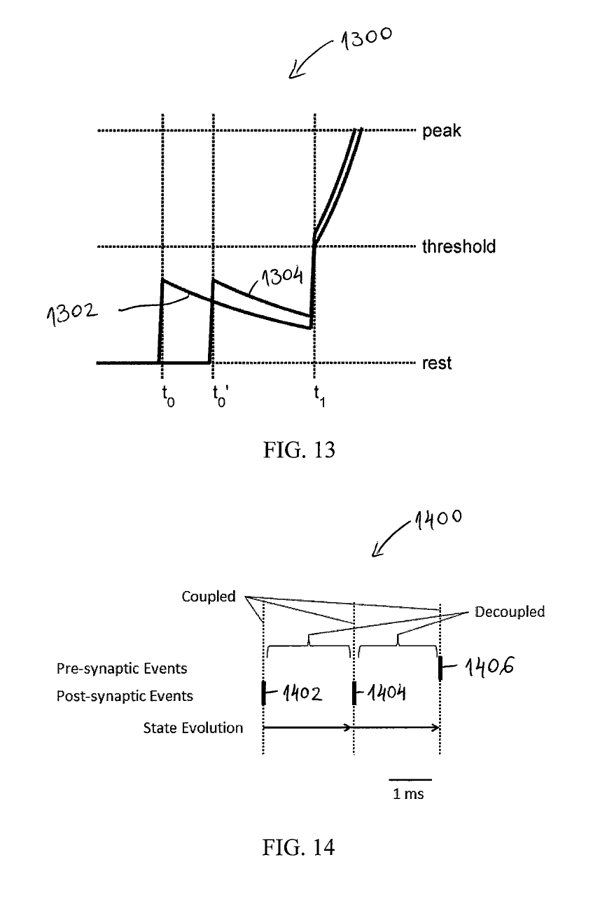

FIG. 13 illustrates two input timing graphs 1302 and 1304 in the context of a neuron model construct where both the leaky and anti-leaky behaviors are exhibited. Notably, the model construct is able to distinguish input timing differences in either regime in terms of output time. FIG. 12 illustrates a distinction of input timing in the positive (anti-leaky) regime, wherein FIG. 13 illustrates a distinction of input timing in the negative (leaky) regime when a first input event time is changed from t₀ to t₀′. As a result, the state at the time t₁ of the second input event (i.e., plot 1302 vs. plot 1304 in FIG. 13) is different.

A neuron model based on the above concepts is presented in this disclosure. The dynamics and mathematical expressions for computation functionalities described above will be discussed in detail in subsequent sections as pertaining to such a model defined according to the principles described in this section, including temporal computation.

One important question is whether anti-leaky-integrate-and-fire behavior might exist in biological cells. Biological cells have regenerative upstroke dynamics generating the voltage spike. The A-channel is a voltage-gated transient Potassium ion channel that activates quickly, which can counteract rapid sodium influx and slow the regenerative upstroke. As a result, it is possible to achieve very long latencies (hundreds of milliseconds or longer) from the time the upstroke is invoked until the spike peak occurs. The voltage level to trigger the A-channel may be slightly below the “threshold” for the sodium channel chain reaction so the actual timing of events and input may alter the latency properties as well.

### Practical Theory

It should be noted that there is no ideal theoretical model that is the baseline or metric by which all other models should be judged or strive to be like. Models are their designer's constructs, designed for their modeler's purposes. From a biological modeling perspective, a neuron model is desired for which it can be easy to determine parameters to match a biological cell's behavior over a range of conditions, i.e., richness in behavioral capability is an advantage.

A good model would allow designing an instance to represent particular behavior, such as a biologically observed behavior. Further, a good model would not change dynamics in one regime away from biologically desired behavior every time one tries to design the behavior in another regime. Behavior would not generally change dramatically with a small numerical parameter change unless on the border of a point of inflection. In addition, a good model would be defined theoretically and possible to implement as theoretically defined (and convenient to implement efficiently as theoretically defined) without incurring numerical differences depending on the implementation. In other words, a good model would behave the same in different implementations. In addition, a good model may be able to reproduce designed biological behavior without leveraging numerical artifacts and rather than based on theoretically defined dynamics.

A well-defined practical model is also desired that provide a stable computational framework, so that cells and networks can be designed rather than search parameter spaces and so that existing networks can be understood in computational terms. A model is desired that, as implemented, behaves as theoretically defined.

### Model Definition

The goal is a behaviorally rich biologically-consistent computationally-convenient model of a neuron which adheres to the principles described above. Certain aspects of the present disclosure support design of a neuron model that can achieve these principles. The general neuron model is unique in that it is defined by the state at the time of events and by operations governing the change in that state from one event to the next event.

Studies of large-scale biological spiking neural networks are motivated to rely on neuron models with rich representation of electrophysiological behaviors and mathematical tractability. Recently, a variety of non-linear models have been shown to reproduce a substantial set of characteristic neuro-computational properties. However, while it has been suggested that the quadratic model may be the simplest model able to reproduce such properties, adding sustained sub-threshold oscillation to the repertoire requires another model. Moreover, solving such models may require numerical methods due to coupled non-linear dynamics. Ensuring stability with plasticity can also constrain modeling parameters. In the present disclosure, a different approach is taken, proposing a new parsimonious linear spiking neuron model. It reproduces a rich variety of neural dynamics including sustained sub-threshold oscillation and the behavioral collection exhibited by non-linear models. The model has dual-regimes governed by sub-threshold leaky-integrate and supra-threshold anti-leaky-integrate-and-fire dynamics along with linear coupling. Time constants and coupling in each regime may be independent and thus relatable to physiological properties on a per-regime basis (e.g., behavior of voltage-gated K⁺ channels; transient A-currents). Due to linearity, spike-timing-dependent plasticity (STDP) alters post-synaptic potential monotonically over time yielding stability advantages for temporal coding. Closed-form solutions provide future state given delay and delay to reach a given future state (spike). A principle of momentary coupling can also be applied. The model is uniquely amenable to theoretical analysis and event-based hardware simulation of large-scale biological spiking networks with arbitrarily fine timing. The linear supra-threshold dynamics is leveraged to show that a spiking network can compute a general linear system of equations by encoding information in spike timing.

The present disclosure formulates a minimal dual-regime linear spiking neuron Model based on neuro-computational dynamics principles and demonstrates that the Model can reproduce a rich variety of behaviors including such sub-threshold features as sustained oscillation. The Model's one- or two-dimensional linear dynamics may have two regimes. The time constant (and coupling) can depend on the regime. In the sub-threshold regime, the time constant, negative by convention, represents leaky channel dynamics generally acting to return a cell to rest in biologically-consistent linear fashion. The time constant in the supra-threshold regime, positive by convention, reflects anti-leaky channel dynamics generally driving a cell to spike while incurring latency in spike-generation due to the role of voltage-gated K⁺ channels and transient A-current. The linear sub- and supra-threshold dynamics are analyzed in relation to biological evidence and compared to prior non-linear models. It is also analyzed how long-term potentiation (LTP) and long-term depression (LTD) change the shape of post-synaptic potential (PSP) in a temporal coding context. In the new Model, the PSP difference for a given change in synaptic strength is monotonically decreasing over time, revealing a potential stability advantage during plasticity.

A unique method of engineering and reverse-engineering (interpreting) spiking neural networks using the new Model is discussed. Methods of engineering rate-based networks have been proposed. However, whether spiking or not, the information in such networks can be coded in firing rates. Moreover, a variety of tuning curves and filters are often required. A consequence of the Model is that there are closed-form solutions for both future state and spike latency. Remarkably, if considering relative spiking timing as encoding negative log information values, then, in the linear supra-threshold regime of the Model, information in post-synaptic spike latency may become a linear function of information in relative pre-synaptic spike timings. This means that a linear system of equations can be effectively computed in real-time by a spiking neural network. This is possible even without precise synaptic weights because the coefficients of the linear system can alternatively be represented by synaptic delays. Positive and negative coefficients may translate to excitation and inhibition, respectively. Conveniently, larger coefficients may translate to shorter delays so significant responses naturally occur (spike) sooner. Precision may depend on timing resolution, and the linear model is particularly amenable to large-scale event-based modeling of spiking neural networks at arbitrarily fine time resolution.

### Model Dynamics

In accordance with certain aspects of the present disclosure, the designed Model is defined in terms of events, wherein the events are fundamental to the defined behavior. The behavior may depend on the events, and the inputs and outputs may occur upon events and the dynamics are coupled at events.

The dynamics of the neuron Model can be divided into two regimes called the negative regime (also referred to as the leaky-integrate-and-fire regime) and the positive regime (also referred to as the anti-leaky-integrate-and-fire regime). Formulation of dynamics in terms of events and separation of the dynamics into these two regimes are fundamental characteristics of the presented neuron Model. In the negative regime, the state generally tends toward a target condition at the time of a future event. In this negative regime, the neuron Model can exhibit temporal input detection properties and other so-called sub-threshold behavior as well as other more complex dynamics. In the positive regime, the state generally tends away from an anti-target condition. In this positive regime, the neuron Model can exhibit computational properties such as incurring latency to spike depending on subsequent input events as well as other more complex dynamics.

The symbol ρ will be used in the present disclosure to denote the dynamics regime with the convention to replace the symbol ρ with the sign ‘−’ or ‘+’ for the negative and positive regimes respectively when discussing or expressing a relation for a specific regime. The multivariate Model state is comprised of a membrane potential (voltage) v and an abstract recovery current u. In basic form, the regime ρ is essentially determined by this state at the time of an event. The neuron Model is defined to be in the positive regime upon a next event if the voltage v at the prior event is above a threshold v>\hat{v}₊, and otherwise the neuron Model is defined to be in the negative regime. For now, the typically setting can be considered where \hat{V}₊ is set equal to a constant v₊.

The dynamics of the Model state are conveniently described in terms of dynamics of a transformed state pair {v′,u′}. The state transformations at the time of an event are,

v′=v+q_{ρ}, (22)

u′=u+r, (23)

where q_{ρ} and r are the linear transformation variables. The voltage transformation may depend on the regime ρ. The Model dynamics, which are also dependent on the regime, are defined by differential equations in terms of the transformed state pair,

$$\begin{matrix}{τ}_{ρ} \frac{d {v}^{′}}{d t} = {v}^{′} , & ( 24 ) \\ {τ}_{u} \frac{d {u}^{′}}{d t} = - {u}^{′} , & ( 25 )\end{matrix}$$

where, as aforementioned, τ₋ is the negative regime voltage time constant, τ₊ is the positive regime voltage time constant and τᵤ is the recovery current time constant. These are constant values although variable time constants are also possible. For convenience, the negative regime time constant τ₋ can be specified as a negative quantity so that the voltage dynamics can be expressed in the same form for all regimes. The exponent τ₊ as well as τᵤ are generally positive.

The state dynamics of the neuron Model are defined in an event framework. Between events, the dynamics are defined by the ordinary decoupled differential equations above. The dynamics of the two state elements are coupled only at events by the transformations offsetting the states from their null-clines at the time of the event, where the transformation variables are,

q_{ρ}=−τ_{ρ}βu−v_{ρ}′, (26)

r=δ(v+ε), (27)

where, as aforementioned, δ is a coupling conductance-time, ε is a coupling offset voltage, and β is a coupling resistance. A more general formulation with β_{ρ} (where the transformations in the two regimes and the time constants are completely independent) can be also employed. Typically, β is a parameter common across regimes, but as β_{ρ}, can be configured separately for each regime ρ. Similarly, τᵤ is typically common across regimes. The two values for v_{ρ}′ are typically the base or reference voltages for the two regimes, i.e., v_{ρ}′=v_{ρ}. As aforementioned, the parameter v₋ is the base voltage for the negative regime, and the membrane potential will generally tend toward v₋ in the negative regime. As aforementioned, the parameter v₊ is the base voltage for the positive regime, and the membrane potential will generally tend away from v₊ in the positive regime. The parameter ε can be typically set to −v₋.

The Model has closed-form solutions for state evolution at time t+Δt given the state {v′,u′} at time t,

$$\begin{matrix}{v}^{′} ( t + Δ t ) = {v}^{′} ( t ) {e}^{\frac{Δ t}{{τ}_{ρ}}} , & ( 28 ) \\ {u}^{′} ( t + Δ t ) = {u}^{′} ( t ) {e}^{- \frac{Δ t}{{τ}_{u}}} . & ( 29 )\end{matrix}$$

Therefore, the Model state need only to be, and is defined to be, updated upon events such as upon an input (pre-synaptic spike) or output (post-synaptic spike). This can be generalized because operations may also be performed on artificial events (whether or not there is input or output). By definition, transformations are defined at events, not between events. This means that q_{ρ} and r and even ρ should not be recomputed unless there is an event.

Hence, the Model is only coupled at events and the regime (whether positive or negative) is only determined at events. The Model state variables v and u are generally coupled as described above via variables q_{ρ} and r, which are only determined at events (or steps). The variables q_{ρ} and r are computed based on the prior state. The state elements are then evolved independently to the next event. In effect, this means that the state variables are ‘momentarily decoupled’ between events.

FIG. 14 illustrates an example 1400 of momentary coupling at events and decoupling between events in accordance with certain aspects of the present disclosure. As illustrated in FIG. 14, a pre-synaptic (input) event 1402 is followed by another pre-synaptic event 1404 and a post-synaptic (output) event 1406. A state may evolve from event-to-event (i.e., from the event 1402 to the event 1404 and to the event 1406) using decoupled dynamics.

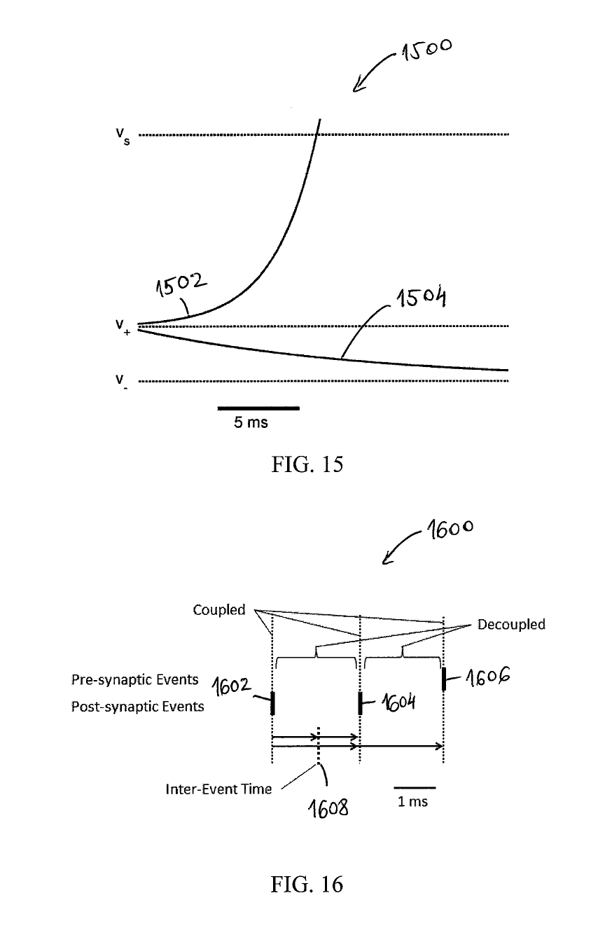

FIG. 15 illustrates an example 1500 of comparison of dynamics in positive and negative regimes in accordance with certain aspects of the present disclosure. FIG. 15 shows that behavior of the voltage (y-axis) of the Model between two events depends on the inter-event-interval (x-axis). Parameters τ₋=−14.3 ms, τ₊=2.6 ms, τᵤ=33.3 ms, v₋=−60 mV, v₊=−40 mV, ε=−v₋, β=0.01 and δ=2 approximately reflect settings for a neocortical pyramidal cell. The voltage offsets are ε₊=ε₋=1 mV. The initial voltage is the voltage at the first event.

In a first case 1502, the state at the time of the first event is v=v₊+ε₊ and u=0, where ε₊ is a small positive voltage offset. Assuming typical settings, the Model will be in the positive regime since v>v₊. As a result of the transformation variable q₊=−v₊, the voltage will increase away from v₊. In a second case 1504, the state at the time of the first event is v=v₊−ε₋ and u=0, where ε₋ is a small positive voltage offset. As a result of the transformation variable q₋=−v₋, the voltage will decrease toward v₋.

The Model is defined to spike (i.e., produce an output event) when the voltage v reaches a threshold value v_{S}. Subsequently, the state is typically reset at a reset event (which technically may be one and the same as the spike output event),

v=\hat{v}₋, (30)

u=u+Δu, (31)

where Δu is a recovery current reset voltage. The reset voltage \hat{v}₋ can be typically set to v₋.

Moreover, the time of a post-synaptic spike may be anticipated so the time to reach a particular state can be determined in advance in closed-form. Given a prior voltage state v₀, the time delay until voltage state v_{f} is reached (from voltage state v₀) is given by,

$$Δ t = {τ}_{ρ} log \frac{{v}_{f} + {q}_{ρ}}{{v}_{0} + {q}_{ρ}} . \qquad ( 32 )$$

If a spike is defined as occurring at the time the voltage state v reaches v_{S} (spike voltage), then the closed-form solution for the amount of time, or relative delay, until a spike occurs as measured from the time that the voltage is at a given state v is,

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \qquad ( 33 )$$

where \hat{v}₊ is a regime threshold and is typically set to v₊. It should be noted that the regime threshold is not the null-cline.

The above definitions of the Model dynamics depend on whether the Model is in the positive or negative regime. As aforementioned, the coupling and the regime ρ are computed upon events. For purposes of state propagation, the regime and coupling (transformation) variables are defined based on the state at the time of the last (prior) event. However, once the state is propagated to the current event, anticipation of spike output time (a next event), the regime and coupling variable are all defined based on the state at the time of the current event after incorporating input.

For momentary coupling with event or step-event update, state evolution from event time t to event time t+Δt may be defined as above in equations (11), (12), (28) and (29). Step-based update may optionally be configured equivalent to event/step-event (by updating q and r only on events) or differently by defining events/moments (computing q and r) at every step. The difference is typically negligible. For computational efficiency, event update (or step-event update if limited to a step-based simulator) implementation may be preferred. In such a case, spike events may be anticipated using the above closed-form expressions (14) and (32). In step update, Δt is a constant (the simulation step) and substituting equations (26)-(27) in equations (28)-(29) accordingly,

$$\begin{matrix}v ( t + Δ t ) = ( {e}^{\frac{Δ t}{{τ}_{ρ}}} ) v ( t ) - {τ}_{ρ} β ( {e}^{\frac{Δ t}{{τ}_{ρ}}} - 1 ) u ( t ) - ( ( {e}^{\frac{Δ t}{{τ}_{ρ}}} - 1 ) {v}_{ρ}^{′} ) , & ( 34 ) \\ u ( t + Δ t ) = ( {e}^{- \frac{Δ t}{{τ}_{u}}} ) u ( t ) - δ ( {e}^{- \frac{Δ t}{{τ}_{u}}} - 1 ) v ( t ) + ( {e}^{- \frac{Δ t}{{τ}_{u}}} - 1 ) δ ɛ . & ( 35 )\end{matrix}$$

Thus, converting an event update or step-event update implementation to step update form may comprise: (i) removal of the condition of update on an event (update at every step) and removal of anticipation of spike and (ii) optional simplification of equations given fixed Δt as described above.

Current and conductance models may be similarly defined and computed from event to event and may be incorporated into the spike anticipation. Alternatively, input models may be computed in a different implementation than the neuron model (e.g., step-updated conductance model with step-event updated neuron model).

Another property of the linear Model is monotonic difference in memory. The difference in the course of membrane potential diminishes over time so, for example, in the negative (LIF) domain (ignoring or omitting a second state for clarity) the difference is monotonically decreasing,

$$\vert {v}_{1} ( t + Δ t ) - {v}_{2} ( t + Δ t ) \vert = \vert ( {v}_{1} ( t ) - {v}_{2} ( t ) ) {e}^{\frac{Δ t}{{τ}_{-}}} \vert \leq \vert {v}_{1} ( t ) - {v}_{2} ( t ) \vert . \qquad ( 36 )$$

Thus, there is a stable effect of spike-timing-dependent plasticity over time: a change in synaptic weight due to spike-timing-dependent plasticity has a decreasing effect on subsequent behavior of a cell over time.

Another property of the linear Model is that relative spike-latency can be expressed as a function of relative input spike timing, which follows from equations (14) and (32). For simplicity of conceptual demonstration, a simple Dirac current spike inputs (weight of 1 or 0) using the heavy-side function θ with one-dimensional state β=0 (or no u) with the threshold at v_{ρ}′=0 (i.e., q=0) can be considered,

$${τ}_{+} \frac{d v}{d t} = v + {\sum }_{i}^{ } θ ( t - {τ}_{i} - Δ {τ}_{i} ) , \qquad ( 37 )$$

where τᵢ is the time of input spike from pre-synaptic neuron i and Δτᵢ is the connection delay from pre-synaptic neuron i. Consequently, the time from increment to voltage membrane state v₀ to spike is,

τ=τ₊ log v_{S}−τ₊ log └v₀+Σᵢe^{-(τ}^{ᵢ}^{+Δτ}^{ᵢ}^{)/τ}^{₊}┘. (38)

Defining b=e^{1/τ}^{₊}, gives a near linear relationship,

b^{-τ}=Δw+Σᵢwᵢb^{-τ}^{ᵢ}, (39)

where wᵢ=q^{Δτ}^{ᵢ}/v_{S}, and Δw=v₀/v_{S}. For sufficiently small Δw, the relation is approximately linear. Thus, log information (negative log of xᵢ) encoded in relative spike timing τᵢ can be considered, and similarly connection delays Δτᵢ related to coefficients wᵢ in the linear domain,

τᵢ=−log_{b}xᵢ;Δτᵢ=−log_{b}(wᵢv_{S}). (40)

Therefore, neuron spike latencies as a function of input spike timing is equivalent to a linear system of equations in a negative log domain. The time at which the voltage state reaches v₀ served as a reference for input and output spike times above, but any time reference may be used for either. The precision of the computation in terms of values in linear domain will depend on timing resolution in the neural spike-timing domain.

### Input and Plasticity

Input may only be applied to the Model at events. In a typical formulation, input may be applied to the Model state after the state has been advanced from a prior event to the time of an input event. Thus more generally,

v′(t+Δt)=hᵥ(v′(t)e^{Δt/τ}^{_{ρ}},i), (41)

u′(t+Δt)=hᵤ(u′(t)e^{Δt/τ}^{ᵤ},i), (42)

where hᵥ and hᵤ are input channel functions. In a simple case, instantaneous current inputs may be modeled as discrete Dirac delta functions, i.e., i=θ(t), applied to voltage state. In this case, input to the Model state applies at the time of the event and,

hᵥ(x,i)=x+iβ;hᵤ(x,i)=x, (43)

where β is the membrane resistance.

However, inputs may alternatively be continuous such as a sum of weighted exponential decays describing an excitatory or inhibitory post-synaptic potential, whether current or conductance based. In this case, input to the Model state is applicable at the time of the event but also potentially before or after the event. Thus, the equivalent total integrated input contribution, from the input for the next event and inputs from past events, as accumulated between a prior event and a next event, may be applied at the time of the next event. Thus, closed-form solutions for continuous input contributions are also an advantage but not required.

A continuous exponentially decaying excitatory or inhibitory input may be defined by,

$${τ}_{g} \frac{d g}{d t} = - g , \qquad ( 44 )$$

which has a closed-form solution and thus may be evolved from event to event decoupled from the {v,u} state. The total contribution over a time period from a prior event at time t to a next event at time t+Δt is given by,

$$i = {\int }_{t}^{t + Δ t} g d t = g {τ}_{g} ( 1 - {e}^{- \frac{Δ t}{{τ}_{g}}} ) , \qquad ( 45 )$$

where g<0 for an inhibitory contribution and where g<0 for an excitatory contribution and the same input channel functions may be used as for Dirac inputs. The input and the state evolution are decoupled and this may, if desired, be compensated for at the time of the event, but is typically unnecessary.

Conductance-based input may also be integrated,

$$i = {\int }_{t}^{t + Δ t} ( v - {E}_{g} ) g d t = ( V - {E}_{g} ) g {τ}_{g} ( 1 - {e}^{- \frac{Δ t}{{τ}_{g}}} ) , \qquad ( 46 )$$

where E_{g} is the reference voltage for the input and V is a voltage level computed to compensate for removing the (v−E_{g}) term from the integral. The approximation V=v(t) (the voltage at the prior event) holds well if v changes by a relatively small amount across events or events occur at small inter-event-intervals. If not, more sophisticated formulations of V or use of artificial events, discussed below, can be used to achieve desired effects while keeping with the definition of the Model.

By definition, the Model does not account for future input between events in spike time anticipation. The general reason for this is the fact that anticipation has a closed-form solution. Even though closed-form solutions may be available for some continuous input formulations, the equivalent effects can be achieved if the rate of events is sufficiently high, by alternatively defining input or channel functions and, otherwise by using artificial events.

By definition, all forms of plasticity apply at events, just like everything else in the Model. Spike-timing-dependent plasticity is particularly suited to this because long-term potentiation and long-term depression can be viewed as triggered by a pre-synaptic (input) event preceding or following a post-synaptic (output) event respectively. Any form of structural plasticity would also, per the definition, apply at events. Structural plasticity may be thought of as modifying, creating or deleting synaptic connections, for example. Equivalently, the parameters of an abstract synapse, such as delay and weight may be changed as if the abstract synapse used to model a deleted synapse was reused to model a new synapse with different parameters. Thus, multiple forms of plasticity may be generalized in terms of variable synaptic parameters. The variability may be at discrete moments or continuous, but regardless are evolved in the Model from event to event.

### Algorithmic Solution

The algorithmic solution to the Model may comprise: (i) advancing the state from a prior event to a next event; (ii) updating the state at the next event time given the input at the next event time (or applying, at the time of the next event, an input equivalent to that accumulated between the prior and next events); and (iii) anticipating when the next event will occur. Events may include input events, which are typically considered to occur at the time a synaptic input propagates to the neuron's soma. Events may also include output events, which are typically considered to occur at the time a spike is emitted by the neuron's soma and begins propagating along the axon. Since closed-form solutions are available, the Model state may also be determined between events if so desired, but regime and coupling are not to be updated unless there is an event.

The following algorithm describes the operations typically conducted upon an event. The state may advance depending on the event. Then, one may advance and apply input (if the event or inter-event interval has input), and anticipate next event (output). Operations needed to advance the state may differ depending on whether the event is an output event or other event (e.g., input or artificial event).

If the state advances based on non-output event, the time Δt since the prior event time t may be first determined. The regime may be determined based on the prior state {v,u} at the prior event. The transformation q_{ρ} and r may be determined given the regime and prior state. The transformed state {v′,u′} may be determined at the prior event. The advanced transformed state may be determined at time t+Δt. The advanced state {v,u} may be determined at time t+Δt. If the state advances based on output event, the state may be reset.

Advancing and applying input is only needed if there is input at the event or during the time between the prior event and the next event. For advancing and applying input, plastic input parameters may need first to be adapted. The advanced input(s) may be determined at time t+Δt. Any new input(s) may be incorporated at time t (if there is any new input event). Equivalent inter-event-interval integrated input contribution i may be determined. The new state {v,u} may be determined by applying equivalent input i.

If there is any chance that the next output event time has changed, the time to the next output event should be anticipated. For anticipating the next output event, the regime may be first determined based on the new state {v,u}. The updated transformation variable q_{ρ} may be determined, and the relative delay Δt_{S} until the next output spike event may be anticipated. Anticipation of the next output spike generally applies whether an event is an input event, and output event or an artificial event because any state updates may change the anticipated time of the spike.

### Artificial Events

By definition, the Model is updated only upon events. An artificial event represents an event defined for purposes of defining Model dynamics behavior rather than an input or output event per se. There are several reasons why a modeler may wish to define artificial events.

Modelers often wish to see traces of voltage and current state at a fine time resolution. Those states can be computed periodically between events without defining artificial events. This would require computation of the voltage and current using the transformation variables and regime as computed at the prior event (not the prior period). This means that at any inter-event time, the state can be determined, but there is no coupling so the state at the time of the next event does not change regardless of whether or not the state is computed between events.

FIG. 16 illustrates this concept, i.e., illustrates an example 1600 of state dynamics between events that are independent of inter-event updates. As illustrated in FIG. 16, a pre-synaptic (input) event 1602 is followed by another pre-synaptic event 1604 and a post-synaptic (output) event 1606. State may evolve from event-to-event (i.e., from the event 1602 to the event 1604 and to the event 1606) using decoupled dynamics, independently of inter-event update, i.e., an update at an inter-event time 1608.

By definition, the coupling transformations are defined at events, not between events. Transformation variables and regime are only computed at events. This means that q_{ρ} and r and even ρ should not be recomputed unless there is an event. Technically, one may define an artificial event to occur at the time the voltage crosses the regime threshold, which is a time computable in advance due to the closed-form expressions and decoupling between events. Hence, assuming no artificial events have been defined, the voltage and current state may be updated between events if so desired, but based on the parameters and offsets from the prior event. In other words, by definition, coupling should occur only at events.

Defining artificial events allows a modeler to alter the coupling. There may also be reasons for defining artificial events at convenient times. There is no wrong way to define or not define artificial events, but the modeler should understand that defining artificial events generally changes the behavior of the model.

One reason to define an artificial event is to achieve a behavior characteristic of a Model instance with a high rate of events with a Model instance with a lower rate of events. If there is a high rate of input events, the Model dynamics are advanced at small time intervals. However, if there is a low rate of input events, the Model dynamics, without artificial events, may be advanced by larger time intervals. Generally, the difference in behavior may not be significant unless the time intervals are much larger. Even then, adjustments to parameters such as the time constants can be made to compensate.

However, artificial events may be defined as an alternative. In particular, artificial events may be defined to occur between non-artificial events if the interval between the non-artificial events is large. Technically, this can be achieved in several ways. For example, an artificial event can be tentatively scheduled with some delay after each non-artificial event. If another non-artificial event occurs before the artificial event, then the artificial event is rescheduled with some delay after the latest non-artificial event. If the artificial event does occur first, then it is rescheduled again with the same delay. Alternatively, artificial events can be scheduled periodically. Artificial events can also be defined to occur conditionally, such as dependent on state or spiking rate or at a time computed in advance.

Artificial events are often unnecessary to achieve desired behaviors in networks with substantial fan-in or fan-out connectivity because there is a substantial number of inputs to each cell each contributing input events to the receiving cell. Consequently, if a particular behavior requiring periodic events is desired, the input events themselves may be more than sufficient to satisfy that role as well.

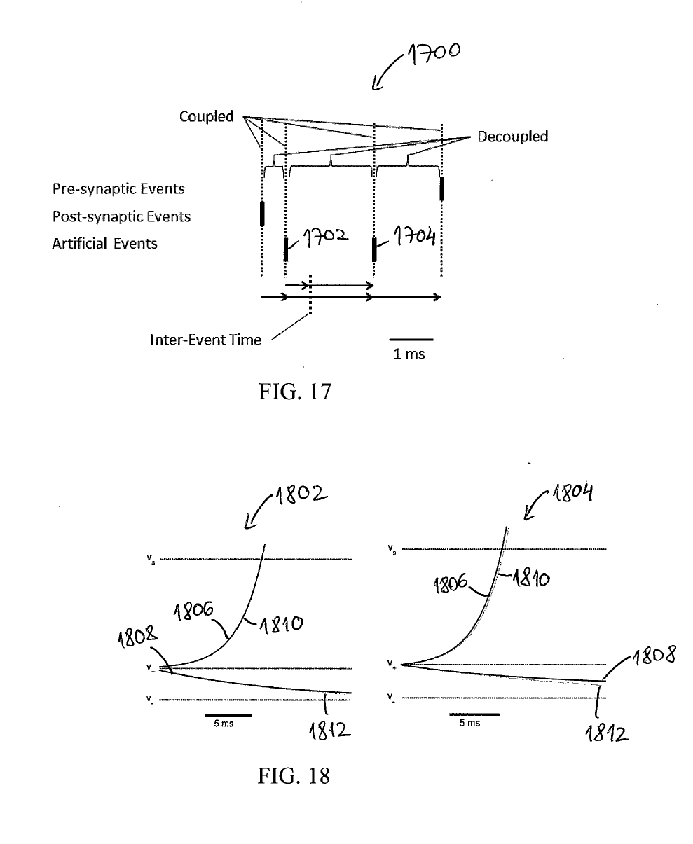

FIG. 17 illustrates the concept of artificial events, i.e., illustrates an example 1700 of artificial events 1702 and 1704 that influence dynamics despite absence of input or output. Artificial events may only change the coupling of the Model. Thus, at any inter-event time, e.g., at an inter-event time 1706, the state may evolve decoupled since the last event. Again, whether the state is determined at inter-event times or not, the state at the next event will be the same, as illustrated in FIG. 17.

FIG. 18 compares the voltage evolution between two events without artificial events in between (plots 1806, 1808) and with periodic artificial events in between (plots 1810, 1812). For example, artificial events in FIG. 18 may occur at 5 ms intervals. In a graph 1802, it can be observed that the difference is so small as to be hard to distinguish. In a graph 1804, three changes have been made to increase the difference. First, the voltages at the first event have been moved very close to v₊ since this will increase the time delays to reach particular voltage levels and increase the difference. Second, the value of u at the first event was decreased substantially. Third, the artificial events occur at a shorter interval. The difference is still very small but might be significant depending on desired behaviors and the density (or rate) of non-artificial events. It can be also observed from these behaviors that a change in the time constants would compensate for the differences.

Generally, the Model is suited to be solved in event-based simulation as described above. However, the Model may also be solved in conventional step-based simulations. Nevertheless, there are fundamentally two ways to perform this: (i) without artificial events; and (ii) with artificial events. These are, by definition, different instances of the Model. The Model operations are defined to occur at events (whether artificial or other). Thus, without artificial events, the code executing at each step should be conditioned on the occurrence of an event at that time slot (effectively no operation may occur at steps where there is no event). Alternatively, with artificial events, an artificial event can be defined to occur at every time slot. Since the closed-form solutions are available, there is no need for numerical methods regardless of whether the time between events is constant or variable. Another issue is whether the time of events is quantized. Typically, in step-based simulations, time is quantized to the step time. Thus, these instances will differ (whether significantly or not) from event-based formulations regardless of whether artificial events are used or not.

While periodic artificial events would generally require more computations and would therefore be generally less desirable, there are some potential simplifications. For example, the time Δt since the prior event may be a constant (the time interval). Because of that, the transformed state update can be simplified to a single multiplication for each state element. The infinite impulse response filters are then given by,

v′(t+Δt)=c_{ρ}v′(t), (47)

u′(t+Δt)=cᵤu′(t), (48)

where constants are defined as c_{ρ}=e^{Δt/τ}^{_{ρ}} and cᵤ=e^{-Δt/τ}^{ᵤ}.

Another simplification is that spike anticipation may be replaced by checking if v≧\hat{v}_{S} at each interval. The spiking condition was defined to be v≧v_{S}. However, if the artificial events are defined to occur at a quantized time interval Δt, the spiking condition may actually be reached between intervals. As a result, it should be ensured that the spike occurs at the desired time, whether at the event before or at the event after.

### Fundamental Behavior Control

The fundamental Model behavior is controlled by the aforementioned parameters τ₊, τ₋, τᵤ, v₊, v₋, v_{S}, β, δ and Δu. The time-constants control the rate of decay of the voltage or current toward or away from the null-clines, which intersect the current axis at the base voltage of the regime. Coupling at events is determined by the slope of the transformation equations. For the voltage transformation, the slope is given by parameters τ₊ and β, whereas for the current transformation the slope is given by the parameter δ. This means that the slope of the null-cline in the positive regime border is dependent on the positive regime time constant but this can be compensated for with β.

In the standard parameterization, only one coupling resistance parameter β may be utilized, which is common for both regimes. However, β_{ρ} may also be configured separately for each regime. Additional behavioral aspects may be achieved with separate control of the aforementioned derivative parameters \hat{v}₊, \hat{v}₋ and ε. However, typically, the default values may be used based on the above basic parameters. For example, the parameter ε is typically set to −v₋.

The typical setting for the regime threshold given above is that \hat{v}₊=v₊. However, the voltage null-cline is not a vertical line in the {v,u} state-space. This characteristic can be advantageous because it allows for richer behaviors. Also, alternatively, the regime threshold may be defined to be the null-cline bordering the positive regime.

Given the state transformations, the null-clines for v and u are given by the negative of the transformation variables q_{ρ} and r respectively: v=−q_{ρ} and u=−r.

v=τ_{ρ}βu+v_{ρ} or u=(v−v_{ρ})/τ_{ρ}β, (49)

u=−δ(v+ε) or v=−u/δ−ε. (50)

The parameter δ is a scale factor controlling the slope of the u null-cline, which may be positive (for δ<0) or negative (for δ>0). Assuming default settings, the u null-cline crosses the x-axis at v₋. The parameter β is a resistance value controlling the slope of the v null-clines in both regimes. The τ_{ρ} time-constant parameters control not only the exponential decays but also the null-cline slopes in each regime separately.

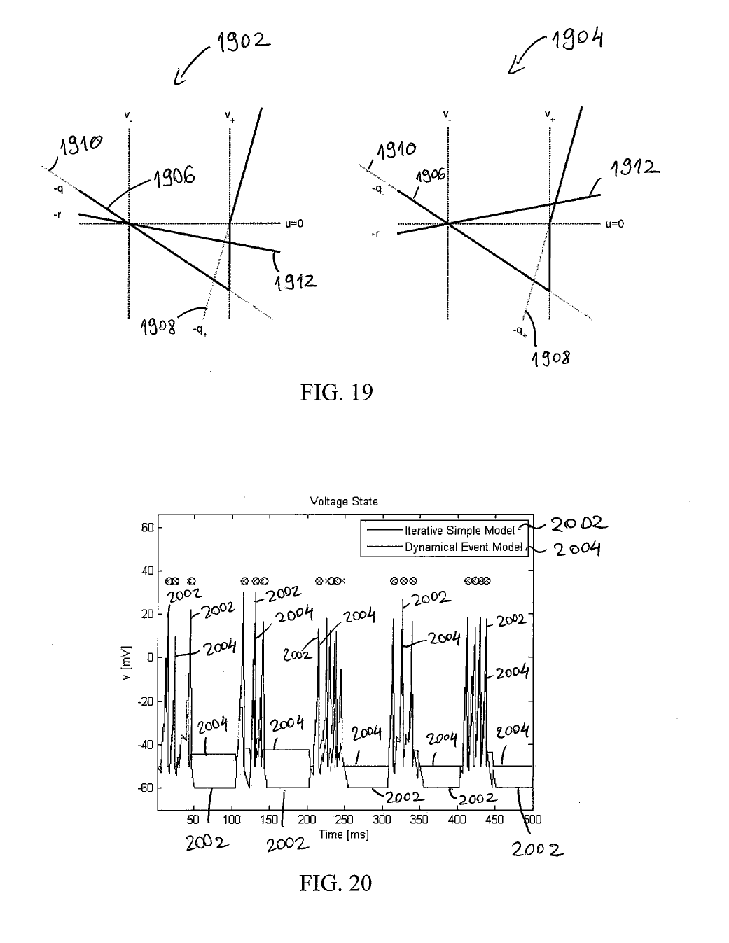

FIG. 19 illustrates two examples 1902 and 1904 of null-clines for voltage and current for negative and positive u null-cline slopes. Other situations can arise depending on parameters but these examples are demonstrative. It should be noted the discontinuity in the voltage null-cline 1906 at the regime threshold, which is v₊ in this exemplary case. It should be recalled that, in the positive regime v>v₊, the voltage tends away from the null-cline −q₊ (a plot 1908), and in the negative regime, the voltage tends toward the null-cline −q₋ (a plot 1910). In both regimes, the current tends toward the null-cline −r if τᵤ>0 (plots 1912, 1914).

In an aspect of the present disclosure, the transformations control the temporal behavior of the Model. The voltage transformation offset variable q_{ρ} is defined by a linear equation depending on the recovery current. When the current is zero, the transformation is entirely due to offset v_{ρ}. Because of that, the voltage state may be shifted in the transformed state so that the base voltage state is zero. Revisiting the formula for anticipating the spike time it can be observed that the logarithm term at u=0 is,

$$x = \frac{v - {v}_{ρ}}{{v}_{s} - {v}_{ρ}} . \qquad ( 51 )$$

Thus, the transformation to state x shifts and normalizes the state model to yield a time delay between zero and one in the positive regime. The information in a spike is in terms of its relative timing. From an information theoretical point of view, a normalized time can be viewed as coding an information value (or state) x having range [0,1] as,

$$\frac{Δ t}{τ} = - log x , \qquad ( 52 )$$

such that the larger the value, the shorter the time delay (response) and a value of 0 corresponds to infinite delay (never spike). Thus, the parameterization of the Model allows control of the information representation in spike timing. This aspect is particularly advantageous for computational design purposes.

Finally, it should be noted that coupling with the current state may be diminished or eliminated. The coupling is controlled by the parameter β, so if β=0, there is no need for the u variable. Similarly, there is no need for the u variable if it has no dynamics, i.e., Δu=0 and τᵤ→∞. The coupling from voltage is governed by the parameter δ, wherein small or zero δ may also diminish or eliminate impact of the voltage state on current state. The u variable may be omitted if the coupled dynamics are insignificant because of a small β, Δu or large τᵤ. However, the u variable provides the opportunity for richer model dynamics.

### Cold Neuron—Dynamical Event Model

Fundamentally important biological neural behaviors may be impossible to emulate or predict with typical spiking neuron models because those models do not capture: (i) fine (continuous) timing or (ii) continuous time dynamics. Even models that are expressed in continuous time differential equation form have no closed-form solution and thus are often approximated iteratively, for example, using the Euler method. The problem with iterative models is evident when observing how spike timing can change dramatically (e.g., by tens of milliseconds or more) merely by changing only the time step resolution and only by a small amount (e.g., from 1 ms to 0.1 ms). While attempting to approximate such models with fine time steps may also be computationally burdensome, more importantly it generally fails to account for continuous time dynamics, particularly if the model has multiple inter-dependent state variables (such as voltage and current) and multiple attractors. Thus, the goal is a continuous time dynamical neuron model that is capable of capturing biologically realistic temporal effects.

As aforementioned, the dynamical event neuron model has a state defined by variables {v,u} representing membrane potential (voltage) and recovery current respectively. A spike event may be anticipated in closed form (to any desired temporal precision) based on the current state given no further input using the conditional anticipation rule:

$$Δ {t}_{spike} ( \{ v , u \} ) = \{ \begin{matrix}{α}_{+} log \frac{{v}_{peak} + {q}_{+}}{v + {q}_{+}} & if v > {v}_{t} \\ ∞ & otherwise\end{matrix} \} , \qquad ( 53 )$$

where

q_{C}=1/α_{C}(−βu_{C}+γ_{C}), (54)

and β, vₚₑₐₖ, α₊, γ₊ are parameters introduced above. This rule is effectively an anti-leaky integrate-and-fire (ALIF) model. The value u_{C} is a conditional parameter and may be either constant or set as a function of u. When a spike occurs, the state is updated as follows: v=vₚₒₛₜ and u=u+uₚₒₛₜ. A more sophisticated version comprises replacing the condition v>vₜ with a condition that also depends on the recovery current u: (v−vₜ)(v−vᵣ)>u/k, where vₜ and vᵣ are depolarization and rest potentials respectively.

The future state of the model can be determined using the independent conditional update rules. These rules include propagation of state variables independently:

v(t+Δt)=(v(t)+q_{C})e^{α}^{_{C}}^{t}−q_{C}, (55)

u(t+Δt)=(u(t)+r)e^{-at}−r, (56)

where

r=δ(v₋+ε), (57)

and δ, ε, a are parameters. Again, these are continuous time closed-form equations computable to any desired temporal precision. The value v₋ is a conditional parameter and may be either constant or set as a function of v. The factor c=+ if v>vₜ and c=− otherwise. In the latter case, computation of q₋ requires parameters α₋, γ₋. When c=+, the neuron is in a depolarizing region, or ALIF mode. When c=−, the neuron is in a LIF mode, returning to rest state unless input is supplied.

When there is an input, the state should be updated to the time of the input event using the state propagations and then updated to account for the input v=v+i. The state variables should also generally be bounded.

### Algorithm

An event-based algorithm to compute the model includes processing two events: a synaptic input event and an anticipated spike event.

Upon synaptic input event, the following steps may be executed. The time since the last state update Δt may be determined. If the voltage condition is met, let c=+ and otherwise c=−, q_{C} may be computed using equation (54), and the voltage may be updated using equation (55). Then, r may be computed using equation (57) and the recovery current may be updated using equation (56). After that, the input may be added to the voltage. If the voltage condition is met, let c=+ and otherwise c=−, q_{C} may be re-computed using equation (54), and the anticipated spike time may be re-computed using equation (53). Finally, the anticipated spike event may be rescheduled.

It should be noted that for re-computing q_{C}, the quantity i to be added to the potential may differ from a discrete time simulation operation since there is no time step here. The i value that would be used for discrete iterative simulation may be scaled by the time step to obtain an equivalent value for event-based modeling. Optionally, these algorithmic steps can be executed at least every predefined period T, if there is no input.

Upon anticipated spike event, the following steps may be executed. The state may be reset or updated (optional/as applicable). If the voltage condition is met, let c=+ and otherwise c=−, q_{C} may be re-computed using equation (54), and the anticipated spike time may be re-computed using equation (53). After that, the anticipated spike event may be rescheduled.

In order to configure the model parameters, the dynamical neuron parameters described by Izhikevich can be considered: membrane capacitance C, threshold potential vₜ, rest potential vᵣ, spike peak potential vₚₑₐₖ, factors k and b depending on the neuron's rheobase and input resistance, reset voltage after a spike c, recovery time constant a, and net current during a spike d.

For the dynamical event model, set:

α_{C}=k(Δv_{C})/C, (58)

β=1/C, (59)

γ_{C}=−v_{C}a_{C}. (60)

It should be noted that γ_{C} depends on α_{C} and v_{C}, wherein α_{C} depends on Δv_{C}. The choice of Δv_{C} may depend on the condition, i.e., whether c=+ or c=−. Generally, if c=+, then,

Δv₊=(\hat{v}−vᵣ);v₊=vₜ, (61)

and otherwise,

Δv₋=(\hat{v}−vₜ);v₋=vᵣ. (62)

However, it is not necessary to use the current value \hat{v}=v to compute the above parameters. Instead, constant values for \hat{v} may be used for simplicity, namely for c=+, the mean of vₚₑₐₖ and vₜ may be used. For c=−, the mean of vᵣ and vₜ may be used, for example.

The dynamical event model is a true continuous time model because there is no dependence on time step or time resolution. On the other hand, computing the Izhikevich simple model accurately in continuous time is problematic because finding a closed form solution for the two inter-dependent differential equations is not possible. Typical implementation of the Izhikevich simple model is based on discrete iterative simulation (or Euler numerical method). While a quantized lookup table may be used, by definition, this is not continuous time either.

In an aspect, the dynamical event model can be configured to produce the behavior of a theoretical continuous time simple model. The instantaneous dynamics can be examined in continuous time. Equation (53) can be rearranged in the following form:

(v+q₊)=(vₚₑₐₖ+q₊)e^{-Δt}^{ₛₚᵢₖₑ}^{/α}^{₊}. (63)

If a transformation on the voltage, v′=v+q₊ is used, then,

v′=v′ₚₑₐₖe^{-Δt}^{ₛₚᵢₖₑ}^{/α}^{₊}. (64)

Taking the Laplace transform for time t=Δtₛₚᵢₖₑ, manipulating and taking the inverse Laplace transform yields,

$$\frac{d {v}^{′}}{d t} = {α}_{+} {v}^{′} . \qquad ( 65 )$$

Substituting for v′ and then q₊ gives,

$$\frac{d v}{d t} = {α}_{+} v - β u + {γ}_{+} . \qquad ( 66 )$$

Further substituting the parameters gives the differential equation for potential according to the Izhikevich Simple Model (assuming no input),

$$\frac{d v}{d t} = ( k ( v - {v}_{r} ) ( v - {v}_{t} ) - u ) / C . \qquad ( 67 )$$

Thus, instantaneously, the continuous time behavior can be achieved. It can be shown that the same is true for the potential when c=− and for the recovery current. FIG. 20 illustrates similarity in spike results for iterative Simple Model and dynamic event Model, i.e., spike results 2002 vs. spike results 2004.

In the dynamical model, the voltage state is only updated when there is an event (input or spike), whereas the iterative simple model has updates every millisecond. Both are subject to exactly the same spike inputs. This example was performed without a minimum update time. The similarity can be increased even more by using a minimum updated time, the shorter the more similar.

While the same or similar behavior (result) can be achieved, it is important to understand that the models are completely different. In the dynamical event model, the state variables are independent and the behavior is conditional. Essentially, the simple model cannot be solved (executed) in continuous time. On the other hand, the dynamical event model is an entirely continuous time model.

### Model Dynamics

The dynamics of the Model will be explained in the present disclosure in a manner in which the behavior can be well understood. The richness of the Model's behavioral capability derives from event-based formulation, coupling at events and decoupling between events, and division of dynamics into regimes. The general Model is unique in these respects and the resulting behavioral aspects reflect this.

### Rest Orbits

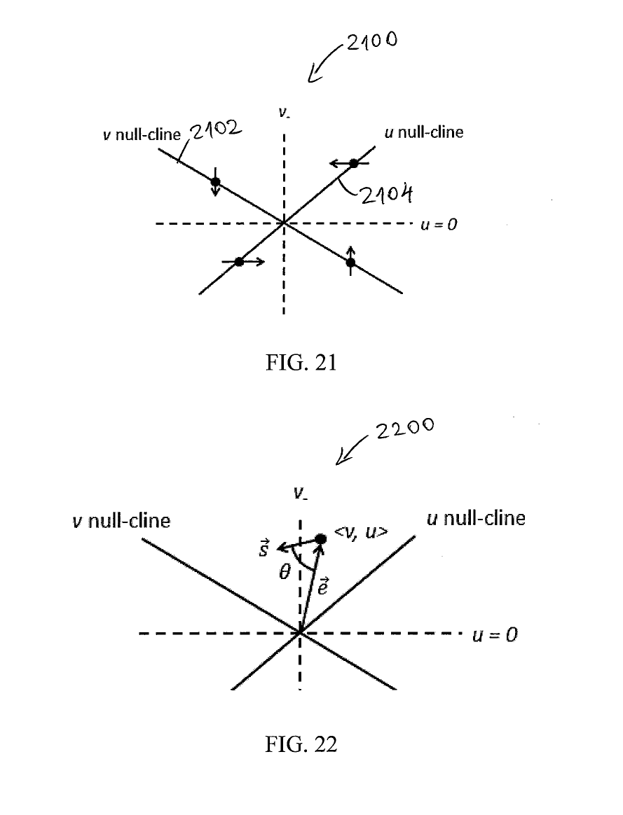

FIG. 21 illustrates an example 2100 of state trajectories across null-clines in the negative regime of the Model in accordance with certain aspects of the present disclosure. At any point along a voltage null-cline 2102, the current state variable evolution may be non-zero and thus may draw the state away from the voltage null-cline 2102. Likewise, at any point along a current null-cline 2104, the voltage state variable evolution may be non-zero and thus may draw the state away from the current null-cline 2104. Although the states at the null-clines have zero-derivatives for the state variable corresponding to the null-cline, the derivative of the other state variable at these points may be non-zero. As a result, oscillations may be possible in the negative regime with the state rotating about the <v₋,0> state.

The instantaneous state trajectory is given by the differential equations. Substituting for the transformation variables, the state trajectory in the negative regime is,

$$\vec{s} = < \frac{1}{{τ}_{-}} ( v - {v}_{-} ) - β u , \\ - \frac{δ}{{τ}_{u}} ( v - {v}_{-} ) - \frac{1}{{τ}_{u}} u > . \qquad ( 68 )$$

The state position vector relative to the rest origin <v₋,0> is,

\vec{e}=<v−v₋,u>. (69)

The angle between the state trajectory and the position vector is given by,

$$cos θ = \frac{\vec{s}}{‖ \vec{s} ‖} \cdot \frac{\vec{e}}{‖ \vec{e} ‖} . \qquad ( 70 )$$

FIG. 22 illustrates an example 2200 of the state trajectory geometry given by equations (68), (69) and (70).

The projection of the state trajectory onto the position vector gives the component of the trajectory toward rest, or the decay component. The dot product yields the component scaled by the magnitude of the position vector,

$$\vec{s} \cdot \vec{e} = \frac{1}{{τ}_{\_}} [ {( v - {v}_{-} )}^{2} + {u}^{2} ( \frac{- {τ}_{-}}{{τ}_{u}} ) ] - u ( v - {v}_{-} ) [ β + \frac{δ}{{τ}_{u}} ] . \qquad ( 71 )$$

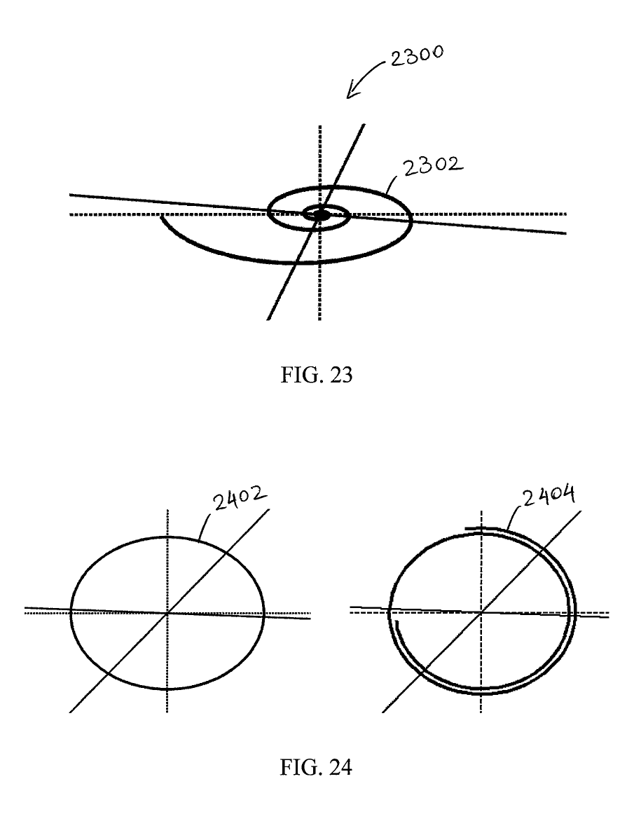

The left-hand term in equation (71) is negative indicating a direction toward the rest origin. A simple conceptual case to visualize is if τᵤ=−τ₋. Then the left-hand term of equation (71) in square brackets is equal to ∥\vec{e}∥. However, since the left-hand term is scaled by the time constant 1/τ₋, it can be observed that decay toward the origin is possible. FIG. 23 illustrates an example 2300 of a state trajectory 2302 in state space about the rest origin. Parameters are v₋=−70 mV, τ₋=−20 ms, τᵤ=20 ms, β=5, δ=−0.26, ε=−v₋ with initial state <−75 mV,0> plotted for 1000 ms with events every 0.1 ms. Because the inter-event interval is small, the behavior approaches that given by the continuous time state derivatives.

To avoid decay toward the origin, the second term in the right-hand side in equation (71) may need to be positive. To achieve the positive u null-cline slope, it is known that δ should be negative. However, as long as β>−δ/τᵤ, the component β+δ/τᵤ is positive. Nevertheless, u(v−v₋) is only negative if one of u or (v−v₋) is negative (second or fourth quadrant about the rest origin). Thus, to counter the decay toward the origin, there are several possibilities: (i) increase the magnitude of τ₋; (ii) increase β+δ/τᵤ; (iii) move the orbit inward toward the rest origin so that the term (v−v₋)²+u² may be less than u(v−v₋); and (iv) alter the inter-event interval.

Thus, it is possible to not only decrease the decay such that the orbit does not decay, but also to create an oscillation that spirals outward and spikes. For example, adjusting δ yields the state paths depicted in FIG. 24, i.e., the sustained orbit 2402 and the spiral outward 2404. Parameter δ was changed, for example, from −0.26 to −4 to sustain the orbit (see plot 2402) and to −5 to spiral outward (see plot 2404).

It should be noted that solving for \vec{s}·\vec{e}=0 yields,

$$v = {v}_{-} + u [ ( β + \frac{δ}{{τ}_{u}} ) {τ}_{u} {τ}_{-} \pm \sqrt{{τ}_{u} {τ}_{-}} \sqrt{4 + ( β + \frac{δ}{{τ}_{u}} ) {τ}_{u}} ] / 2 {τ}_{u} , \qquad ( 72 )$$

which is a line in the state space. But, this does not prevent decaying, sustained or exploding orbits about rest because \vec{s}·\vec{e} may vary to positive and negative values.

To understand item (iv) above and why inter-event intervals matter, the present disclosure delves deeper into the matter of momentary coupling at events.

### Momentary Coupling

Events may influence the behavior of the Model whether they have input or not. The reason for this is that the Model dynamics variables are coupled at events and decoupled between events as defined above. Typical parameterizations and spaces were analyzed above in which the voltage and current evolution change almost imperceptibly over short periods of time regardless of when events occur absent significant input.

In the negative regime, with typical settings, voltage and current state variables may decay toward the respective null-clines. The individual states would reach those separate null-clines after an infinite inter-event interval. However, since both state variables change, the intercepts on the null-clines change. This means that while voltage decays toward some q₋ (t₀) defined at a prior event, the null-cline has changed to q₋ (t₁) at the time of a next event.

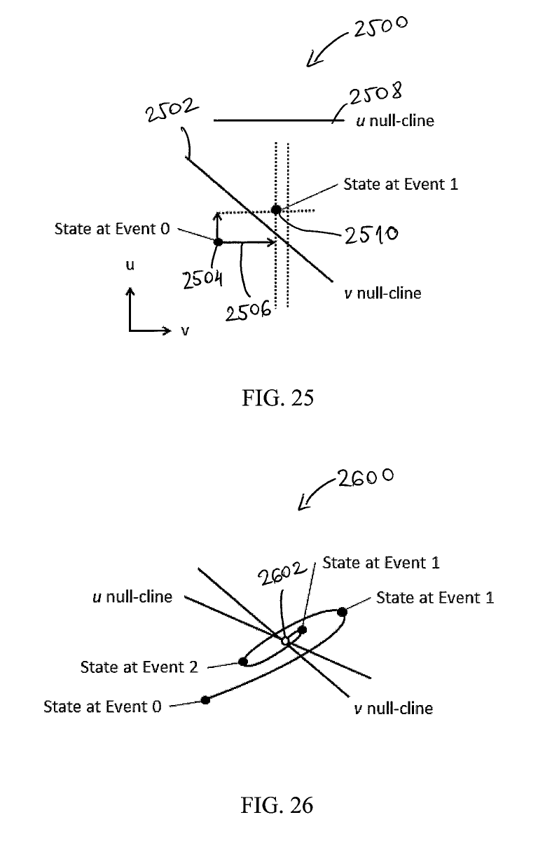

FIG. 25 illustrates such a concept, i.e., illustrates an example 2500 of relation between inter-event dynamics and null clines. In the example 2500, the voltage null-cline 2502 is to the right of the first state 2504 (at the first event, or event 0), so the voltage moves toward that null-cline 2502. In some finite inter-event interval time t, it reaches the point shown by the horizontal arrow 2506 (approaching the null-cline). However, over the same decoupled interval, the current moves toward a null-cline 2508. Thus, at the second event 2510 (event 1), the state will be above and right in the state space. However, if the slope of the voltage null-cline is negative, then this second state 2510 can be to the right (past) the null-cline 2502.

As a result, oscillation is possible with the Model entirely within the negative regime due only to sufficient inter-event intervals. Oscillations can occur in individual state variables or even in both, if the first and second states cross both null-clines. Such oscillation may occur even in the absence of parameters conducive to orbit with short inter-event intervals. FIG. 26 conceptually illustrates an example 2600 of this damped dual-state-variable oscillation, in accordance with certain aspects of the present disclosure. In this scenario, the slopes of the null-clines in the negative regime are both negative, intercepting at the rest point 2602, which is u=0 and v=v₋. The oscillation is damped because inter-event intervals are finite (ignoring the possibility of time constants equal to 0). This oscillation can be also described as the state jumping back and forth across the null-cline.

However, inter-event intervals contribute to the shape of more conventional orbits discussed in the previous section as well. The underlying reason is the same as above except when combined with an inherent orbit effect, a much smaller inter-event interval effect can be enough to alter the Model's behavior to obtain desired properties such as sub-threshold oscillations.

If inter-event intervals are considered, then the trajectory may be defined based on the state change over an inter-event interval Δt,

$$\vec{s} = < ( ( v - {v}_{-} ) - β {τ}_{-} u ) ( {e}^{\frac{Δ t}{{τ}_{-}}} - 1 ) , \\ ( u + δ ( v - {v}_{-} ) ( {e}^{- \frac{Δ t}{{τ}_{u}}} - 1 ) ) > , \qquad ( 73 )$$

which is subtly but importantly different from (68), and thus,

\vec{s}·\vec{e}=(v−v₋)²l₋+u²lᵤ−u(v−v₋)(βτ₋l₋−δlᵤ), (74)

where

$${l}_{-} = ( {e}^{\frac{Δ t}{{τ}_{-}}} - 1 ) ; \\ {l}_{u} = ( {e}^{\frac{Δ t}{{τ}_{-}}} - 1 ) . \qquad ( 75 )$$

Since τ₋<0 typically and τᵤ>0, then l₋<0 and lᵤ<0 for Δt>0 and the first term of the projection onto \vec{e} in equation (74) is thus negative, decaying an orbit toward the rest origin. A simple conceptual case to visualize is if τᵤ=−τ₋=τ. Then l₋=lᵤ=l, and

\vec{s}·\vec{e}=l[((v−v₋)²+u²)+u(v−v₋)(βτ+δ)]. (76)

It can be observed from equation (76) that the second term u(v−v₋)(βτ+δ) can counteract the first term ((v−v₋)²+u²) if βτ+δ is sufficiently large. Moreover, it can be observed that since l can be factored out, Δt controls the angle θ between the trajectory vector and the position vector. The larger Δt is, the more negative l becomes and the larger the trajectory component in the radial direction is. As a result, when the second term u(v−v₋)(βτ+δ) has opposite sign to the first term ((v−v₋)²+u²), then a large inter-event interval Δt can push a decaying state back out into an orbit or, if sufficient, to spiral outward.

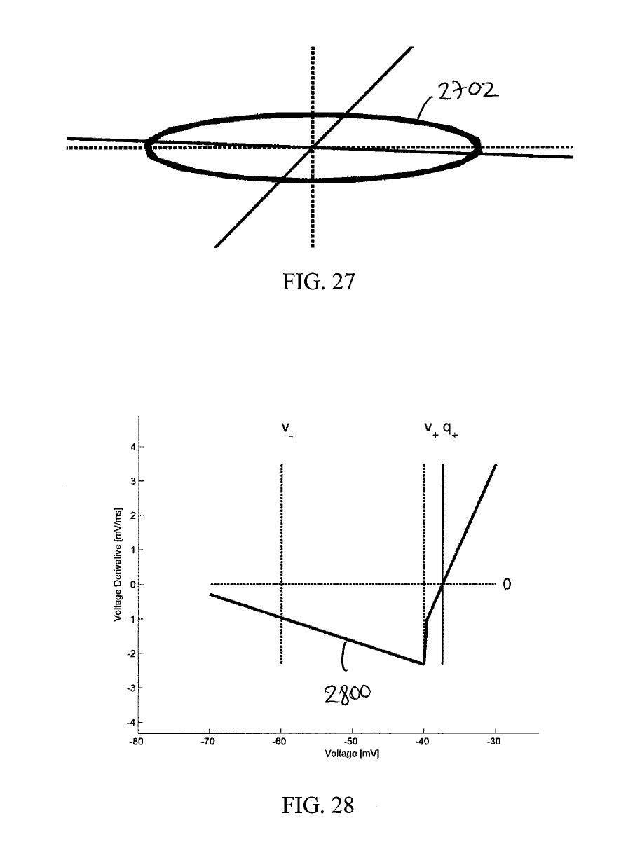

The first case is illustrated in FIG. 27. The same parameters are used as in FIG. 23 except the inter-event interval is Δt=1.55 ms instead of 0.1 ms. In FIG. 27, the state has a decaying orbit 2702 over some inter-event intervals but recovers in other inter-event intervals where the second term u(v−v₋) is large, and this is significant if the inter-event interval is large enough. This is why the orbit plot 2702 in FIG. 27 appears thick, trajectories from event to event have slightly different corresponding states on each cycle and overlap or cross one another.

It should be noted that solving for \vec{s}·\vec{e}=0 yields,

v=v₋+u[(βτ₋l₋−δlᵤ)±\sqrt{(βτ₋l₋−δlᵤ)²−4l₋lᵤ}]/2l₋, (77)

which remains a line in the state space. However, this does not prevent decaying, sustained or exploding orbits about rest because \vec{s}·\vec{e} may vary to positive and negative values.

### Finite Return

At first glance, one might assume that, absent further input, the Model will return toward rest when in the negative regime and eventually spike when in the positive regime. However, this is not generally true. In fact, the Model can spike from the negative regime and return to rest from the positive regime even if there is no further input.

The behavior of the Model in terms of recovery current dynamics is straight-forward. The recovery current may decrease above the current null-cline −r and increases below it (assuming τᵤ>0 or vice versa if τᵤ<0). However, the voltage dynamics are more complex because the voltage dynamics depend on regime and thus on the regime threshold. However, the regime threshold is not generally the same as the voltage null-cline (although it can be defined so).

The typical definition of the regime threshold is,

\hat{v}₊=v₊, (78)

where v₊ is a constant. It can be assumed that v_{ρ}′=v_{ρ} in the transformation variables (null-cline expressions). Accordingly, the voltage null-clines cross v₊ at u=0 for the positive null-cline −q₊=v₊ and at u=(v₊−v₋)/τ₋β for the negative null-cline −q₊=v₋. These two null-clines carve out two sub-regimes with particular properties. In these sub-regimes, one in the positive regime and one in the negative regime, voltage returns toward the regime threshold in finite, rather than infinite time. Moreover, the voltage can actually cross over v₊ into the opposite regime absent any subsequent input, whether from the positive regime to the negative regime or vice versa. Bordering these finite regimes, at the threshold voltage, the voltage derivative is discontinuous (although the sign may remain unchanged). For these reasons, these two regimes can be denoted as finite return regimes.

### Positive Finite Return Regime

In the positive regime, the voltage tends away from the positive regime null-cline given τ₊>0. However, voltage tending away from the positive regime null-cline is not the same as voltage heading away from the regime threshold v₊. Rather, there is only a particular region of u in which they are equal under the typical regime threshold definition.

### Positive Return Theorem

Under the typical regime threshold definition, there exists a positive finite return regime that is a subspace of the positive regime in which the state tends toward the negative regime.

### Proof

In the positive regime v>v₊ and for the state to return toward the negative regime it is required that dv/dt<0 or,

v<−q₊. (79)

Thus,

v<τ₊βu+v₊. (80)

Together, these two conditions define a region within the positive regime in which the voltage state tends toward the negative regime rather than spiking.

Since τ₊>0 and β>0, then

u>(v−v₊)/τ₊β, (81)

which is a non-null region delineated by the line with slope 1/τ₊β and offset −v₊/τ₊β as long as |τ₊β|>0.

For example, if τ₊=1 ms, β=1 and v₊=−40 mV, then u=v+40. Thus, at v=−30 mV (i.e., above v₊), any state with u>10 may yield a decay toward the negative regime. For example, at u=20, −q=−20.

### Finite Positive Return Theorem

In the positive finite return regime, the state tends into the negative regime in finite time.

### Proof

In the positive finite return regime, v₊<v<−q₊. To arrive at a state v_{f} in the negative regime, v_{f}<v₊<v. Thus,

v_{f}+q₊<v+q₊<0. (82)

As a result, for a finite v_{f} and finite non-zero τ₊,

$$0 < Δ t = {τ}_{+} log \frac{{v}_{f} + {q}_{+}}{v + {q}_{+}} < ∞ . \qquad ( 83 )$$

Following from the example above, q₊=−u+40. At u=5, to reach v_{f}=−45 mV in the negative regime from v=−35 mV in the positive regime, Δt≅1.1 ms.

### Positive Finite Return Limit-Cycle

On the positive regime side of the threshold, v=v₊+ε₊, where ε₊ is a positive voltage offset and any state with sufficient u>0 decays into the negative regime over time Δt₊,

Δv₊=(ε₊−τ₊βu)e^{Δt}^{₊}^{/τ}^{₊}+τ₊βu+v₊. (84)

On the negative regime side of the threshold, v=v₊−ε₋, where ε₋ is a positive voltage offset and any state with sufficient u decays further into the negative regime over time Δt₋, i.e.,

Δv₋=(v₊−v₋−ε₋−τ₋βu)e^{Δt}^{_{−}}^{/τ}^{_{−}}+τ₋βu+v₋. (85)

Thus, the difference at the discontinuity, in the direction of the derivative, is,

Δv₋−Δv₊=−Δv_{±}k₋+βu(τ₋k₋+τ₊k₊)−ε₋e^{Δt}^{_{−}}^{/τ}^{_{−}}−ε₊e^{Δt}^{₊}^{/τ}^{₊}, (86)

where,

$${k}_{ρ} = ρ ( {e}^{\frac{Δ {t}_{ρ}}{{τ}_{ρ}}} - 1 ) , \qquad ( 87 )$$

and Δv_{±}=(v₊−v₋). It should be noted that Δv_{±} and k_{ρ} are always positive with the considered parameters. As ε_{ρ}→0,

Δv₋−Δv₊=−Δv_{±}k₋+βu(τ₋k₋+τ₊k₊). (88)

To remove the discontinuity would require,

$$β = \frac{{Δ}_{\pm } {k}_{-} + ( {ɛ}_{-} {e}^{Δ {t}_{-} / {τ}_{-}} + {ɛ}_{+} {e}^{Δ {t}_{+} / {τ}_{+}} )}{u ( {τ}_{-} {k}_{-} + {τ}_{+} {k}_{+} )} . \qquad ( 89 )$$

However, a discontinuity is of interest. The discontinuity is a negative quantity unless the βu term is sufficiently large and (τ₋k₋+τ₊k₊) is a positive quantity. Typically, (τ₋k₋+τ₊k₊) is positive even though is typically larger than τ₋ because k₋ is typically much smaller than k₊ for significant Δt_{ρ}. A negative step discontinuity means the voltage decrease accelerates across the regime threshold. FIG. 28 illustrates the voltage derivative 2800 in such a case. Parameters are the same as for FIG. 15 with Δt_{ρ}=1 ms and u=100. Any constant input that is sufficient to overcome the voltage leak in the negative regime will be able to overcome the leak in the positive regime.

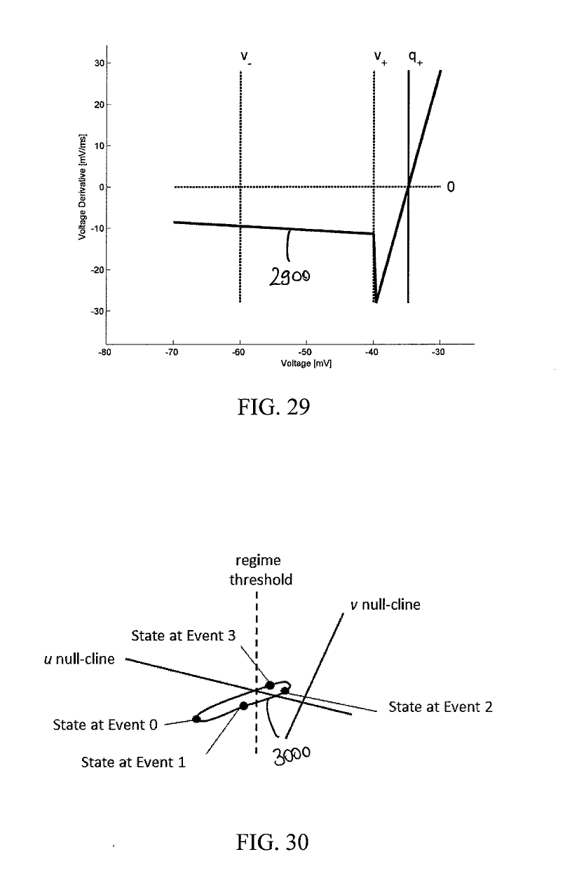

However, the discontinuity may be positive in the direction of the voltage derivative, due to sufficiently large βu, large inter-event interval Δt_{ρ}, higher u, or longer time constant τ₊ (or shorter time constant τ₋). FIG. 29 illustrates the voltage derivative 2900 in such a case. Parameters are the same as for FIG. 15 except β=0.02, Δt_{ρ}=5 ms, τ₋=−50 ms and u=100.

A constant excitatory input sufficient to overcome voltage leak in the negative regime may not be sufficient to overcome leak in the positive regime. Thus, there is a potential for a voltage cycle under constant excitatory input. If the u null-cline intersects the region of the cycle, there is even the potential for a limit cycle.

FIG. 30 illustrates a limit cycle 3000 under constant excitatory input (applied at events). At a prior event (event 0), the state is in the negative regime. However, input at a first event (event 1) is sufficient to overcome the decay. At a second event (event 2), input can bring the state into the positive regime. Input at a third event (event 3) is insufficient to overcome the stronger decay in the positive regime and thus the state moves back toward the negative regime and into the negative regime by the time of a next event.

### Negative Finite Return Regime

In the negative regime, the voltage tends toward the negative regime null-cline given τ₋<0. However, voltage tending toward the negative regime null-cline is not the same as declining away from the regime threshold. Rather, there is only a particular region of u in which they are equal under the typical regime threshold definition.

### Negative Return Theorem

There exists a negative finite return regime which is a subspace of the negative regime in which the state tends toward the positive regime if τ₋β is negative.

### Proof

For negative regime, v<v₊ and it requires dv/dt>0. By this definition, v<−q₋. For there to be a region in which −q₋>v₊,

τ₋βu>(v₊−v₋). (90)

If τ₋β<0, then,

u<(v₊−v₋)/τ₋β, (91)

which is a non-null region as long as τ₋β>−∞. The region is delineated by a zero-slope line that crosses the voltage threshold v₊ at (v₊−v₋)/τ₋β.

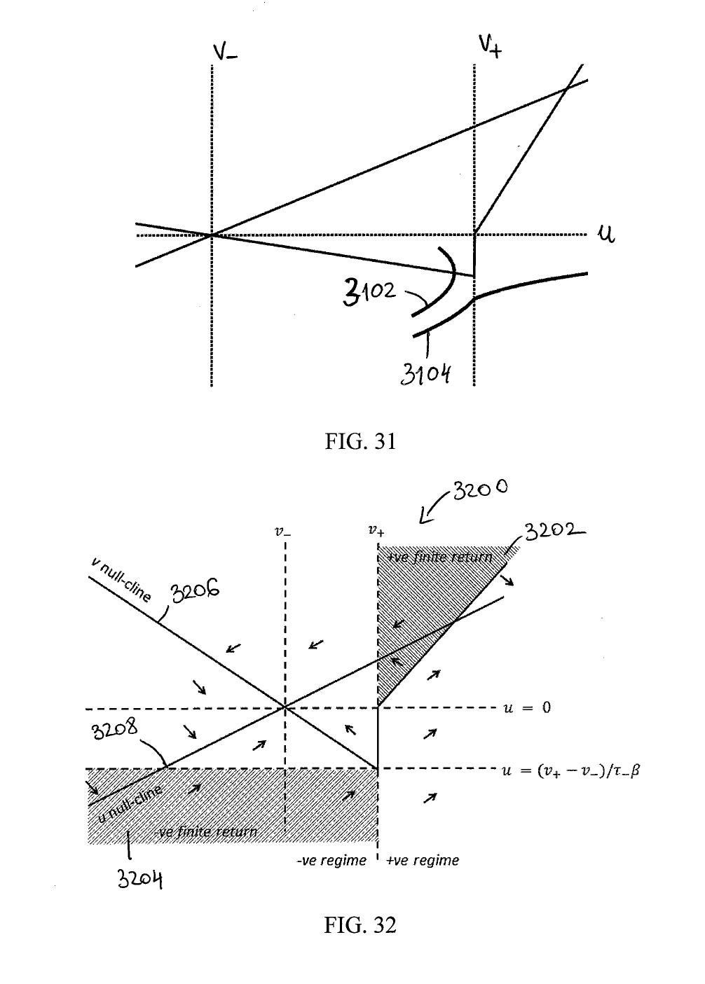

The derivative of the voltage in the negative finite return regime will thus be positive. However, merely because the state tends toward the positive regime, does not mean it will reach it. FIG. 31 illustrates an example 3100 of behavior in negative finite return regime. Trajectories 3102 and 3104 for two initial states are illustrated that both tend initially toward the positive regime but only one arrives, i.e., the trajectory 3104. For τ₋=−10 ms, β=1 and v₊=−40 mV and v₋=−60 mV, the negative finite return regime is defined by v<v₊ and u<−2. At u<−2, −q₋>v₊, since v<v₊, the derivative is positive tending toward the positive regime. The two initial states <v,u> are <−45,−4> and <−45,−5>.

At the negative regime side of the threshold, v=v₊−Δv₋, any state with sufficient u tends into the positive regime with voltage derivative,

$$\frac{d v}{d t} = {τ}_{-} ( {v}_{+} - {v}_{-} - Δ {v}_{-} ) - β u , \qquad ( 92 )$$

whereas at the positive regime side of the threshold v=v₊+Δv₊,

$$\frac{d v}{d t} = {τ}_{-} Δ {v}_{+} - β u . \qquad ( 93 )$$

The acceleration of the voltage across this barrier in the direction of the derivative is,

g(Δv)=τ₊Δv₊−τ₋(v₊−v₋−Δv₋). (94)

At the limit Δv₋→0 and Δv₊→0 for τ₋<0, g(Δv)<0 so the state is generally accelerating toward v_{S}.

### Finite Negative Return Theorem

In the negative finite return regime, the state tends into the positive regime in finite time for finite negative τ₋.

### Proof

In the negative finite return regime, v<v₊<−q₋. To arrive at a state v_{f} in the positive regime, v_{f}>v₊>v. Thus,

v+q₋<v_{f}+q₋. (95)

For negative regime, v+q₋<0, but v_{f}<q₋ may be chosen such that, as a result, for negative finite non-zero τ₋, the following holds,

$$0 < Δ t = {τ}_{-} log \frac{{v}_{f} + {q}_{-}}{v + {q}_{-}} < ∞ . \qquad ( 96 )$$

Following from the example above, at u=−10, for v=−45 mV and v_{f}=−35 mV, Δt≅0.5 ms.

### Advanced Controls

FIG. 32 illustrates an example 3200 of positive and negative regimes along with positive and negative finite return regimes (regions 3202 and 3204, respectively), the null-clines 3206, 3208 and conceptual vector field for the typical case in which δ<0, \hat{v}₊=v₊ and ε=−v₋.

### Regime Threshold

However, as described above, there are alternative definitions possible for the regime threshold. For example, the regime threshold may be defined to follow the voltage null-cline above u=0, or, \hat{v}₊=max(v₊, q₊). This would eliminate the positive finite return regime but would not eliminate the negative finite return regime. An alternative definition would be to set \hat{v}₊=max(q₋, q₊) so that the regimes are split at the right-most voltage null-cline. However, given the typical slopes, the positive and negative voltage null-clines cross below u=0, and thus the voltage differential would still generally not be continuous. Rather, the situation would be reversed from above since the positive voltage null-cline would be further left of the regime threshold below u=0. There are various other alternatives that a modeler may define, and it should be noted that the general analysis methods discussed above may be applied to dynamics resulting from other or atypical settings as well.

The finite return regimes are results of a regime threshold that is different from the voltage null-clines. To remove the positive return regime, the regime threshold may be made dependent on the second state variable, namely equal to the positive regime null-cline when that null-cline applies and otherwise equal to the default,

$${\hat{v}}_{+} ( u ) = \{ \begin{matrix}{τ}_{+} β u + {v}_{+}^{′} & u > 0 \\ {v}_{+}^{′} & otherwise\end{matrix} \} . \qquad ( 97 )$$

However, this still leaves the negative finite return regime. While both finite return regimes can be useful, to remove the negative finite return regime will prevent the cell from firing for arbitrarily large voltage states if the current state is sufficiently negative. The modification to the regime threshold is,

$${\hat{v}}_{+} ( u ) = \{ \begin{matrix}{τ}_{-} β u + {v}_{-}^{′} & u \leq ( {v}_{+}^{′} - {v}_{-}^{′} ) / {τ}_{-} β \\ {v}_{+}^{′} & otherwise\end{matrix} \} . \qquad ( 98 )$$

This is due to the negative voltage null-cline crossing the voltage null-cline discontinuity at v₊′. However, this can also be controlled. To remove both finite return regimes,

$${\hat{v}}_{+} ( u ) = \{ \begin{matrix}{τ}_{-} β u + {v}_{-}^{′} & u \leq ( {v}_{+}^{′} - {v}_{-}^{′} ) / {τ}_{-} β \\ {τ}_{+} β u + {v}_{+}^{′} & u > 0 \\ {v}_{+}^{′} & otherwise\end{matrix} \} . \qquad ( 99 )$$

### Decoupling Voltage Null-Cline Slopes and Time Constants

Further freedom of design may be obtained by using the generalized version of the voltage null-cline definition. It should be recalled that the standard model is defined with the transformations,

q_{ρ}=−τ_{ρ}βu−v_{ρ}′, (100)

r=δ(v+ε). (101)

However, since the voltage dynamics are governed by,

$${τ}_{ρ} \frac{d {v}^{′}}{d t} = {v}^{′} , \qquad ( 102 )$$

the parameterization may be limiting in terms of having the voltage null-cline slopes being related by slope factor β. To remove this limitation, a more general definition is,

q_{ρ}=−β_{ρ}u−v_{ρ}′, (103)

where there is a subtle change from βτ_{ρ} to β_{ρ}. The generalized definition is related to the standard definition by the setting,

β_{ρ}=τ_{ρ}β. (104)

This generalization may be used with or without finite return regime controls discussed above.

### One-Dimensional Equivalence

The model inherits the computational benefits of the anti-leaky-integrate-and-fire (ALIF) neuron model. It has been shown in the present disclosure that the second state variable (u) can be omitted while retaining a near equivalent behavior for some particular parameterizations with low coupling (small β and δ) and high second-state time constant (large τᵤ) by scaling the voltage time constant to compensate for the effects of the second-state null-cline attractor on the voltage decay and rise times.

The reason for this is that the solution to the model dynamics (if continuous coupling is assumed) is of the form,

$${v}^{′} ( t ) = {v}^{′} ( 0 ) \frac{1}{2 a} [ ( a + ( {τ}_{ρ} + {τ}_{u} ) ) {e}^{bt} + ( a - ( {τ}_{ρ} + {τ}_{u} ) ) {e}^{ct} ] + {u}^{′} ( 0 ) \frac{{βτ}_{u} {τ}_{ρ}}{a} [ {e}^{ct} - {e}^{bt} ] , \qquad ( 105 )$$

where a=\sqrt{(τ_{ρ}+τᵤ)²+2ρδτ_{ρ}τᵤ}, b=(a−τ_{ρ}+τᵤ)/2τᵤτ_{ρ}, c=(−a−τ_{ρ}+τᵤ)/2τᵤτ_{ρ}, v′=v−v_{ρ}′ and u′=u+δε. If the coupling is weak and τᵤ is large, then after approximation, one might propose a≅τᵤ and b≅1/τ_{ρ} while c≅0. Accordingly,

v′(t)≅[v′(0)−u′(0)βτ_{ρ}]e^{t/τ}^{_{ρ}}. (106)

The time to reach such a state (for example spiking or rest or any arbitrary v(t)) is given by,

$$t ≅ {τ}_{ρ} log ( \frac{v ( t ) - {v}_{ρ}^{′}}{v ( 0 ) - {v}_{ρ}^{′} - ( u ( 0 ) + δɛ ) {βτ}_{ρ}} ) . \qquad ( 107 )$$

To achieve approximately the same effect with only one variable (i.e., only v instead of v and u), the time constant τ_{ρ} can be adjusted to τ_{ρ}′ to obtain equivalent time t or,

$${τ}_{ρ}^{′} = {τ}_{ρ} log ( \frac{v ( t ) - {v}_{ρ}^{′}}{v ( 0 ) - {v}_{ρ}^{′} - ( u ( 0 ) + δɛ ) {βτ}_{ρ}} ) / log ( \frac{v ( t ) - {v}_{ρ}^{′}}{v ( 0 ) - {v}_{ρ}^{′}} ) . \qquad ( 108 )$$

It can be recalled that by default ε=−v₋, and thus for δ<0, the denominator in the logarithm on the right-hand-side of equation (108) is larger, thus making the resulting fraction smaller and the logarithm smaller. For this reason, τ_{ρ}′ need to be smaller (faster) than τ_{ρ} to account for the removal of the second state that was slowing the effective behavioral time responses.

Certain aspects of the present disclosure support the model definition and basic model dynamics resulting from negative (leaky-integrate-and-fire) and positive (anti-leaky-integrate-and-fire) regimes as well as momentary coupling at events. The present disclosure also provides additional dynamics features including fundamental aspects driving oscillatory or resonating behavior resulting from the model definition including the momentary coupling. Following this, it will be described in the present disclosure how these dynamics can generate a variety of biologically-consistent cell behaviors.

### Model Behaviors

In this section, the present disclosure provides explanation how the dynamics aspects described above and similar dynamics allow the Model to be designed to exhibit a rich variety of behaviors including responses to spike-timing patterns, sustained or step inputs, ramps and other inputs often used to characterize biological cell behavior types. Specific parameterization examples will be also provided. However, these are only examples as there are generally various ways to design the Model to exhibit particular behavioral characteristics. Yet, particular examples can be illustrative in demonstrating how particular parameters govern or influence behavioral differences according to the dynamics principles described above. Given the flexibility of the Model, it would be impractical to consider all combinations and cases, and thus the present disclosure is focused on a demonstrative set of behaviors and a subset of illustrative means to achieve each of those behaviors. Similarly, the behaviors are not limited to the specific dynamics described in the previous chapter, but also include similar or related dynamics according to the general principles discussed there.

### Arbitrary Reference Cell

For convenience, a nominal (arbitrary) cell parameterization will be used as a reference or baseline. To demonstrate a variety of responses to inputs, examples will typically use a parameterization and configuration where \hat{v}₊=v₊, \hat{V}=v₋, ε=−v₋, τ₋<0, τ₊>0 and τᵤ>0 with artificial events at a nominal periodicity. Nominal settings without loss of generality can be: τ₋=−20 ms, τ₊=2 ms, τᵤ=10 ms, v₊=−60 mV, v₋=−70 mV, v_{S}=30 mV, β=1, δ=−0.25 and Δu=0, and event periodicity of 1 ms can be considered. However, there is no particular reason for selecting those nominal parameters or settings over others. Other parameterizations can be used to obtain similar or even the same behaviors. The purpose of choosing a specific nominal example is only to show how various behaviors can be achieved with (or without) changes to particular parameters. In other words, the purpose of choosing the specific nominal example is to address whether a cell with the same parameters can demonstrate multiple behaviors, and whether a behavior change can be achieved in multiple/different ways (e.g., by a change in one parameter or an alternative parameter or a combination of parameters or by a change in input).

Model behaviors can be produced at any desired time scale because time units in the definition of the Model are arbitrary. Therefore, without loss of generality, behaviors on abstract time scales can be discussed.

The present disclosure examines a set of demonstrative behaviors in response to a variant of input contexts and in terms of illustrative parameter design. The behaviors are organized according to aspects of synchrony or timing, aspects of accommodation or excitability, aspects of spiking patterns under sustained input or effectively tonic and phasic spiking and bursting, and dynamics of rest or reset orbits under sustained inputs.

### Synchrony and Spike-Timing Patterns

Since inputs are applied at events, Dirac delta functions can be used as a fundamental basis for input. Together, multiple delta function inputs generally comprise spiking timing patterns (whether the inputs to the post-synaptic cell are from the same synapse or multiple synapses). A set of representative behaviors is examined in response to such patterns. Although characterized here according to such inputs, the behaviors are relevant in other input contexts as well. Delta function inputs are just a convenient means for elemental analysis in discrete time.

### Spike Latency

The Model's positive regime dynamics incur spike latency. The positive regime time constant τ₊ determines the nominal latency without coupling. With coupling, the current dynamics interact depending on whether the current is above or below the null-cline. The only requirement for incurring spike latency is to move the state into the positive regime at an event (i.e., to spike). From a rest state, with a Dirac delta function input, to enter the positive regime only requires the magnitude contribution of input in voltage terms Δv to satisfy Δv>v₊−v₋. In general, the smaller the initial amount by which the state moves into the positive regime is, the longer the spike latency is.

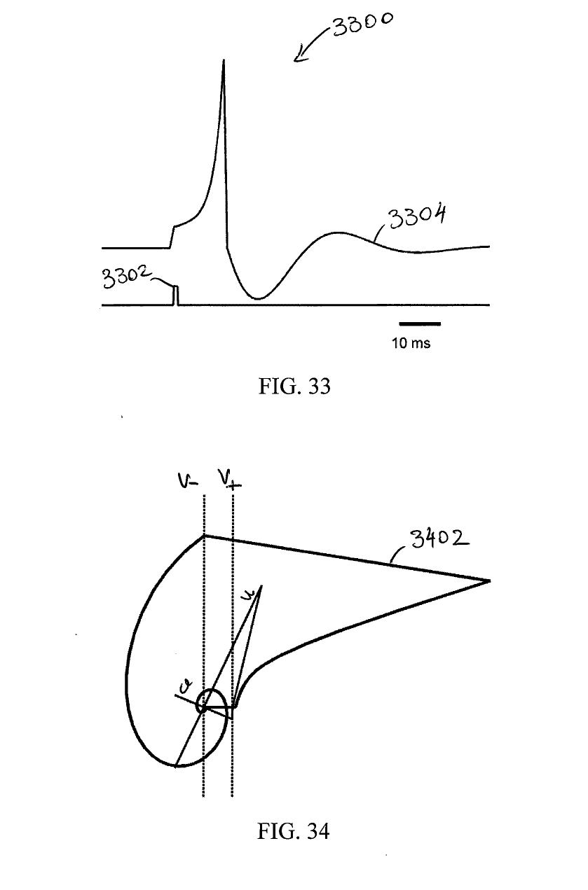

FIG. 33 illustrates an example 3300 of spike latency if an input event 3302 occurs. A graph 3304 shows how substantial spike latency can be incurred. The parameters are same as in the nominal setting with Δv=11 mV, i.e., 1 mV more than sufficient to reach the regime threshold. It should be noted that the further the input drives the voltage state into the positive regime, the shorter the spike latency is. Latency in this case can be impacted (increased) by periodic coupling (due to non-zero β).

FIG. 34 illustrates this effect in state space (the x-axis is voltage state and y-axis is the current state). In FIG. 34, the two regime reference voltages v₋ and v₊ are plotted as vertical dashed lines, while the current u and voltage v null-clines are plotted over limited domains as solid lines. The state trajectory is illustrated with a curve 3402.

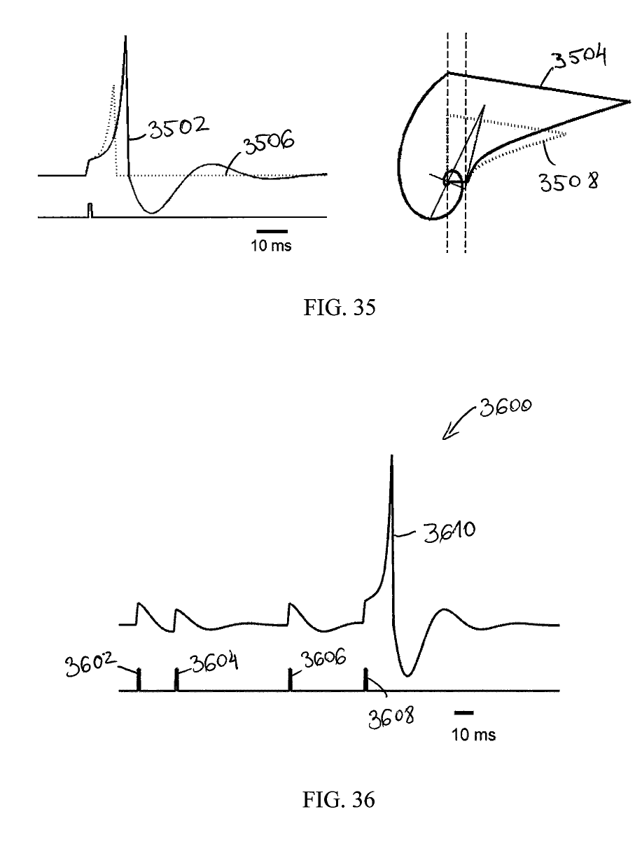

For purposes of comparison, the spike trace and state trajectory are depicted in FIG. 35 for two cases: with coupling (spike trace 3502 and state trajectory 3504) and without coupling (spike trace 3506 and state trajectory 3508). The parameters are same as before but with β=0. In the case of coupling, the state trajectory away from the regime threshold has a positive current component, and thus brings the voltage closer to the voltage null-cline, instead of more horizontally toward the spike condition, and thus the latency is increased (compared to having no coupling).

Thus, the degree of coupling influences spike latency. Decreasing the coupling decreases spike latency. However, decreasing the coupling periodicity would also have the effect of decreasing the latency. One could also achieve a decreased latency simply by shortening the positive regime time constant τ₊ or by decreasing the amount of input so that the state enters the positive regime by a smaller amount initially. In summary, there are multiple ways to obtain a particular latency and there is a freedom to design a Model for desired behavior even if some elements are constrained by other design goals.

This flexibility in the Model is an advantage because a cell behavior can be designed using various dimensions: input, cell parameters, and events (including artificial events). Moreover, this flexibility applies not only to spike latency but to model behaviors and dynamics in general. As aforementioned, these dimensions are all independently controllable elements. Not only are inputs and cell parameters distinct dimensions, but events themselves, regardless of whether there is associated input or output, control coupling and thus influence dynamics.

### Sub-Threshold Oscillation

Sub-threshold oscillation may occur after a spike because of the return state. Post-spike oscillation may be set in motion as a result of reset conditions (where the voltage and current state are reset after spike) or due to the trajectory of the state to reach the spike condition (because the reset of the current state is an offset) or a combination of both. As discussed above, reset conditions can result in a rest orbit that converges to or diverges from a rest state (rest origin).

This dynamic is the underlying feature that enables resonator behavior as exhibited in an example 3600 in FIG. 36. The parameters are same as for nominal setting with Δv=10 mV, i.e., insufficient to incur a transition to the positive regime alone. The first pair of spikes 3602-3604 is separated by, for example, 20 ms, and the second pair of spikes 3606-3608 is separated by, for example, 40 ms. The key aspect of the resonator behavior is that an input coinciding with/synchronous with sub-threshold oscillation reinforces the effect. Thus, the timing of inputs relative to one another is a distinguishable input characteristic in terms of output, as illustrated by the resonator behavior 3610 in FIG. 36 after the second pair of spikes 3606-3608. In other words, a cell with a resonating behavior can distinguish between inputs that have one periodicity (frequency) from inputs with another periodicity (frequency).

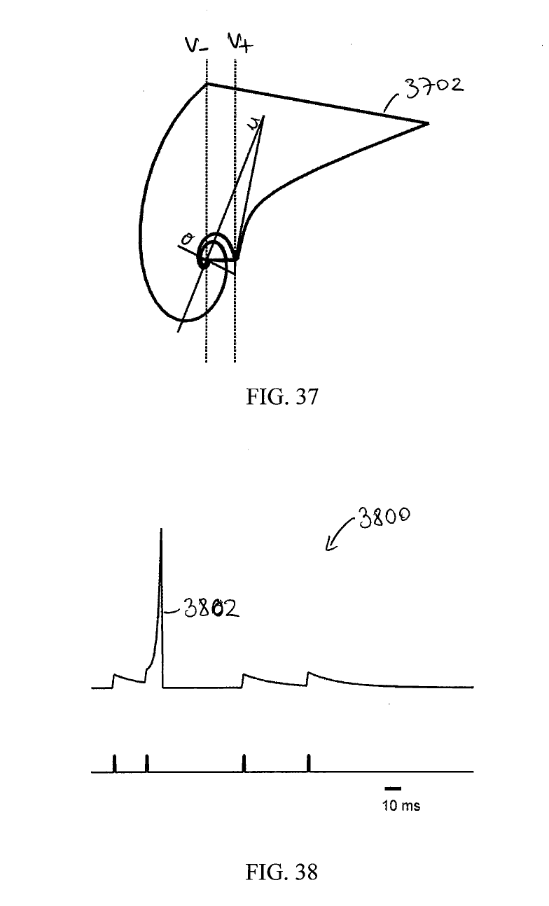

A decaying sub-threshold oscillation driving resonator behavior can be seen in state trajectory near rest. FIG. 37 illustrates such dynamics. Same conventions are used for all state-space trajectory diagrams, i.e., the x-axis is voltage state and y-axis is the current state; the two reference voltages v₋ and v₊ are plotted as vertical dashed lines, while the current u and voltage v null-clines are plotted over a limited domain as solid lines. The state trajectory is illustrated with a curve 3702. The dynamics of the decaying counter-clockwise orbit near rest, both before and after the spike, are directly comparable to those discussed above with respect to rest orbits around the intersection of the voltage and current null-clines in the negative regime. Current and conductance inputs are applied to the voltage state. If input occurs periodically but at an offset at a point on the orbit in state space to the left of rest at the time of subsequent input, the excitatory impact is dampened. If instead the input occurs when the state is on a point to the right of rest in the orbit, then the excitatory impact is enhanced.

In contrast, integrative behavior illustrated in an example 3800 in FIG. 38 does not have this distinguishing capability because there is no oscillation resulting in an orbit with a portion to the left of rest voltage. The integrative behavior is achievable in various ways, including decoupling the current dynamics. The parameters are same as before, except for δ=0 and Δv=8 mV. It can be observed from a graph 3802 in FIG. 38 that there is no oscillation as a result.

The underlying coupling feature also enables a behavior that may be termed as an apparent variability in the depolarization threshold due to inhibitory input. Inhibitory input, as with excitatory input, can be used to disturb the Model state, moving it into a sub-threshold oscillation. If a subsequent excitatory input occurs synchronously (coincident) with the oscillation, the effect can be reinforced and give the impression that the “threshold” of the cell has changed.

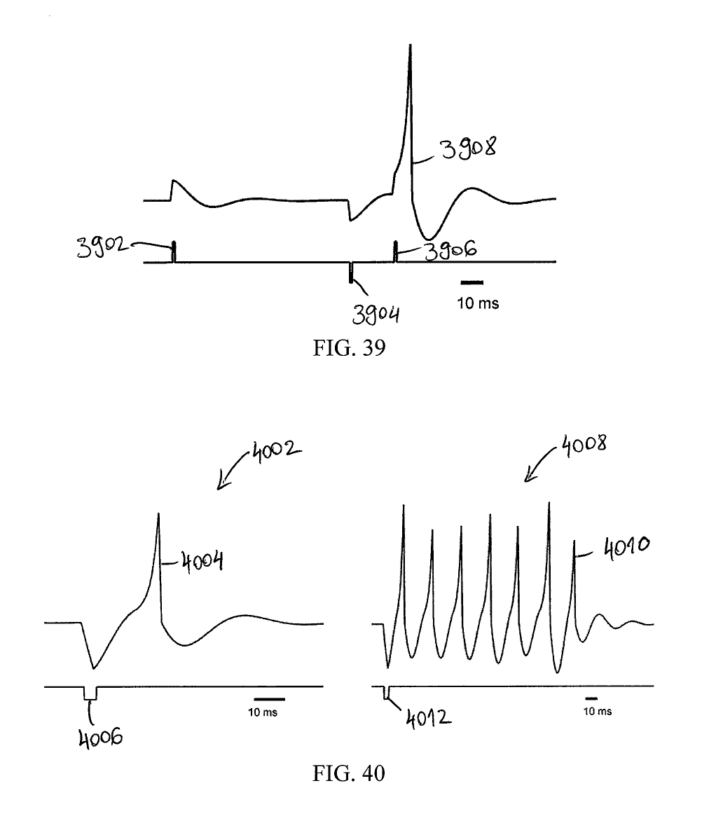

FIG. 39 illustrates, as a direct result of this underlying feature, how a spike pattern comprised of an inhibitory input followed by an excitatory input, with a particular inter-spike-interval, can cause a spike when the excitatory input could not alone (assuming the cell is at rest to begin with). The parameters are same as for nominal setting. The inter-spike interval is 20 ms with Δv=10 mV for each input. This behavior can be understood in the context of FIG. 37. The difference is that instead of using an excitatory input 3902 to start the oscillation at a point on the orbit to the right of rest, an inhibitory input 3904 followed by an excitatory input 3906 is used to start the oscillation at a point on the orbit to the left of rest. Since the orbit is then followed, it can be observed in FIG. 39 that the voltage 3908 oscillates (exceeding rest at the time of the excitatory input 3906). These spike-timing-related behaviors result from synchrony or lack of synchrony of input timing with the cell's current resonant frequency.

The effect of input magnitude and input timing on the state and thus spiking behavior can be controlled by designing the orbits in terms of the shape in <v,u> space (e.g., circular or elliptical) and time constants controlling the trajectory velocity. The former influences invariance with respect to timing (bandwidth) and magnitude, and the latter influences the primary resonant center frequency.

### Super-Threshold Oscillation

Above, the oscillations corresponded to sub-threshold state trajectories. However, trajectories are not constrained to the negative regime. If the rebound from an inhibitory input is sufficient, it can induce a spike. This may require a large inhibitory input or multiple inhibitory inputs to move the state into a path of outward spiral depending on parameters. A burst can be designed by increasing current dynamics (the slope of the current null-cline). FIG. 40 illustrates an example 4002 of a rebound spike 4004 caused by an input event 4006. For the rebound spike example 4002, parameters are the same as for nominal setting, and the inhibitory input 4006 is applied over 4 ms (at the artificial event interval of 1 ms). FIG. 40 illustrates an example 4008 of a rebound burst 4010 caused by an inhibitory input 4012. For the rebound burst example 4008, parameters are the same as for nominal settings, except for δ=−0.5.

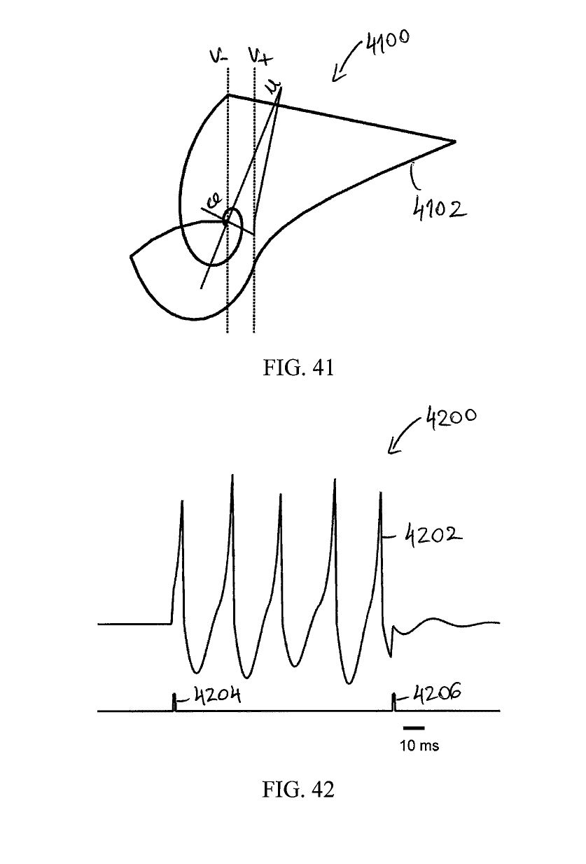

FIG. 41 illustrates an example 4100 of a state space trajectory 4102 in the case of the rebound spike example 4002 in FIG. 40. The inhibitory input moves the state deep into the negative regime and negative current state from which the state follows a partial orbit around the rest origin (counter-clockwise). However, since the orbit radius is quite large, the path intersects the regime boundary and causes a spike. That is the difference between sub-threshold oscillation and rebound spike/burst. It should be noted that there are many ways to influence whether the trajectory crosses the regime boundary, i.e., whether by controlling the trajectory, moving the references, changing the input, or designing the events.

Moreover, the very same underlying feature may enable bi-stability behaviors. Once a burst is underway, the state dynamics are in an orbit (which passes through the reset state(s)). In order to stop the burst, an input may be needed to knock the state out of orbit. In an aspect, either type of input (excitatory or inhibitory) can be suitable. FIG. 42 illustrates an example 4200 of bi-stability behavior (a graph 4202) with excitatory inputs 4204, 4206. Parameters are the same as for nominal setting, except the inputs are single events but larger, e.g., Δv=20 mV.

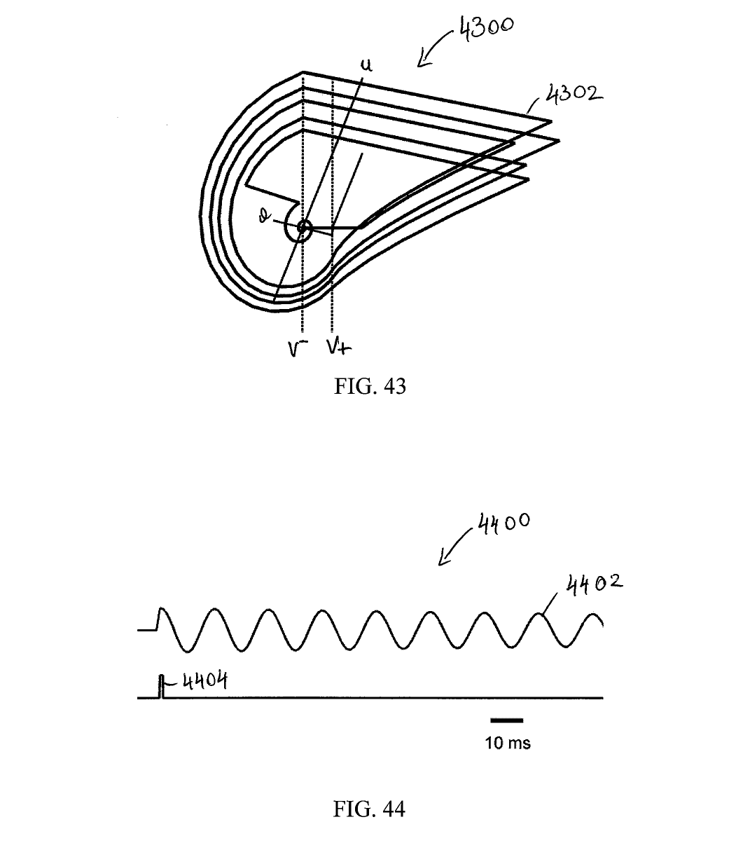

FIG. 43 illustrates an example 4300 of a state space trajectory 4302 for the bi-stability example 4200 from FIG. 42. The features to note are twofold. First, the initial excitatory input 4204 causes a spike and the reset parameters bring the state into an orbit producing further spikes (see, for example, the graph 4202). Second, the final excitatory input 4206 moves the state from a point on the orbit back to near rest voltage which results in a decaying spiral back to the rest origin. It should be noted that the timing of the final excitatory input is important.

In an aspect of the present disclosure, the parameters can be also modified according to the aforementioned analysis in the previous chapter to counter the decay and maintain the orbit in the negative regime. In addition, two or more of the methods described in that chapter can be used in conjunction.

### Intersections Between Coupling, Events and Oscillation

A variety of demonstrative dynamics of the Model including decaying, sustained and exploding orbits is presented above. A cell can transition between these types of cycles due to coupling or events (whether input, output or artificial). For example, above a sub-threshold, oscillation was demonstrated after spike (output event) and decaying orbit (to rest) was demonstrated after an excitatory input (input event). In general, the change in dynamics behavior may also depend on an oscillation if one is already present. The present disclosure first demonstrates an example application of one of the aforementioned principles to design oscillation by coupling (as opposed to events, input, or other parameters), and then demonstrates an example of how the oscillation can be designed to continue even after an event.

FIG. 44 illustrates an example 4400 of sub-threshold oscillation 4402, i.e., how increasing the magnitudes of coupling parameters β and δ are sufficient to counter the orbit decay. Parameters are same as for nominal setting except β=2 and δ=−0.725. The input 4404 was set to Δv=10 mV to be insufficient to incur a transition to the positive regime. In this case, the input is insufficient to enter the positive domain, and thus the system behavior illustrated by the graph 4402 is associated with sub-threshold oscillation.

Designing a cell that sustains oscillation after a spike may be achieved only by configuring the reset current offset Δu to bring the state into the orbit region. Generally, this may be accomplished by configuring Δu, \hat{v}₋ or both so that the state after reset is on an orbit path.

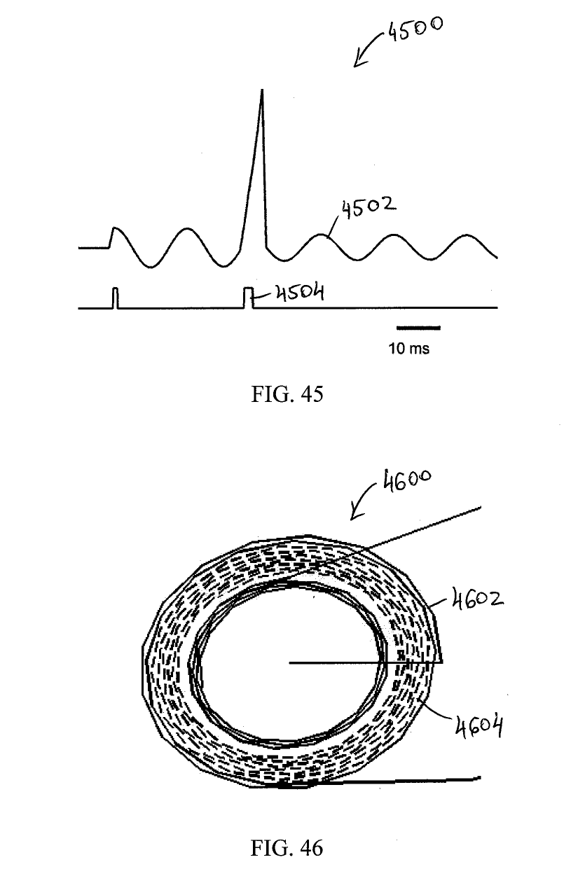

FIG. 45 illustrates an example 4500 of sub-threshold oscillation post-spike, i.e., how the same cell can oscillate sub-threshold (see a graph 4502 in FIG. 45) before and after spiking (before and after an input 4504). Parameters are same as above (unchanged), except Δu was changed from 0 to −11, which is sufficient to move the return state into an orbit path.

FIG. 46 illustrates an example 4600 of rest orbit paths before and after spike in accordance with certain aspects of the present disclosure. FIG. 46 illustrates how the sub-threshold oscillation after the spike (solid line 4602) returns to the orbit path as before the spike (dashed line 4604). The x-axis is the voltage state v and the y-axis is the current state u. The traces correspond to the state paths for FIGS. 44-45 overlaid. It should be noted that the width of the oscillatory region can be designed arbitrarily large relative to the contributing input.

### Oscillation Phase

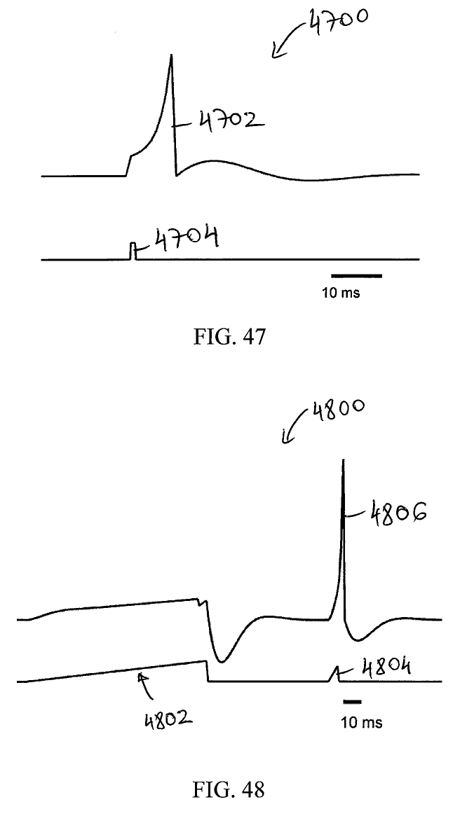

It should be noted that the behavior of the cells after spiking generally comprises a negative voltage swing (the oscillation starts off decreasing). However, a depolarization after spike is also possible to achieve. FIG. 47 illustrates an example 4700 whereby the depolarizing (see graph 4702) after potential (after an input 4704) is achieved by adjusting the current reset offset Δu. The parameters are the same as above except Δu=−7.5. Effectively, this places the oscillation in a different phase upon reset.

### Multiple Behaviors

Most of the above behaviors were achieved without changing Model parameters. All behaviors were achieved without substantially changing parameters (adjusting one or two at most). Moreover, adjusting particular parameters to alter aspects of behavior did not disturb other aspects of behavior to be retained. This advantage can be observed in behaviors characterized in other ways than spike timing patterns.

### Accommodation and Excitability

Cell behaviors are often characterized in terms of other input waveform shapes with the typical goal of determining the excitability of a cell (what aspects do or do not excite the cell). One of the more interesting input waveform shapes is the ramp because the amount of input evolves. Specifically, such characterization may involve supplying an increasing current to a cell. The ramp can be characterized by the slope (rate of increase) and the duration. Increasing (or otherwise changing) input is interesting when juxtaposed with how cell dynamics change during the input and whether they counter-act or emphasize the input changes.

### Accommodation

Accommodation is a behavior in which a cell's dynamics are above to recover from an increasing input, without spiking, as long as the rate of increase of the input is relatively low. However, if the rate of increase is faster, the cell may be unable to recover and prevent a spike. FIG. 48 illustrates an example 4800 of the accommodation principle. Parameters are same as for nominal setting, except τ₋=−5 ms, τ₊=1 ms, τᵤ=50 ms, δ=−1. Duration of first ramp 4802 is 100 ms, and duration of second ramp 4804 is 5 ms. First ramp 4802 has a slope of 8 mV/ms, and second ramp 4804 has ¾ the slope of the first ramp. It should be noted that the second ramp is shorter and smaller (lower peak and total integrated input) than the first ramp. Nevertheless, a spike 4806 results from the second ramp and not the first one.

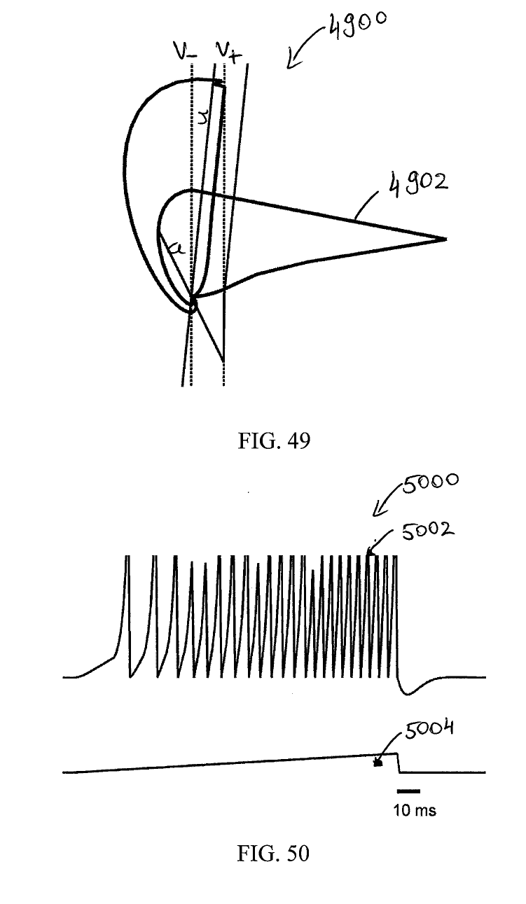

FIG. 49 illustrates an example 4900 of a state space trajectory 4902 for the accommodation example 4800 from FIG. 48. It should be noted that the input is applied to the voltage state but at a rate that is slow enough to allow the current state to bring the trajectory into a decay trajectory back toward rest. In contrast, the dynamics cannot respond fast enough to prevent a spike if the slope (rate of input) is increased.

### Spiking and Bursting Patterns

Varying spike rate behaviors may also be achieved for increasing excitatory inputs. A class 1 behavior, or increasing spiking rate, may be achieved by decreasing both the negative regime voltage time constant and current time constants. This emphasizes the effect of the instantaneous magnitude of the input, which is increasing, rather than the integrated or accumulated amount of input. As long as the reset parameters bring the state back into a similar trajectory each time, the behavior change (inter-spike-interval) will be largely influenced by that instantaneous input magnitude.

FIG. 50 illustrates an example 5000 of an increasing rate of spiking 5002 as a result of a rising excitatory input 5004. Parameters are same as for nominal setting, except the time constants were shortened to: τ₋=−5 ms, τᵤ=5 ms and δ=−0.1 to decrease the coupling slightly from nominal. It should be recalled that Δu=0 and \hat{v}₋=v₋ for nominal reset parameters.

A relatively more constant spiking rate, a class 2 behavior, may result if the reset parameters move the state such that the decay toward rest is faster after each spike so that as the excitatory input ramps up, the inter-spike-interval may remain relatively constant rather than decrease. A class 2 behavior, or relatively constant firing rate for a rising excitatory input, may thus result by balancing the reset condition for the current (and/or voltage).

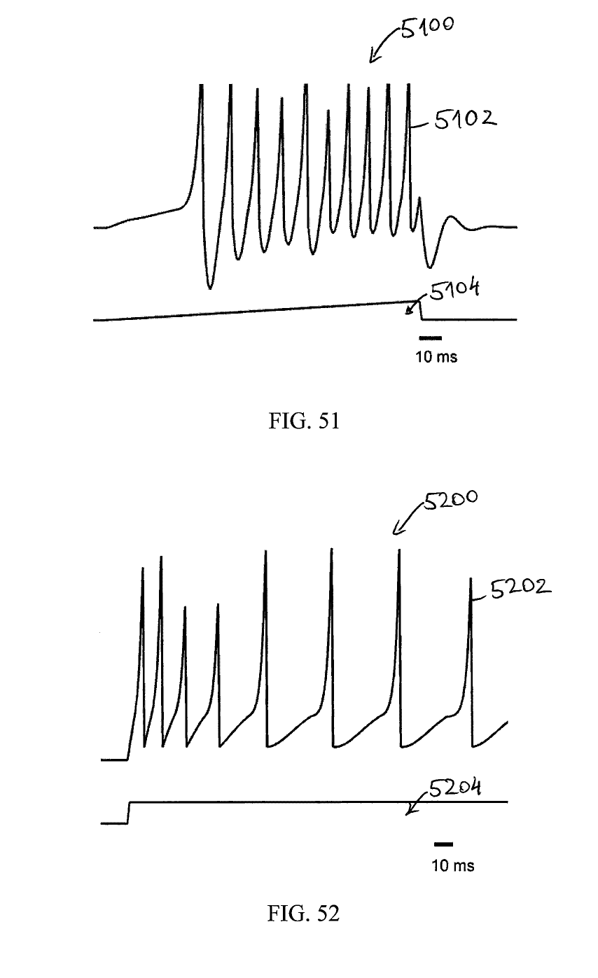

FIG. 51 illustrates an example 5100 of spiking 5102 at a relatively constant rate (fixed interval) despite a rising excitatory input 5104. Parameters are same as for class 1 except Δu=10 to balance (compensate) for increasing input and δ=−0.5 to increase the coupling. It should be noted that the excitatory input ramp for both class 1 and class 2 examples are identical, e.g., 140 ms in length, equivalent to 25 mV at peak/end. It should be noted that here, as in other voltage trace plots, the voltage upon spike does not appear to reach the spike threshold. However, this is merely because when it does, it is reset immediately so that the voltage plotted at the spike time is actually the reset voltage, and thus the spikes do not always appear as tall in the plots. This is merely an artifact of how the voltage is recorded.

### Tonic and Phasic Spiking and Bursting

Application of step input currents has typically been used as an experimental protocol for biological cell characterization including basic tonic and phasic spiking as well as bursting. These behaviors are quite straightforward as the focus is less on timing and input and more on ensuing output pattern, particularly in the case of tonic behavior.

### Tonic and Phasic Spiking

Ignoring the step transition itself for the moment, the sustained input thereafter may also be thought of as a rough approximation of a sum effect of many discrete inputs that are occurring over a period of time, possibly with a substantial filtering effect. With sustained excitatory input, tonic spiking is a behavior resulting from the input driving the voltage repeatedly into depolarization. Depending on state variable coupling and activity, the rate of spiking may change as a direct result. FIG. 52 illustrates an example 5200 of tonic spiking behavior 5202 as a result of a step 5204. Parameters are unchanged from the nominal setting. The behavior 5202 is generated by the input step 5204 (the sustained excitatory input). However, this behavior can result with various other parameterizations including those amenable to phasic spiking as described below merely by increasing the amount of input.

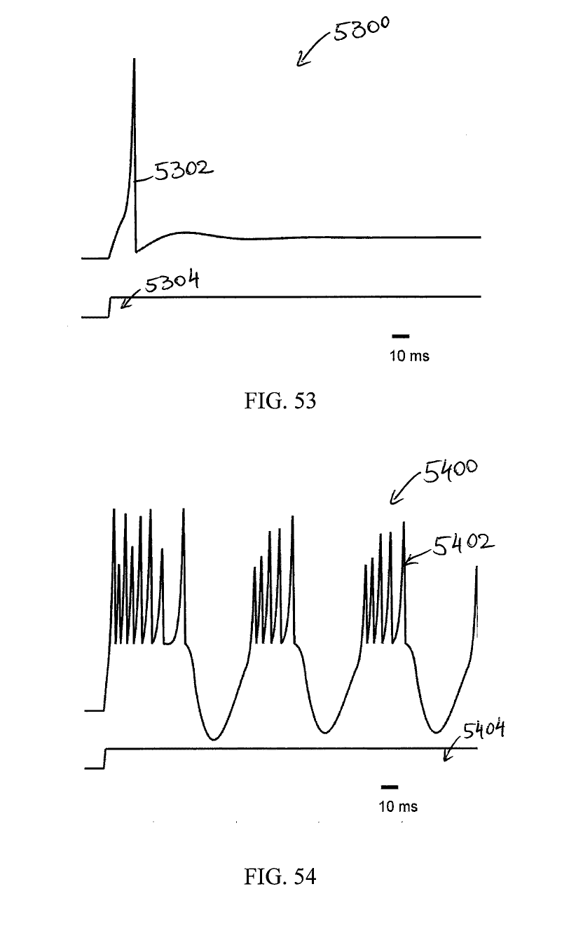

Phasic spiking behavior differs in that the spiking stops after the transition. However, the difference may be less than it appears at first glance. Phasic behavior will occur if the reset conditions put the trajectory on a non-spiking path after the first spike (despite sustained input) or if the trajectory during the first spike itself moves the state into a path that will decay after reset instead of spike again. The difference between the former and latter is what mechanism (or combination of mechanisms) drives the state to a non-spiking regime. FIG. 53 illustrates an example 5300 of the latter mechanism alone in accordance with certain aspects of the present disclosure. It can be observed that phasic spiking 5302 stops after transition of the input step 5304. Parameters are same as nominal, except the current decay time constant is increased to τᵤ=40 ms, which influences where the state ends up after reset. It should be also noted that various other parameterizations or input can result in the same or similar behavior.

### Tonic and Phasic Bursting

Tonic and phasic bursting are similar to tonic and phasic spiking. However, to generate bursts, the only fundamental change to parameterization (from nominal) that may be needed is increasing the reset voltage or adjusting the reset current offset so that the cell continues to spike. Also, the current time constant will influence burst characteristics such as how long the bursts lasts.

FIG. 54 illustrates an example 5400 of tonic bursting 5402 achieved mainly by adjusting the reset conditions. Parameters are same as for tonic and phasic spiking except the reset conditions changed to Δu=1.5 and \hat{v}₋=−45 mV to create the burst after an input step 5404.

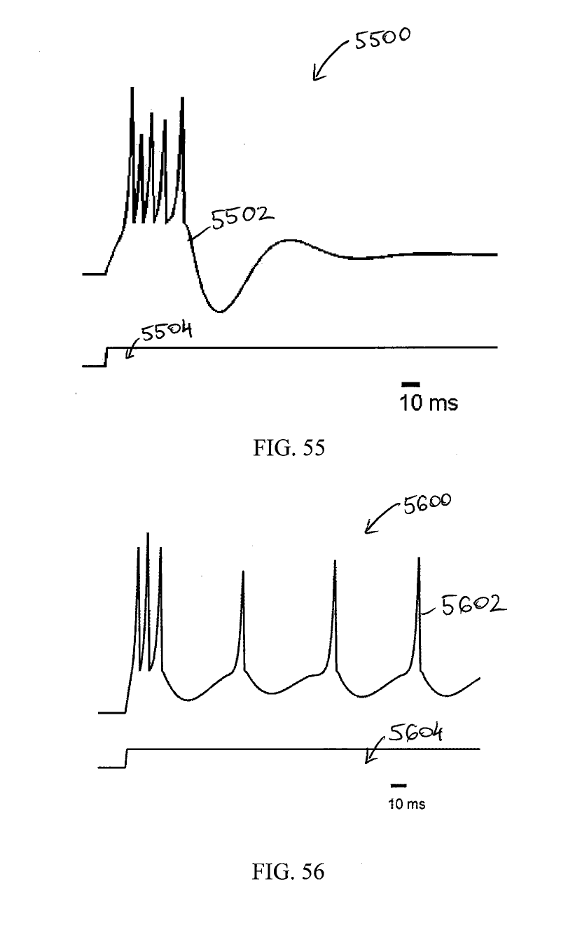

Phasic busting behavior is similar and achievable using the same mechanisms. A difference (reduction) in input can turn tonic to phasic because the rebound may be reduced and insufficient to kick off the next burst. This can be demonstrated by adjusting the relative regime reference voltage difference to adjust sensitivity of the cell behavior to exact input level. FIG. 55 illustrates an example 5500 of phasic bursting behavior 5502 upon an input step 5504. Parameters are same as for tonic bursting except leaving the current reset condition unchanged from nominal, i.e., Δu=0 and changing the regime reference difference by setting \hat{v}₊=−50 mV.

### Adaptation Variations

Mixed mode behavior is similar if not often indistinguishable from tonic spiking. However, there are other ways of generating mixed mode behaviors including parameterizations like those used for tonic or phasic bursting. This is because of two reasons. First, bursts are just a sequence of spikes close in time where the requisite “closeness” to be considered a burst is rather a matter of time scale or definition (often arbitrary). Second, a single spike is basically a burst that has only one spike. Thus, mixed behaviors can be generated by elements of tonic or phasic bursts (one or more spikes).

FIG. 56 illustrates an example 5600 of how a tonic/phasic bursting parameterization can also result in mixed mode behavior 5602 initiated by an input step 5604. Parameters are same as for phasic bursting except small change to reset conditions Δu=1 and \hat{v}₋=−53 mV. This is just another example of how one type of behavior can result from various combinations of parameterizations or input formulations.

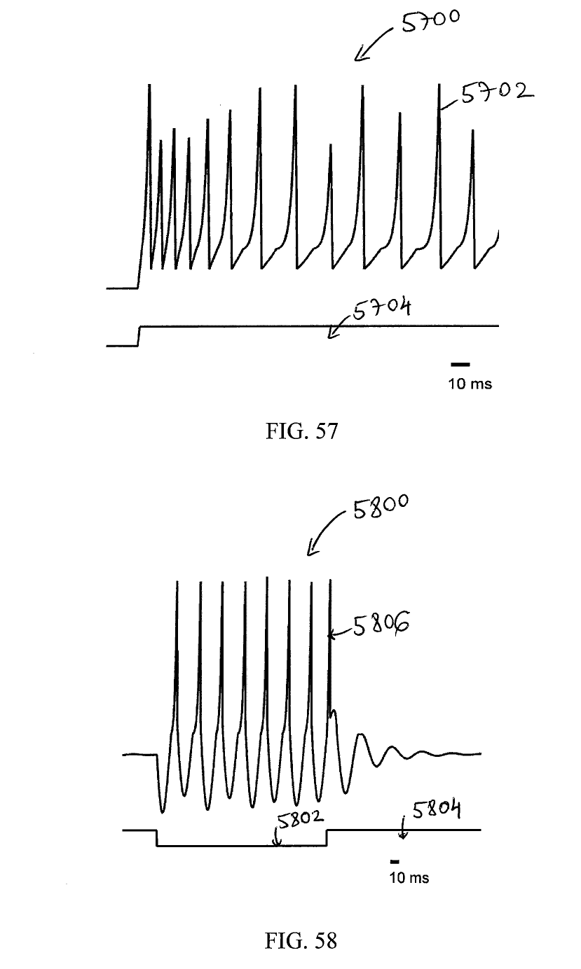

The same general principles may apply for spike frequency adaptation behaviors, as illustrated in an example 5700 in FIG. 57. Parameters are same as above except small change to reset conditions Δu=0.5 and returning to the nominal \hat{v}₋=−70 mV to show how common parameters explain various behaviors. The frequency of spikes 5702 in the “sustained burst” initiated by an input step 5704 can be controlled by various parameters including the reset conditions or time constants, for example.

A variety of straightforward behaviors in response to step excitatory input can be explained by reset conditions and evolution of the current state as determined by the current state decay time constant. However, various behaviors may be generated by alternative parameterizations and mechanisms (or combinations), and the presented examples are demonstrative and not meant to be exhaustive or preferred. The examples are selected to demonstrate particular minimal parameter differences that change behavior or to explain a particular relationship without necessarily any intention to minimize parameter changes.

### Null-Cline Saddle

The current time constant τᵤ is typically a positive value so that the state tends toward the null-cline. Moreover, the coupling parameter δ is typically negative so that the null-cline has a positive slope. However, if the sign of τᵤ is reversed, the transform variable and null-cline r becomes a saddle point instead of an attractor. This would result in a spiking loop without input because: (i) above the null-cline the state is pushed up and drawn toward negative voltage/away from positive voltage; (ii) with a sufficiently aggressive (small) τ₋, the state is drawn across the null-cline; and (iii) once under the null-cline, the state is pushed downward and drawn out toward spiking voltage. When the state is reset, the loop repeats and the cell continues spiking.

However, the cell can be made to stop spiking by adding excitatory input. This may require adding enough excitatory input to offset the voltage derivative at large negative voltages. As a result, the negative voltage derivative becomes positive. If it is positive enough, the state trajectory can cross back over the null-cline and loop back (a sub-threshold loop) and even decay to a stable point if desired. But, if the excitatory input is removed (or countered with inhibition), the cell can re-enter the spiking loop.

In demonstrating these principles below, some additional atypical parameterization aspects can be considered. For example, the regime threshold \hat{v}₊ can be set to a value other than the positive regime reference voltage v₊. This means that the state trajectory can be designed using one of the voltage null-clines beyond the typical extend (reference voltage). For example, by reducing the regime threshold to \hat{v}₊=v₋, the positive regime null-cline effectively extends all the way back to v₋ and governs dynamics between v₋ and v₊ as well as above v₊. This can be used to achieve various desired effects including pushing the voltage state rather than pulling it.

In an example 5800 in FIG. 58, inhibition 5802 is added to offset (cancel) a constant excitatory input 5804 resulting into inhibition-induced spiking 5806. Parameters modified from nominal example are: τᵤ=−25, δ=+0.9, and \hat{v}₊=v₋ as well as τ₋=−10. The reset condition is also set to Δu=10 and \hat{v}₋=−60 mV. When the inhibition cancels the excitatory input, the cell begins to fire and continues to do so because the reset condition brings the cell back to unstable conditions absent input. When the inhibition is removed, the net excitatory input places the state above the current saddle point, which pushes the current state back to zero instead of exploding.

FIG. 59 illustrates an example 5900 of a state trajectory 5902 for the inhibition-induced spiking example 5800 from FIG. 58. It should be noted how the removal of the excitation (cancellation by inhibition) results in a spiking cycle. The reintroduction of excitatory input puts the trajectory into a decaying orbit about an elevated origin due to the input offset.

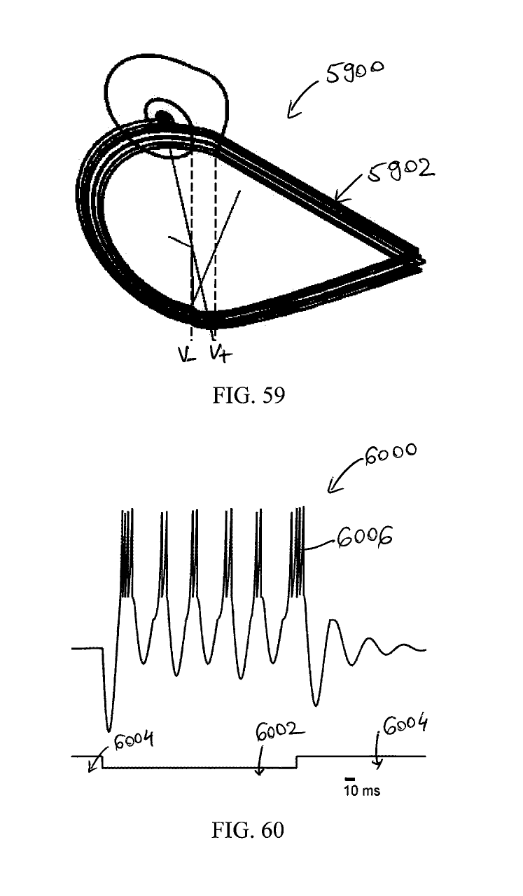

Bursting can be achieved by applying one or more of the principles discussed above. For example, the reset state can be changed to place the state on a faster orbit path. FIG. 60 illustrates an example 6000 of inhibition-induced bursting. Inhibition 6002 is added to offset (cancel) a constant excitatory input 6004 resulting into inhibition-induced bursting 6006. Parameters are same as above except Δu=0 and \hat{v}₋=−48 mV.

In summary, the Model is flexible in that even atypical parameter ranges can be used to model rich biologically realistic behaviors.

### Cell Templates

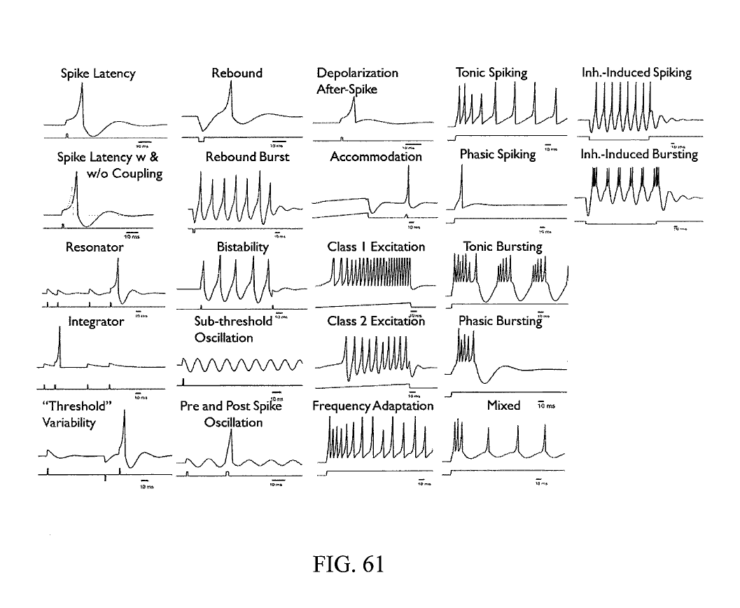

For practical purposes, a limited set of examples were discussed in the present disclosure. Accordingly, the examples demonstrated a limited set of behaviors, each generated in one of multiple possible ways. A model designer should be encouraged to apply the principles to achieve these and related or similar desired behaviors and interactions between dynamics and consider that multiple design combinations (parameterizations, events, and inputs) are generally possible. The aforementioned behaviors are reproduced in FIG. 61.

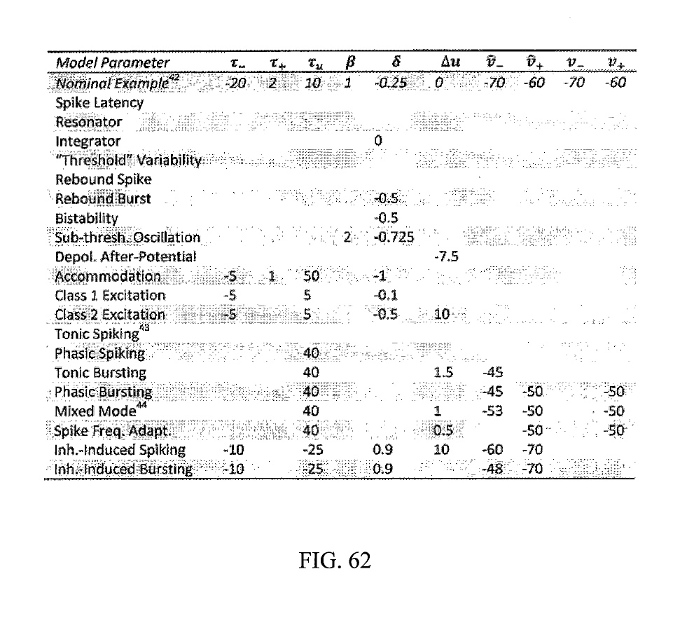

FIG. 62 summarizes the nominal example parameter settings and the specific variations on those parameters demonstrated in the above examples. This should not accord the actual values or specific variations demonstrated undue importance. Rather, these examples may serve as conceptual templates for relative parameterizations (how parameters relate to one another) and behavioral aspects.

Examining FIG. 62 reveals how cells with the same parameters (or similar, e.g., only a single parameter change) can exhibit multiple behaviors. In an aspect, modifying parameters may prevent a subset of behaviors, allow new behaviors, change the domain in which behaviors are exhibited, or some combination thereof. Upon first glance at the limited example parameter set illustrated in FIG. 62, it may be tempting to assume that two behaviors with different parameters require that difference for the behavioral difference. But, other means of creating one behavior may have parameters equal to or similar to another behavior. It should be recalled that these examples were chosen to demonstrate particular design modeling principles. It should be also noted that events influence dynamics, and that input formulation is another dimension for design as well.

It should be noted in FIG. 62 that the nominal example is arbitrary. Tonic spiking may also result with phasic spiking parameters with stronger input. Mixed Mode behavior may be indistinguishable from Tonic Spiking. Different parameters are used for Mixed Mode merely to demonstrate that behaviors can be generated or explained in different ways.

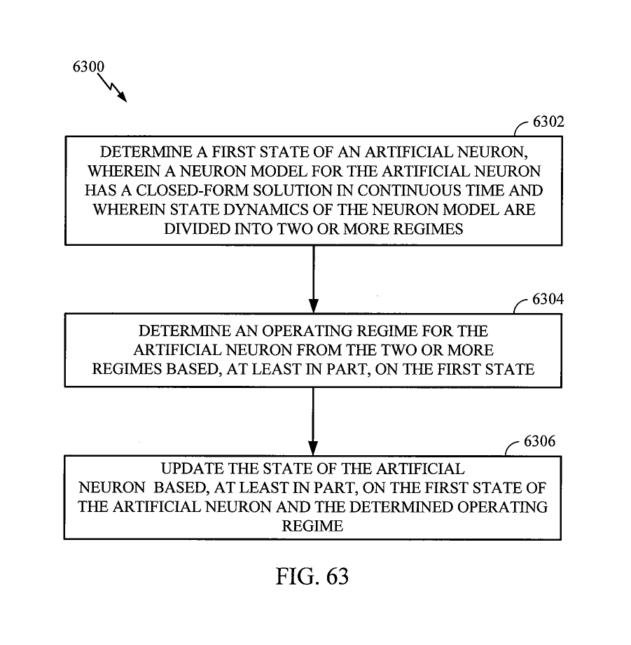

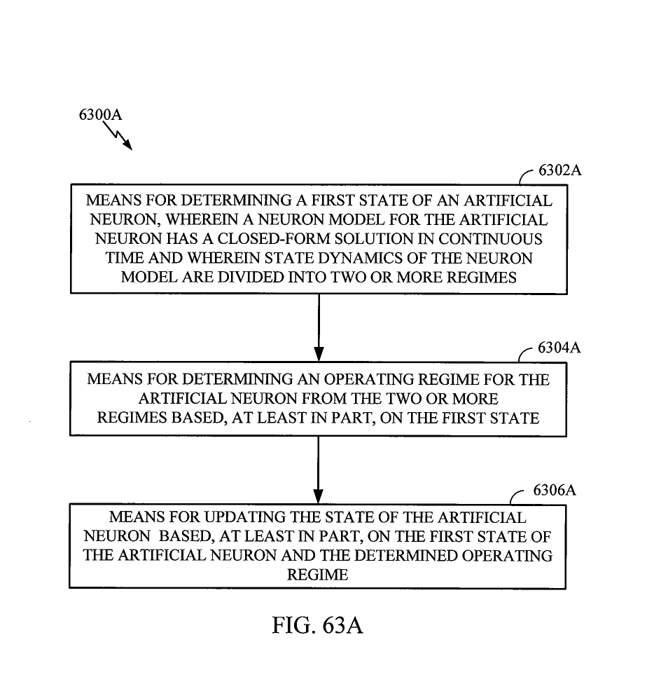

FIG. 63 illustrates example operation 6300 for updating a state of an artificial neuron in accordance with certain aspects of the present disclosure. At 6302, a first state of the artificial neuron may be determined, wherein a neuron model for the artificial neuron may have a closed-form solution in continuous time and wherein state dynamics of the neuron model may be divided into two or more regimes. At 6304, an operating regime for the artificial neuron may be determined from the two or more regimes based, at least in part, on the first state. At 6306, the state of the artificial neuron may be updated based, at least in part, on the first state of the artificial neuron and the determined operating regime.

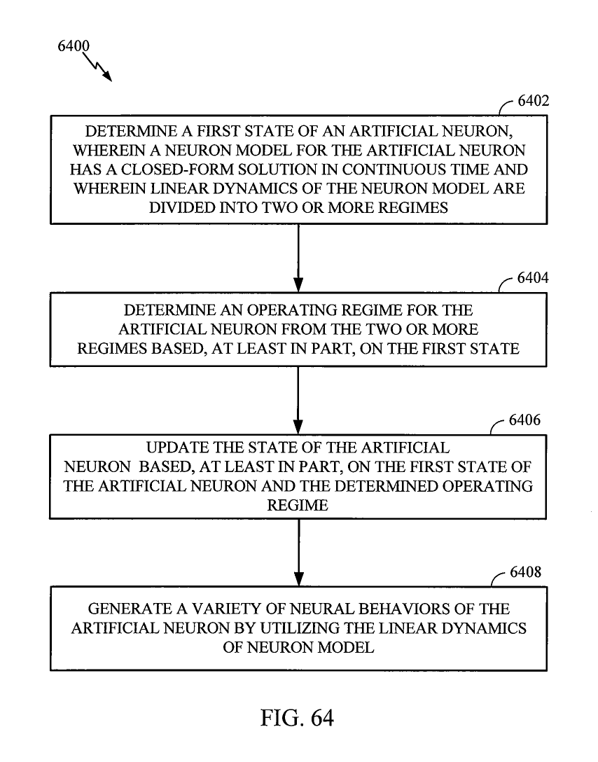

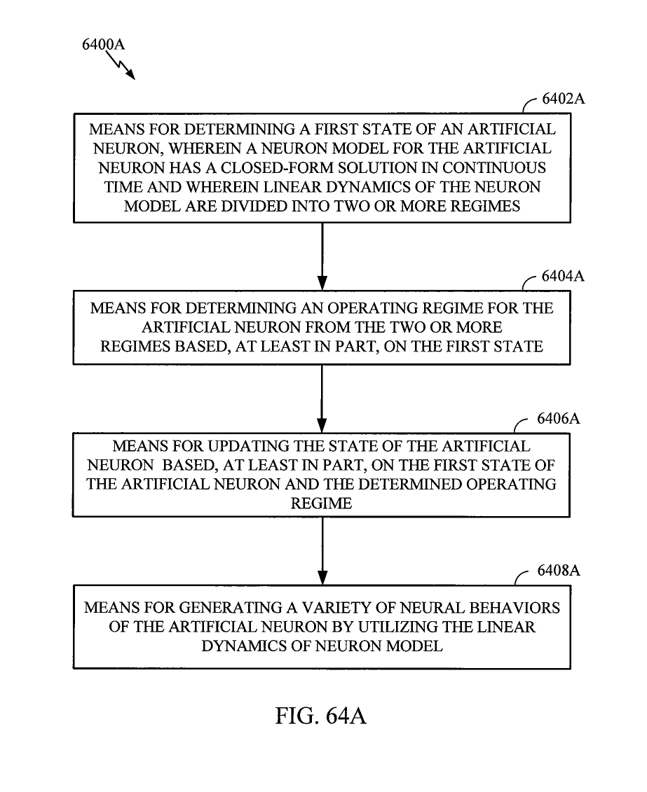

FIG. 64 illustrates example operation 6400 for producing various neural behaviors of an artificial neuron in accordance with certain aspects of the present disclosure. At 6402, a first state of the artificial neuron may be determined, wherein a neuron model for the artificial neuron has a closed-form solution in continuous time and wherein linear dynamics of the neuron model are divided into two or more regimes. At 6404, an operating regime for the artificial neuron may be determined from the two or more regimes based, at least in part, on the first state. At 6406, the state of the artificial neuron may be updated based, at least in part, on the first state of the artificial neuron and the determined operating regime. At 6408, a variety of neural behaviors of the artificial neuron may be generated by utilizing the linear dynamics of neuron model.

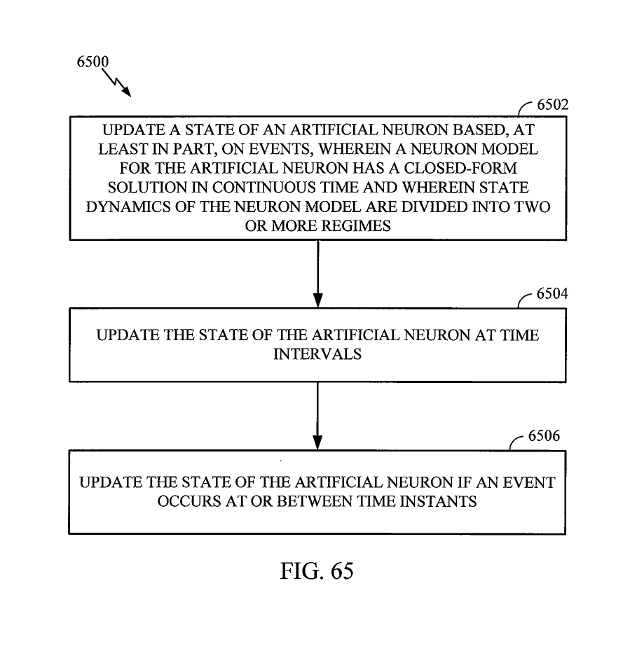

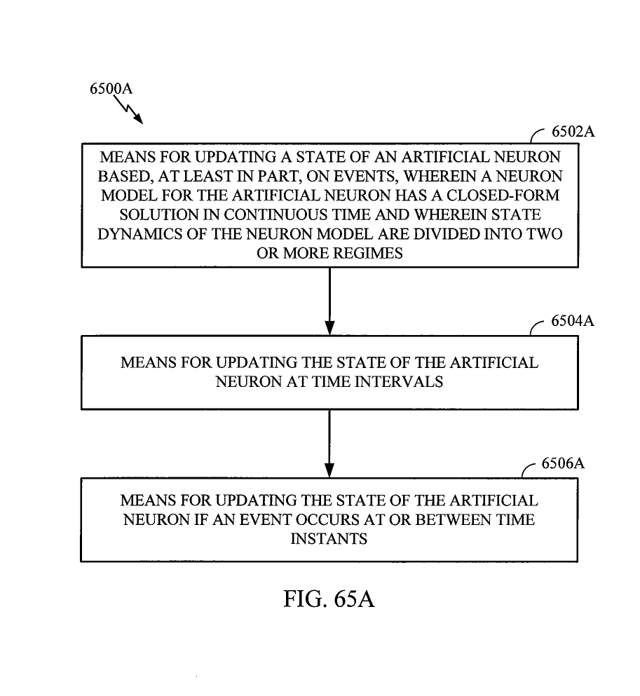

FIG. 65 illustrates example operation 6500 for updating a state of an artificial neuron in accordance with certain aspects of the present disclosure. At 6502, the state of the artificial neuron may be updated based, at least in part, on events, wherein a neuron model for the artificial neuron has a closed-form solution in continuous time and wherein state dynamics of the neuron model are divided into two or more regimes. At 6504, the state of the artificial neuron may be updated at time intervals. At 6506, the state of the artificial neuron may be updated if an event occur at or between time instants.

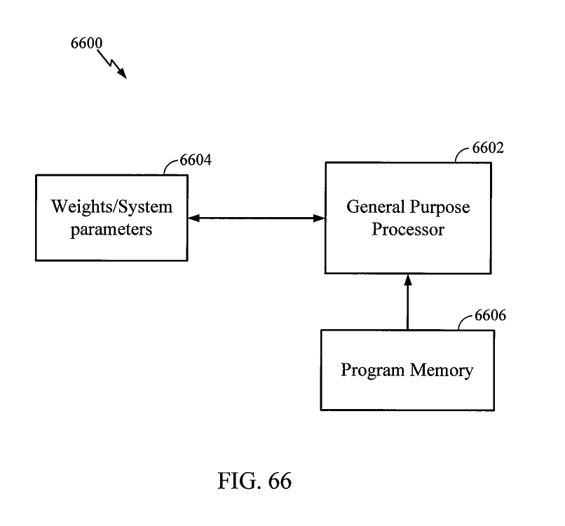

FIG. 66 illustrates an example implementation 6600 of the aforementioned methods for updating the state of an artificial neuron and producing various neural behaviors of the artificial neuron using a general-purpose processor 6602 in accordance with certain aspects of the present disclosure. Variables (neural signals), synaptic weights and system parameters associated with a computational network (neural network) may be stored in a memory block 6604, while instructions executed at the general-purpose processor 6602 may be loaded from a program memory 6606. In an aspect of the present disclosure, the instructions loaded into the general-purpose processor 6602 may comprise code for determining a first state of the artificial neuron, wherein a neuron model for the artificial neuron has a closed-form solution in continuous time and wherein state (linear) dynamics of the neuron model are divided into two or more regimes, code for determining an operating regime for the artificial neuron from the two or more regimes, based, at least in part, on the first state, code for updating the state of the artificial neuron based, at least in part, on the first state of the artificial neuron and the determined operating regime, and code for generating a variety of neural behaviors of the artificial neuron by utilizing the linear dynamics of neuron model.

In another aspect of the present disclosure, the instructions loaded into the general-purpose processor 6602 may comprise code for updating the state of the artificial neuron based on events, wherein a neuron model for the artificial neuron has a closed-form solution in continuous time and wherein state dynamics of the neuron model are divided into two or more regimes, code for updating the state of the artificial neuron at time intervals, and code for updating the state of the artificial neuron if an event occur at or between time instants.

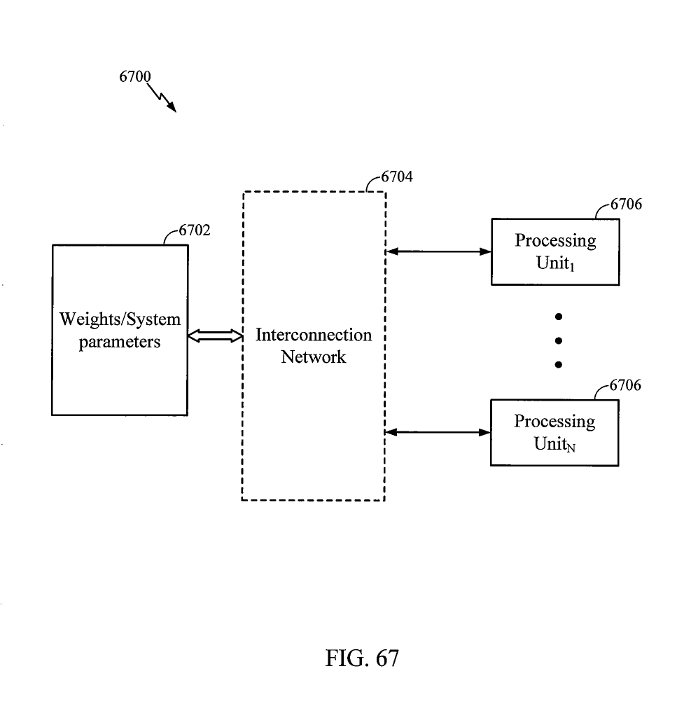

FIG. 67 illustrates an example implementation 6700 of the aforementioned methods for updating the state of an artificial neuron and producing various neural behaviors of the artificial neuron where a memory 6702 can be interfaced via an interconnection network 6704 with individual (distributed) processing units (neural processors) 6706 of a computational network (neural network) in accordance with certain aspects of the present disclosure. Variables (neural signals), synaptic weights and system parameters associated with the computational network (neural network) may be stored in the memory 6702, and may be loaded from the memory 6702 via connection(s) of the interconnection network 6704 into each processing unit (neural processor) 6706. In an aspect of the present disclosure, the processing unit 6406 may be configured to determine a first state of the artificial neuron, wherein a neuron model for the artificial neuron has a closed-form solution in continuous time and wherein state (linear) dynamics of the neuron model are divided into two or more regimes, determine an operating regime for the artificial neuron from the two or more regimes, based, at least in part, on the first state, update the state of the artificial neuron based, at least in part, on the first state of the artificial neuron and the determined operating regime, and generate a variety of neural behaviors of the artificial neuron by utilizing the linear dynamics of neuron model.

In another aspect of the present disclosure, the processing unit 6706 may be configured to update the state of the artificial neuron based on events, wherein a neuron model for the artificial neuron has a closed-form solution in continuous time and wherein state dynamics of the neuron model are divided into two or more regimes, update the state of the artificial neuron at time intervals, and update the state of the artificial neuron if an event occur at or between time instants.

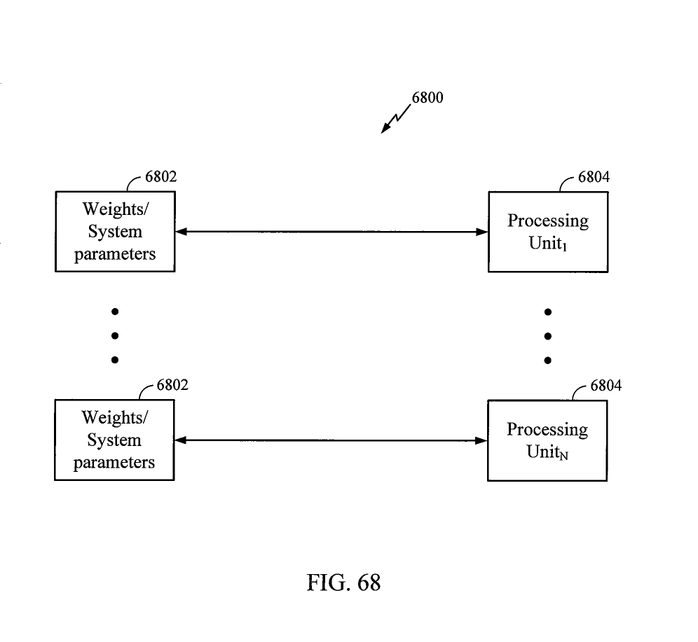

FIG. 68 illustrates an example implementation 6800 of the aforementioned methods for updating the state of an artificial neuron and producing various neural behaviors of the artificial neuron based on distributed memories 6802 and distributed processing units (neural processors) 6804 in accordance with certain aspects of the present disclosure. As illustrated in FIG. 68, one memory bank 6802 may be directly interfaced with one processing unit 6804 of a computational network (neural network), wherein that memory bank 6802 may store variables (neural signals), synaptic weights and system parameters associated with that processing unit (neural processor) 6804. In an aspect of the present disclosure, the processing unit 6804 may be configured to determine a first state of the artificial neuron, wherein a neuron model for the artificial neuron has a closed-form solution in continuous time and wherein state (linear) dynamics of the neuron model are divided into two or more regimes, determine an operating regime for the artificial neuron from the two or more regimes, based, at least in part, on the first state, update the state of the artificial neuron based, at least in part, on the first state of the artificial neuron and the determined operating regime, and generate a variety of neural behaviors of the artificial neuron by utilizing the linear dynamics of neuron model.

In another aspect of the present disclosure, the processing unit 6804 may be configured to update the state of the artificial neuron based on events, wherein a neuron model for the artificial neuron has a closed-form solution in continuous time and wherein state dynamics of the neuron model are divided into two or more regimes, update the state of the artificial neuron at time intervals, and update the state of the artificial neuron if an event occur at or between time instants.

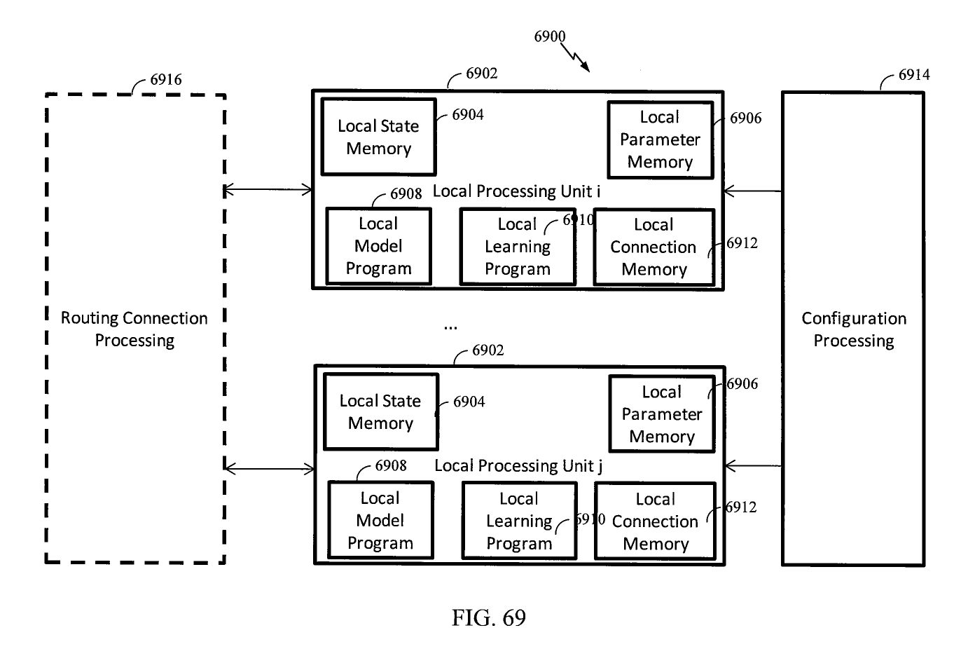

FIG. 69 illustrates an example implementation of a neural network 6900 in accordance with certain aspects of the present disclosure. As illustrated in FIG. 69, the neural network 6900 may comprise a plurality of local processing units 6902 that may perform various operations of methods described above. Each processing unit 6902 may comprise a local state memory 6904 and a local parameter memory 6906 that store parameters of the neural network. In addition, the processing unit 6902 may comprise a memory 6908 with local (neuron) model program, a memory 6910 with local learning program, and a local connection memory 6912. Furthermore, as illustrated in FIG. 69, each local processing unit 6902 may be interfaced with a unit 6914 for configuration processing that may provide configuration for local memories of the local processing unit, and with routing connection processing elements 6916 that provide routing between the local processing units 6902.

According to certain aspects of the present disclosure, the operations 6300, 6400 and 6500 illustrated in FIGS. 63-65 may be performed in hardware, e.g., by one or more processing units 6902 from FIG. 69.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in Figures, those operations may have corresponding counterpart means-plus-function components with similar numbering. For example, operations 6300, 6400 and 6500 illustrated in FIG. 63, FIG. 64 and FIG. 65 correspond to components 6300A, 6400A and 6500A illustrated in FIG. 63A, FIG. 64A and FIG. 65A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC (Application Specific Integrated Circuit) with the processor, the bus interface, the user interface, supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for updating a state of an artificial neuron, comprising:
determining a first state of the artificial neuron, wherein a neuron model for the artificial neuron has a closed-form solution in continuous time and wherein state dynamics of the neuron model are divided into two or more regimes;
determining an operating regime for the artificial neuron from the two or more regimes based, at least in part, on the first state; and
updating the state of the artificial neuron based, at least in part, on the first state of the artificial neuron and the determined operating regime.

2. The method of claim 1, wherein the two or more regimes comprise first and second regimes and wherein the state dynamics of the neuron model tend toward rest in the first regime and tend toward spiking in the second regime.

3. The method of claim 1, wherein the two or more regimes comprise first and second regimes and wherein the state dynamics of the neuron model tend toward a first reference in the first regime and tend away from a second reference in the second regime.

4. The method of claim 1, wherein the two or more regimes comprise first and second regimes and wherein the state dynamics of the neuron model exhibit leaky-integrate-and-fire (LIF) behavior in the first regime and exhibit anti-leaky-integrate-and-fire (ALIF) behavior in the second regime.

5. The method of claim 1, further comprising:
determining a second state of the neuron model at a different time than that of the first state, based on at least one of the first state and the operating regime.

6. The method of claim 5, wherein the first state of the neuron model corresponds to a first event, wherein the second state corresponds to a second event, and wherein the second event is the next event after the first event.

7. The method of claim 6, wherein the first event comprises an input event, an output event, or an artificial event for the neuron model.

8. The method of claim 6, wherein determining the second state comprises determining the second state of the neuron model based, at least in part, on a time between the first event and the second event and on the state dynamics in the operating regime.

9. The method of claim 8, wherein the first state is defined by a membrane potential (v) and a recovery current (u) of the neuron model and wherein determining the second state is according to:
$${v}^{′} ( t + Δ t ) = {v}^{′} ( t ) {e}^{\frac{Δ t}{{τ}_{ρ}}} , \\ {u}^{′} ( t + Δ t ) = {u}^{′} ( t ) {e}^{\frac{Δ t}{{τ}_{u}}} , \\ {v}^{′} = v + {q}_{ρ} , \\ {u}^{′} = u + r , \\ {q}_{ρ} = - {τ}_{ρ} β u - {v}_{ρ}^{′} , and$$
$$r = δ ( v + ɛ ) ,$$
where Δt is an elapsed time between the first and second states, ρ=+ if v>\hat{v}₊, ρ=− if v≦\hat{v}₊, \hat{v}₊ is a regime threshold, τ_{ρ} is a voltage time constant, τᵤ is a recovery current time constant, β is a resistance, v_{ρ} is a base voltage for the operating regime, q_{ρ} and r are state transformation variables, δ is a scale factor, and ε is an offset voltage.

10. The method of claim 1, further comprising:
determining when the artificial neuron will fire based, at least in part, on at least one of the first state or the operating regime.

11. The method of claim 10, wherein the first state is defined by a membrane potential (v) and a recovery current (u) of the neuron model and wherein determining when the artificial neuron will fire comprises using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise ,\end{matrix}$$
where τ₊ is a positive regime voltage time constant, v_{S} is a defined voltage of an output spike of the neuron model, q is a positive regime state transformation variable, \hat{v}₊ is a regime threshold and Δt_{S} is an anticipated time until the artificial neuron will fire.

12. The method of claim 1, wherein updating the state of the artificial neuron comprises updating the state at or immediately after a time instant of an event.

13. The method of claim 1, wherein updating the state of the artificial neuron comprises updating the state at determined time intervals.

14. The method of claim 1, wherein updating the state of the artificial neuron comprises updating the state if an event occurs at or between determined time intervals.

15. The method of claim 1, wherein the state dynamics are defined by a membrane potential and a recovery current of the neuron model.

16. The method of claim 1, further comprising:
applying an input event to the state dynamics of the neuron model after the first state is advanced from a prior event to a time of the input event according to
v′(t+Δt)=hᵥ(v′(t)e^{Δt/τ}^{_{ρ}},i),
u′(t+Δt)=hᵤ(u′(t)e^{Δt/τ}^{ᵤ},i),
where the first state is defined by a membrane potential (v) and a recovery current (u) of the neuron model, Δt is an elapsed time between the prior event and the input event, hᵥ and hᵤ are input channel functions, τ_{ρ} is a voltage time constant, ρᵤ is a recovery current time constant, and i is a function that models the input event.

17. The method of claim 16, wherein a total contribution over the elapsed time between the prior event and the input event is given by,
$$i = {\int }_{t}^{t + Δ t} g d t = g {τ}_{g} ( 1 - {e}^{\frac{Δ t}{{τ}_{g}}} ) ,$$
where g is an exponentially decaying excitatory or inhibitory input, and τ_{g} is a decaying time constant.

18. The method of claim 1, further comprising:
advancing the state of the artificial neuron from a prior event to a next event;
updating the state at the next event time given an input at the next time event; and
anticipating when an event after the next event will occur.

19. The method of claim 1, further comprising:
applying one or more artificial events to change coupling of the neuron model,
wherein the state of the artificial neuron evolves decoupled since a last event after applying the one or more artificial events.

20. The method of claim 9, wherein null-clines for the membrane potential (v) and the recovery current (u) are given by the negative of the state transformation variables q_{ρ} and r, respectively, wherein
v=τ_{ρ}βu+v_{ρ} or u=(v−v_{ρ})/τ_{ρ}β,
u=−δ(v+ε) or v=−u/δ−ε,
and wherein the parameter δ is a scale factor controlling the slope of the u null-cline, which may be positive (for δ<0) or negative (for δ>0).

21. An apparatus for updating a state of an artificial neuron, comprising a processing system configured to:
determine a first state of the artificial neuron, wherein a neuron model for the artificial neuron has a closed-form solution in continuous time and wherein state dynamics of the neuron model are divided into two or more regimes;
determine an operating regime for the artificial neuron from the two or more regimes based, at least in part, on the first state; and
update the state of the artificial neuron based, at least in part, on the first state of the artificial neuron and the determined operating regime.

22. An apparatus for updating a state of an artificial neuron, comprising:
means for determining a first state of the artificial neuron, wherein a neuron model for the artificial neuron has a closed-form solution in continuous time and wherein state dynamics of the neuron model are divided into two or more regimes;
means for determining an operating regime for the artificial neuron from the two or more regimes based, at least in part, on the first state; and
means for updating the state of the artificial neuron based, at least in part, on the first state of the artificial neuron and the determined operating regime.

23. A computer program product for updating a state of an artificial neuron, comprising a computer-readable medium comprising code for:
determining a first state of the artificial neuron, wherein a neuron model for the artificial neuron has a closed-form solution in continuous time and wherein state dynamics of the neuron model are divided into two or more regimes;
determining an operating regime for the artificial neuron from the two or more regimes based, at least in part, on the first state; and
updating the state of the artificial neuron based, at least in part, on the first state of the artificial neuron and the determined operating regime.

24. A method for producing neural behaviors of an artificial neuron, comprising:
determining a first state of the artificial neuron, wherein a neuron model for the artificial neuron has a closed-form solution in continuous time and wherein linear dynamics of the neuron model are divided into two or more regimes;
determining an operating regime for the artificial neuron from the two or more regimes based, at least in part, on the first state;
updating the state of the artificial neuron based, at least in part, on the first state of the artificial neuron and the determined operating regime; and
generating a variety of neural behaviors of the artificial neuron by utilizing the linear dynamics of neuron model.

25. The method of claim 24, wherein the neural behaviors comprise sustained sub-threshold oscillations of the artificial neuron.

26. The method of claim 25, wherein the neural behaviors of the artificial neuron further comprise at least one of: rebound, depolarization after spiking, tonic spiking, pre- and post-spike oscillation, rebound burst, accommodation, phasic spiking, bi-stability, class 1 excitation, tonic bursting, resonating, inhibition-induced spiking, class 2 excitation, phasic bursting, inhibition-induced bursting, frequency adaptation, or integrative behavior.

27. The method of claim 24, wherein the linear dynamics of the neuron model comprise:
a sub-threshold regime with a negative time constant representing leaky-integrate-and-fire dynamics acting to return the artificial neuron to rest, and
a supra-threshold regime with a positive time constant representing anti-leaky-integrate-and-fire dynamics driving the artificial neuron to spike with a latency.

28. The method of claim 27, wherein the linear dynamics of the neuron model is defined as:
$${τ}_{ρ} \frac{d v}{d t} = v + {q}_{ρ} , \\ - {τ}_{u} \frac{d u}{d t} = u + r , \\ {q}_{ρ} = - {τ}_{ρ} β u - {v}_{ρ} , and$$
$$r = δ ( v + ɛ ) ,$$
where v is a membrane potential of the neuron model, u is a recovery current of the neuron model, τ_{ρ=+} is a positive regime voltage time constant, τ_{ρ=-} is a negative regime voltage time constant, τᵤ is a recovery current time constant, q_{ρ} and r are state transformation variables, β is a coupling resistance, δ is a coupling conductance-time, ε is a coupling offset voltage, v_{ρ=+} is a positive regime base voltage, and v_{ρ=-} is a negative regime base voltage.

29. The method of claim 28, a closed form solution for the state of the artificial neuron and for a time to reach the first state from another state is defined as:
$$v ( t + Δ t ) = ( v ( t ) + {q}_{ρ} ) {e}^{\frac{Δ t}{{τ}_{ρ}}} - {q}_{ρ} , \\ u ( t + Δ t ) = ( u ( t ) + r ) {e}^{\frac{Δ t}{{τ}_{u}}} - r , \\ Δ t = {τ}_{ρ} log \frac{{v}_{f} + {q}_{ρ}}{{v}_{0} + {q}_{ρ}} ,$$
where Δt is the time to reach the first state v_{f} from the other state v₀.

30. An apparatus for producing neural behaviors of an artificial neuron, comprising a processing system configured to:
determine a first state of the artificial neuron, wherein a neuron model for the artificial neuron has a closed-form solution in continuous time and wherein linear dynamics of the neuron model are divided into two or more regimes;
determine an operating regime for the artificial neuron from the two or more regimes based, at least in part, on the first state;
update the state of the artificial neuron based, at least in part, on the first state of the artificial neuron and the determined operating regime; and
generate a variety of neural behaviors of the artificial neuron by utilizing the linear dynamics of neuron model.

31. An apparatus for producing neural behaviors of an artificial neuron, comprising:
means for determining a first state of the artificial neuron, wherein a neuron model for the artificial neuron has a closed-form solution in continuous time and wherein linear dynamics of the neuron model are divided into two or more regimes;
means for determining an operating regime for the artificial neuron from the two or more regimes based, at least in part, on the first state;
means for updating the state of the artificial neuron based, at least in part, on the first state of the artificial neuron and the determined operating regime; and
means for generating a variety of neural behaviors of the artificial neuron by utilizing the linear dynamics of neuron model.

32. A computer program product for producing neural behaviors of an artificial neuron, comprising a computer-readable medium comprising code for:
determining a first state of the artificial neuron, wherein a neuron model for the artificial neuron has a closed-form solution in continuous time and wherein linear dynamics of the neuron model are divided into two or more regimes;
determining an operating regime for the artificial neuron from the two or more regimes based, at least in part, on the first state;
updating the state of the artificial neuron based, at least in part, on the first state of the artificial neuron and the determined operating regime; and
generating a variety of neural behaviors of the artificial neuron by utilizing the linear dynamics of neuron model.

33. A method for updating the state of an artificial neuron, comprising:
updating the state of the artificial neuron based, at least in part, on events, wherein a neuron model for the artificial neuron has a closed-form solution in continuous time and wherein state dynamics of the neuron model are divided into two or more regimes;
updating the state of the artificial neuron at time intervals; and
updating the state of the artificial neuron if an event occur at or between time instants.

34. The method of claim 33, wherein updating the state from event time t to event time t+Δt is according to:
$$v ( t + Δ t ) = ( v ( t ) + {q}_{ρ} ) {e}^{\frac{Δ t}{{τ}_{ρ}}} - {q}_{ρ} , \\ u ( t + Δ t ) = ( u ( t ) + r ) {e}^{\frac{Δ t}{{τ}_{u}}} - r ,$$
where v is a membrane potential of the neuron model, u is a recovery current of the neuron model, τ_{ρ} is a regime voltage time constant, τᵤ is a recovery current time constant, and q_{ρ} and r are state transformation variables.

35. The method of claim 34, wherein the events are anticipated to occur according to
$$Δ t = {τ}_{ρ} log \frac{{v}_{f} + {q}_{ρ}}{{v}_{0} + {q}_{ρ}} ,$$
where Δt is a time to reach a state v_{f} from another state v₀.

36. The method of claim 33, the state update at the time intervals t+Δt is defined as:
$$v ( t + Δ t ) = ( {e}^{\frac{Δ t}{{τ}_{ρ}}} ) v ( t ) - {τ}_{ρ} β ( {e}^{\frac{Δ t}{{τ}_{ρ}}} - 1 ) u ( t ) - ( ( {e}^{\frac{Δ t}{{τ}_{ρ}}} - 1 ) {v}_{ρ} ) , \\ u ( t + Δ t ) = ( {e}^{\frac{Δ t}{{τ}_{u}}} ) u ( t ) + δ ( {e}^{\frac{Δ t}{{τ}_{u}}} - 1 ) v ( t ) + ( ( {e}^{\frac{Δ t}{{τ}_{u}}} - 1 ) δɛ ) ,$$
where v is a membrane potential of the neuron model, u is a recovery current of the neuron model, τ_{ρ} is a regime voltage time constant, τᵤ is a recovery current time constant, q_{ρ} and r are state transformation variables, β is a coupling resistance, δ is a coupling conductance-time, ε is a coupling offset voltage, and v_{ρ} is a regime base voltage.

37. The method of claim 33, wherein a difference of membrane potentials of the neuron model diminishes over time.

38. The method of claim 37, wherein the difference is monotonically decreasing in a negative regime of the two or more regimes as given by,
$$\vert {v}_{1} ( t + Δ t ) - {v}_{2} ( t + Δ t ) \vert = \vert ( {v}_{1} ( t ) - {v}_{2} ( t ) ) {e}^{\frac{Δ t}{{τ}_{-}}} \vert \leq \vert {v}_{1} ( t ) - {v}_{2} ( t ) \vert ,$$
where v₁ and v₂ are membrane potentials of the neuron model, t+Δt is a time of the event, and τ₋ is a negative regime voltage time constant.

39. The method of claim 33, wherein a spike latency of the neuron model is a function of input spike timing as given by,
τ=τ₊ log v_{S}−τ₊ log └v₀+Σᵢe^{-(τ}^{ᵢ}^{+Δτ}^{ᵢ}^{)/τ}^{₊}┘,
where τ₊ is a is a negative positive regime voltage time constant, v_{S} is a threshold voltage, v₀ is a voltage membrane state, τᵢ is a time of input spike from a pre-synaptic neuron i, and Δτᵢ is a connection delay from the pre-synaptic neuron i.

40. The method of claim 39, wherein the spike latency as the function of input spike timing is equivalent to a linear system of equations in a negative log domain.

41. An apparatus for updating a state of an artificial neuron, comprising a processing system configured to:
update the state of the artificial neuron based, at least in part, on events, wherein a neuron model for the artificial neuron has a closed-form solution in continuous time and wherein state dynamics of the neuron model are divided into two or more regimes;
update the state of the artificial neuron at time intervals; and
update the state of the artificial neuron if an event occur at or between time instants.

42. An apparatus for updating the state of an artificial neuron, comprising:
means for updating the state of the artificial neuron based, at least in part, on events, wherein a neuron model for the artificial neuron has a closed-form solution in continuous time and wherein state dynamics of the neuron model are divided into two or more regimes;
means for updating the state of the artificial neuron at time intervals; and
means for updating the state of the artificial neuron if an event occur at or between time instants.

43. A computer program product for updating the state of an artificial neuron, comprising a computer-readable medium comprising code for:
updating the state of the artificial neuron based, at least in part, on events, wherein a neuron model for the artificial neuron has a closed-form solution in continuous time and wherein state dynamics of the neuron model are divided into two or more regimes;
updating the state of the artificial neuron at time intervals; and
updating the state of the artificial neuron if an event occur at or between time instants.
